(19) United States
(12) Patent Application Publication
(10) Pub. No.: US 2026/0229427 A1
(43) Pub. Date: Aug. 6, 2026

(54) OPERATION INPUT DEVICE

(71) Applicants: Yuki TAKAHASHI, Tokyo (JP); Yasutaka KITAMURA, Tokyo (JP); Kazutaka SAKAGUCHI, Tokyo (JP); Takanori KATO, Tokyo (JP); Yoshihiro GOMI, Tokyo (JP)

(72) Inventors: Yuki TAKAHASHI, Tokyo (JP); Yasutaka KITAMURA, Tokyo (JP); Kazutaka SAKAGUCHI, Tokyo (JP); Takanori KATO, Tokyo (JP); Yoshihiro GOMI, Tokyo (JP)

(73) Assignee: MINEBEA MITSUMI Inc., Nagano (JP)

(21) Appl. No.: 19/152,510

(22) PCT Filed: Jan. 30, 2024
(86) PCT No.: PCT/JP2024/002942

§ 371 Date: Jul. 31, 2025

(30) Foreign Application Priority Data
Jan. 31, 2023 (JP) 2023-012967
Jun. 21, 2023 (JP) 2023-101730

(51) Int. Cl. H01H 13/85; H01H 3/00; H01H 3/12; H01H 3/20; H01H 3/22; H01H 3/60

(52) U.S. Cl. CPC H01H 13/85; H01H 3/122; H01H 3/20; H01H 3/222; H01H 3/60; H01H 2003/008

(57) ABSTRACT

This operation input device comprises an operation part that is operated by a user, and an actuator that includes a movable body to which the operation part is connected, the actuator being electromagnetically driven to perform actuation of the movable body to provide the user with an operational feel, and actuation of the movable body to indicate an operating position of the operation part or to prompt an operation thereof to the user.

### TECHNICAL FIELD

The present invention relates to an operation input apparatus operated by a user.

### BACKGROUND ART

An operation button, a switch, or the like operated by a user is formed in a protruding shape in order for the user to easily recognize the operation button or the switch. However, in recent years, from emphasis on design properties, it is desired to dispose an operation part so as not to interfere when the operation part is not operated.

For example, Patent Literature (hereinafter, referred to as “PTL”) 1 discloses a selector knob that is disposed on a center console of an automobile, and that enters a protruding state in which the selector knob can be operated in response to starting of an engine of the automobile (turning on the power of a vehicle), and enters a state of being lowered and accommodated in response to turning off the power of the vehicle.

The center knob is provided to be raisable and lowerable by a raising and lowering mechanism that converts rotation of a motor into linear motion of the knob via a plurality of power transmission members, and in a case where the power of the vehicle is turned off, the center knob is accommodated in the center console and enters a state of not protruding from a front surface of the center console.

### CITATION LIST

### Patent Literature

### PTL 1

US Patent Application Publication No. 2019/0195322

### SUMMARY OF INVENTION

### Technical Problem

However, in the case of miniaturization of the selector knob in the structure of the selector knob in the related art, although when the vehicle power is turned on, the center knob as the operation part enters the protruding state and the position thereof can be visually recognized, so that operability during operation can be ensured, the operation part itself is small and the degree of protrusion thereof is also low. Accordingly, since an operation feeling for the user in a case where the operation part is operated is also small, it is considered to assist the operation feeling by applying (force feedback) vibration or force in response to the operation of the user to the operation part to apply a suitable operation feeling to the user.

That is, in a case where the entire configuration disclosed in PTL 1 is reduced in size, a movable range of the operation part is also reduced, and accordingly, the operation feeling obtained in a case where the user operates the operation part with a finger is also reduced. Therefore, it is considered that, during the operation, vibration or force in response to the operation by the user is generated by an actuator and transmitted to the operation part so as to be applied (force feedback) to the user as the operation feeling.

However, in the configuration disclosed in PTL 1 (the structure of the center knob in the related art), a force feedback configuration in which vibration or force is applied to the operation part itself cannot be applied due to the structure including a motor, a power transmission mechanism, and the like, such as the motor and the plurality of power transmission members for raising and lowering the center knob, and thus the operation feeling cannot be assisted.

An object of the present invention is to provide an operation input apparatus capable of presenting a position of an operation part and reducing in size while ensuring operability and an operation feeling of the operation part during operation.

### Solution to Problem

An aspect of the operation input apparatus according to the present invention adopts a configuration including:
an operation part operated by a user; and
an actuator including a movable body to which the operation part is connected, the actuator being configured to perform, through electromagnetic drive, actuation of the movable body for applying an operation feeling to the user and actuation of the movable body for presenting an operation position of the operation part to the user or for prompting the user to operate the operation part.

An aspect of the operation input apparatus according to the present invention includes:
a movable body to which an operation part that receives a pressing operation by a user is connected via a protruding part;
a fixed body on which the operation part is disposed externally and that accommodates the movable body internally;
an actuator that moves the movable body inside the fixed body through electromagnetic drive in response to the pressing operation to apply an operation feeling to the user; and
a damping member that is disposed between the movable body and the fixed body.

### Advantageous Effects of Invention

According to the present invention, it is possible to present the position of an operation part by actuation of the operation part accompanying actuation of a movable body, and to achieve size reduction while ensuring operability and an operation feeling of the operation part during operation.

### BRIEF DESCRIPTION OF THE DRAWINGS

FIG. 1 is an external perspective view of the operation input apparatus according to Embodiment 1 of the present invention;

FIG. 2 is a partial sectional view taken along line A-A and seen in a direction of arrows A in FIG. 1;

FIG. 3 is an external perspective view of the operation input apparatus according to Embodiment 1 of the present invention in which an operation surface portion is displaced;

FIG. 4 is a partial sectional view taken along line B-B and seen in a direction of arrows B in FIG. 3;

FIG. 5 is an exploded perspective view of the operation input apparatus according to Embodiment 1 of the present invention;

FIG. 6 is an external perspective view of an actuator of the operation input apparatus according to Embodiment 1 of the present invention;

FIG. 7 is a longitudinal sectional view showing a configuration of a principal part of the actuator;

FIG. 8 is a view showing an internal structure of the actuator with a case removed;

FIG. 9 is an exploded perspective view of the actuator;

FIG. 10 is a perspective view of a movable body;

FIG. 11 is a view for describing an operation of the actuator according to Embodiment 1 of the present invention;

FIGS. 12A and 12B are views for describing sensing of a magnetic sensor;

FIG. 13 is a view schematically showing a configuration of a principal part of the operation input apparatus according to Embodiment 1 of the present invention;

FIG. 14 is a view schematically showing a configuration of a principal part of a variation of the operation input apparatus according to Embodiment 1 of the present invention;

FIG. 15 is a view showing an example of operation control of the actuator in the operation input apparatus;

FIGS. 16A, 16B, and 16C are views showing an example of operation patterns of the actuator;

FIGS. 17A and 17B are views showing an example of operation patterns of the operation input apparatus;

FIGS. 18A, 18B, 18C, 18D, 18E, and 18F are views showing an example of operation patterns of the operation input apparatus;

FIG. 19 is a flowchart for describing an example of an operation using the operation patterns of the operation input apparatus according to Embodiment 1 of the present invention;

FIG. 20 is a flowchart for describing an example of an operation using the operation patterns of the operation input apparatus according to Embodiment 1 of the present invention;

FIG. 21 is a flowchart for describing an example of an operation using the operation patterns of the operation input apparatus according to Embodiment 1 of the present invention;

FIGS. 22A, 22B, and 22C are views showing an example of an operation of the operation input apparatus according to Embodiment 1 of the present invention;

FIG. 23 is a flowchart for describing an operation pattern of the operation input apparatus according to Embodiment 1 of the present invention;

FIGS. 24A and 24B are views showing an example of an operation of the operation input apparatus according to Embodiment 1 of the present invention;

FIG. 25 is an external perspective view of an operation input apparatus according to Embodiment 2 of the present invention;

FIG. 26 is an exploded perspective view of the operation input apparatus according to Embodiment 2 of the present invention;

FIG. 27 is a partial sectional view taken along line C-C and seen in a direction of arrows C in FIG. 25;

FIG. 28 is an external perspective view showing the operation input apparatus according to Embodiment 2 of the present invention in which an operation surface portion protrudes;

FIG. 29 is a partial sectional view taken along line D-D and seen in a direction of arrows D in FIG. 28;

FIG. 30 is an external perspective view of an operation input apparatus according to Embodiment 3 of the present invention;

FIG. 31 is a partial sectional view taken along line F-F and seen in a direction of arrows F in FIG. 30;

FIG. 32 is an external perspective view showing the operation input apparatus according to Embodiment 3 of the present invention in which an operation surface portion is displaced;

FIG. 33 is a partial sectional view taken along line G-G and seen in a direction of arrows G in FIG. 32;

FIG. 34 is an exploded perspective view of the operation input apparatus according to Embodiment 3 of the present invention;

FIG. 35 is an external perspective view of an actuator of the operation input apparatus according to Embodiment 3 of the present invention;

FIG. 36 is a longitudinal sectional view showing a configuration of a principal part of the actuator;

FIG. 37 is a view showing an internal structure of the actuator with a case removed;

FIG. 38 is an exploded perspective view of the actuator;

FIG. 39 is a perspective view of a movable body;

FIG. 40 is a view for describing an operation of the actuator according to Embodiment 3 of the present invention;

FIGS. 41A and 41B are views for describing sensing of a magnetic sensor;

FIG. 42 is a view schematically showing a configuration of a principal part of the operation input apparatus according to Embodiment 3 of the present invention;

FIG. 43 is a view schematically showing a configuration of a principal part of a variation of the operation input apparatus according to Embodiment 3 of the present invention;

FIG. 44 is a view showing an example of operation control of the actuator in the operation input apparatus;

FIGS. 45A, 45B, and 45C are views showing an example of operation patterns of the actuator;

FIGS. 46A and 46B are views showing an example of operation patterns of the operation input apparatus;

FIGS. 47A, 47B, 47C, 47D, 47E, and 47F are views showing an example of operation patterns of the operation input apparatus;

FIG. 48 is a flowchart for describing an example of an operation using the operation patterns of the operation input apparatus according to Embodiment 3 of the present invention;

FIG. 49 is a flowchart for describing an example of an operation using the operation patterns of the operation input apparatus according to Embodiment 3 of the present invention;

FIG. 50 is a flowchart for describing an example of an operation using the operation patterns of the operation input apparatus according to Embodiment 3 of the present invention;

FIGS. 51A, 51B, and 51C are views showing an example of an operation of the operation input apparatus according to Embodiment 3 of the present invention;

FIG. 52 is a flowchart for describing an operation pattern of the operation input apparatus according to Embodiment 3 of the present invention;

FIGS. 53A and 53B are views showing an example of an operation of the operation input apparatus according to Embodiment 3 of the present invention;

FIG. 54 is a longitudinal sectional view showing a configuration of a principal part of an actuator of an operation input apparatus according to Embodiment 4 of the present invention;

FIG. 55 is a longitudinal sectional view showing a configuration of a principal part of an actuator of an operation input apparatus according to Embodiment 5 of the present invention;

FIG. 56 is a longitudinal sectional view showing a configuration of a principal part of an actuator of an operation input apparatus according to Embodiment 6 of the present invention;

FIG. 57 is a longitudinal sectional view showing a configuration of a principal part of an actuator of an operation input apparatus according to Embodiment 7 of the present invention;

FIG. 58 is a longitudinal sectional view showing a configuration of a principal part of an actuator of an operation input apparatus according to Embodiment 8 of the present invention;

FIG. 59 is a longitudinal sectional view showing a configuration of a principal part of an actuator of an operation input apparatus according to Embodiment 9 of the present invention;

FIG. 60 is an external perspective view of an actuator of an operation input apparatus according to Embodiment 10 of the present invention;

FIG. 61 is an exploded perspective view of the actuator of the operation input apparatus according to Embodiment 10 of the present invention; and

FIG. 62 is a longitudinal sectional view showing a configuration of a principal part of the actuator of the operation input apparatus according to Embodiment 10 of the present invention.

### DESCRIPTION OF EMBODIMENTS

Hereinafter, the present embodiment will be described in detail with reference to the drawings. The same reference numerals will be assigned to common components in each figure, and description thereof will be omitted as appropriate.

### Embodiment 1

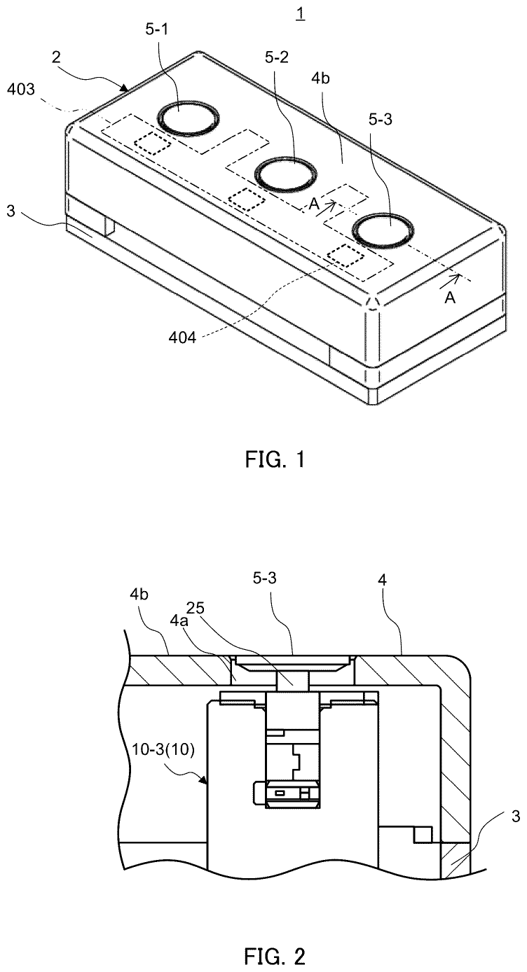

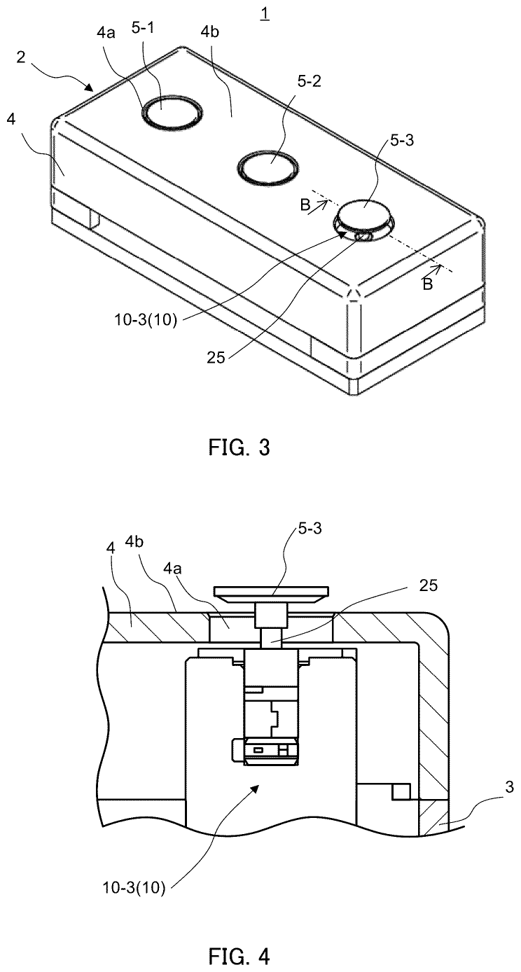

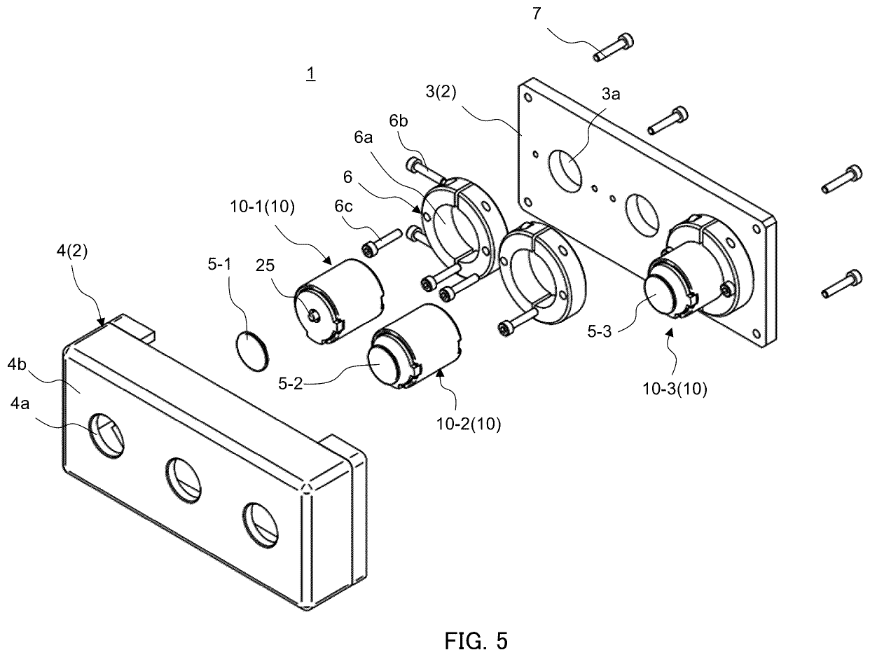

FIG. 1 is an external perspective view of an operation input apparatus according to Embodiment 1 of the present invention, and FIG. 2 is a partial sectional view taken along line A-A and seen in a direction of arrows A in FIG. 1. FIG. 3 is an external perspective view of a state where an operation surface portion is displaced in the operation input apparatus according to Embodiment 1 of the present invention, and FIG. 4 is a partial sectional view taken along line B-B and seen in a direction of arrows B in FIG. 3. In addition, FIG. 5 is an exploded perspective view of the operation input apparatus according to Embodiment 1 of the present invention. Note that, in the present embodiment, expressions related to directions, such as up, down, left, right, front, and rear, used for describing configurations and operations of the respective parts of the operation input apparatus are relative ones, not absolute ones. These expressions are appropriate in a case where an attitude of an operation surface is as shown in the figure, but in a case where the attitude is changed, the expressions should be changed and interpreted in accordance with the change in attitude.

Operation input apparatus 1 includes a function of applying, to a user, a haptic sensation which is an operation feeling including vibration, a reaction force, a thrust, a displacement, or the like through an operation part that is operated by the user by touching or pressing the operation part, or of presenting a position of the operation part by operation or detecting a load applied to the operation part.

For example, in a case where the user intends to operate the operation part, that is, in a case where a situation of the user is observed, recognized, and determined, operation input apparatus 1 moves the operation part. As a result, it is possible to allow recognition of the position of the operation part or recognition of the movement of the operation part. In particular, operation input apparatus 1 can drive the operation part operated by the user to prompt the operation on the operation part such that the user actively acts.

As shown in FIGS. 1 to 4, operation input apparatus 1 includes apparatus case 2, operation surface portions 5-1 to 5-3 that are disposed to be projectable and retractable on a front surface of apparatus case 2 and are operated by the user, and actuator 10.

### <Apparatus Case 2>

Apparatus case 2 is formed in a hollow rectangular parallelepiped shape and includes base portion 3 and cover portion 4. Base portion 3 has a plate shape, and box-shaped cover portion 4 of which a lower surface is open is attached to base portion 3 from above via fastening members 7.

Actuator 10 that is driven by electromagnetic drive to move operation surface portions 5-1 to 5-3 in an up-down direction, specifically, upward from front surface 4b of cover portion 4 is disposed inside apparatus case 2.

Apparatus case 2 accommodates bodies of a plurality of actuators 10-1 to 10-3.

Through-holes 3a are formed in base portion 3 at predetermined intervals. Actuators 10-1 to 10-3 are attached onto base portion 3 in a state of being held by holders (holding parts) 6 such that actuators 10-1 to 10-3 are positioned at positions facing through-holes 3a.

Each of holders 6 includes semi-arc-shaped divided bodies 6a that are disposed to surround each of actuators 10-1 to 10-3. Divided bodies 6a fix each of actuators 10-1 to 10-3 such that each of actuators 10-1 to 10-3 is sandwiched by fastening it with fastening members 6b, and are fixed to base portion 3 by fastening members 6c. Accordingly, actuators 10-1 to 10-3 are respectively fixed to be unable to move in left-right, front-rear, and up-down directions with respect to base portion 3.

Actuators 10-1 to 10-3 each include an output shaft portion (protruding part) 25 that is disposed to protrude upward from a central portion of an upper surface of a fixed body as a main body portion and that moves in the up-down direction.

In actuators 10-1 to 10-3, the fixed bodies are formed in a columnar shape, and output shaft portions 25 are directly fixed to operation surface portions 5-1 to 5-3, respectively.

Output shaft portions 25 extend perpendicularly to base portion 3, and their distal end portions are joined perpendicularly to operation surface portions 5-1 to 5-3, respectively.

Operation surface portions 5-1 to 5-3 are disposed in opening portions 4a formed in front surface 4b of cover portion 4 and are movable in the up-down direction in opening portions 4a.

Operation surface portions 5-1 to 5-3 have front surface portions that are disposed to be projectable and retractable with respect to apparatus case 2, and the front surface portions are flush with front surface 4b. Note that, a moving direction of movable body 20 during application of the operation feeling and a moving direction of movable body 20 during presentation of an operation position of operation surface portion 5 or during prompting of the operation of operation surface portion 5 coincide with a projection and retraction direction of operation surface portions 5-1 to 5-3.

Operation surface portions 5-1 to 5-3 are disposed to move perpendicularly to front surface 4b of cover portion 4 (case 2). This is due to the fact that movable body 20 is disposed to be movable in a direction orthogonal to front surface 4b of cover portion 4.

It is preferable that operation surface portions 5-1 to 5-3 have shapes that are easy for the user to operate. In the present embodiment, since operation surface portions 5-1 to 5-3 are operated by a finger of the user, operation surface portions 5-1 to 5-3 are formed in a disk shape having front surfaces with diameters that come into contact with finger pads in correspondence with the fingers of the user.

As shown in FIGS. 1 to 4, operation surface portions 5-1 to 5-3 are flush with front surface 4b of cover portion 4 in a non-operative state, and are displaceable to positions protruding upward from front surface 4b of cover portion 4 in an operative state. Output shaft portions 25 also follow to move up and down as operation surface portions 5-1 to 5-3 move up and down.

### <Overview of Actuator 10>

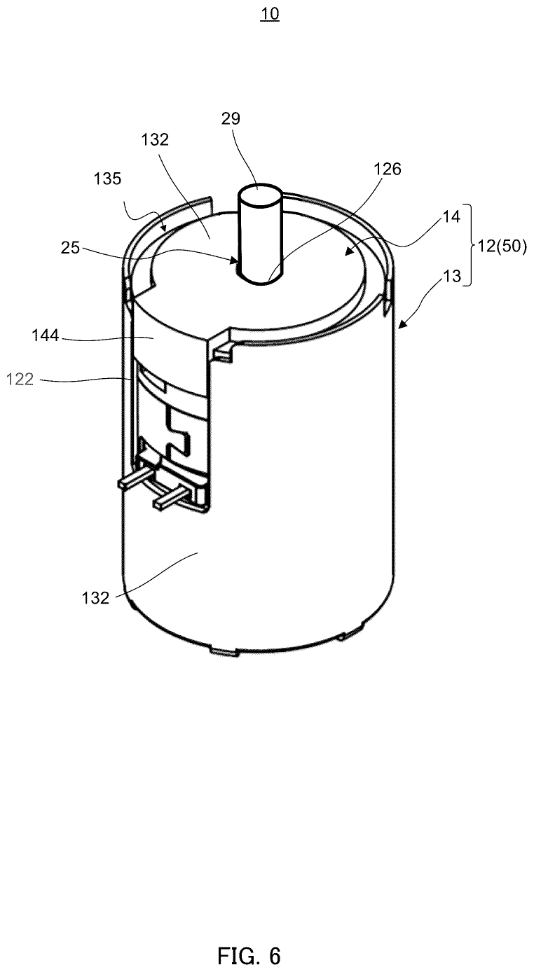

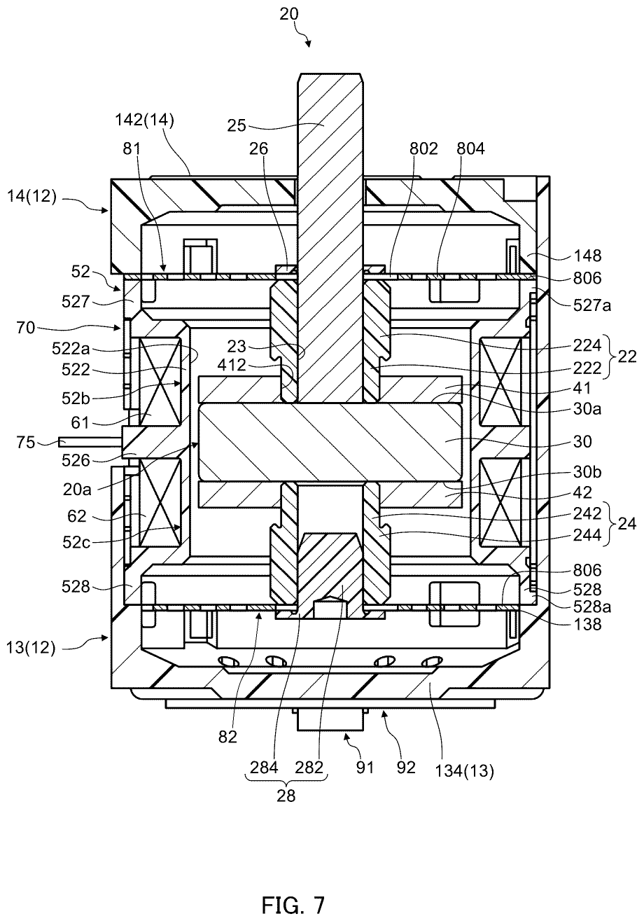

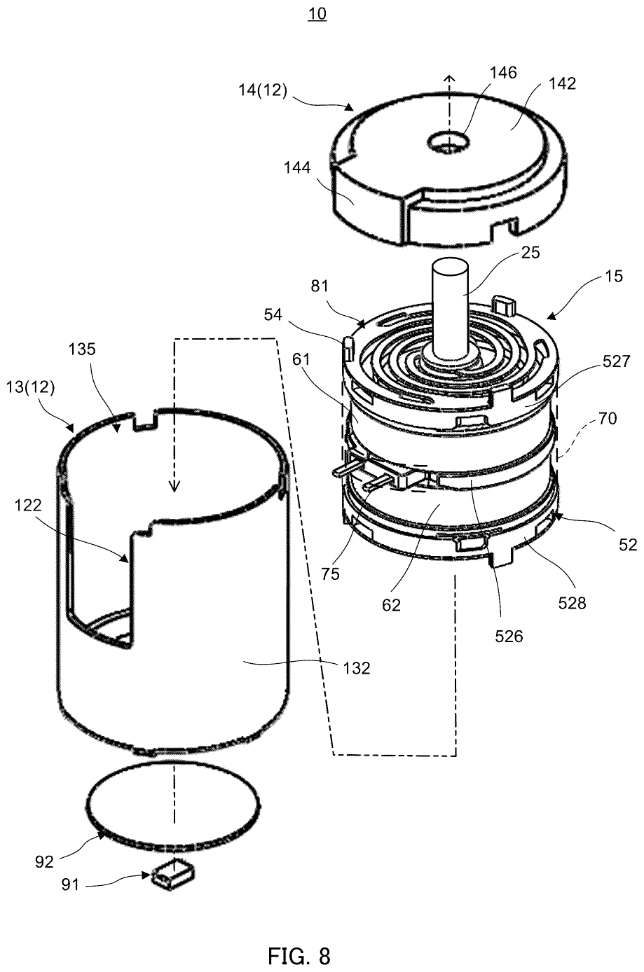

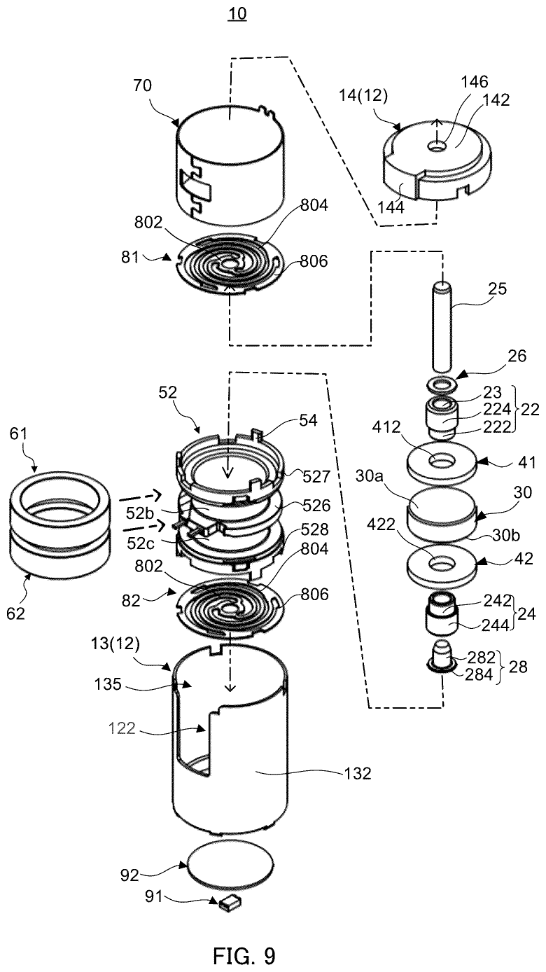

FIG. 6 is an external perspective view of the actuator in the operation input apparatus according to Embodiment 1 of the present invention, and FIG. 7 is a longitudinal sectional view showing a configuration of a principal part of the actuator. In addition, FIG. 8 is a view showing an internal structure of the actuator with a case removed, and FIG. 9 is an exploded perspective view of the actuator.

Actuator 10 includes movable body 20 to which operation surface portion 5 is connected. Actuator 10 performs an actuation of movable body 20 for applying the operation feeling to the user via operation surface portion 5 through electromagnetic drive. In addition, actuator 10 performs an actuation of movable body 20 for presenting an operation position of operation surface portion 5 to the user or for prompting the user to operate operation surface portion 5 through electromagnetic drive.

Actuator 10 is, for example, an actuator that presents perception, and is configured to transmit reciprocating motion of movable body 20 in response to a touch operation by the user on operation surface portion 5 as the operation feeling (a haptic sensation, a force feeling, or the like) of the user. Actuator 10 of the present embodiment is configured to move operation surface portion 5 itself as the operation part directly connected to the movable body to indicate the position of operation surface portion 5 and to prompt the operation of operation surface portion 5. Note that, in a case where the movable body is moved to move operation surface portion 5, the position of operation surface portion 5 may be made more reliably known to the user by light emission.

Actuator 10 is used as a device that detects an operation and feeds back an operation feeling (haptic sensation). The haptic feedback is to feed back a force feeling or the like in addition to the haptic sensation to the user through operation surface portion 5 operated by the user by means of the actuation, vibration, or the like of movable body 20. For example, the haptic feedback may also be referred to as haptic sensation feedback, tactile sensation feedback, or force feedback, and is a function used for expressing a haptic sensation and an operation feeling.

As shown in FIGS. 6 and 7, actuator 10 accommodates movable body 20 in hollow case 12 such that the movable body can reciprocate between upper and lower end surfaces, with an axial direction (up-down direction) of case 12 as a moving direction. Case 12 accommodates movable body 20 together with coils 61 and 62 such that a protruding end side of output shaft portion 25 protrudes outward. Actuator 10 includes magnetic sensor 91 that detects a movement position of movable body 20. Actuator 10 is connected to operation surface portion 5 (5-1, 5-2, 5-3) (see FIGS. 3 to 5) via output shaft portion 25 provided in movable body 20, and transmits the movement of the movable body to operation surface portion 5 (5-1, 5-2, 5-3).

### <Configuration of Actuator 10>

Actuator 10 includes magnet 30 in movable body 20, includes coils 61 and 62 in fixed body 50, and causes movable body 20 to perform reciprocating motion in a straight line direction by cooperation between energized coils 61 and 62 and magnet 30. Actuator includes elastic supporting parts 81 and 82 that support movable body 20 to be movable with respect to fixed body 50.

Specifically, actuator 10 includes movable body 20 including a pair of yokes 41 and 42 and a pair of spring retaining parts 22 and 24 in addition to magnet 30, and fixing body 50 including outer yoke 70 in addition to a pair of annular coils 61 and 62. A pair of elastic supporting parts 81 and 82 are provided between movable body 20 and fixing body 50.

Movable body 20 is attached via elastic supporting parts 81 and 82 to fixed body 50 to be movable in a moving direction of the movable body during application of the operation feeling and in a moving direction of movable body 20 during presentation of the operation position of operation surface portion 5 (5-1, 5-2, 5-3) or during prompting of the operation of operation surface portion 5.

Note that a configuration in which a pair of yokes 41 and 42, a pair of spring retaining parts 22 and 24, and a pair of coils 61 and 62 are disposed is employed, but the present invention is not limited thereto, and the number of yokes, spring retaining parts, and coils may also be one, three, or more as long as it is possible to achieve movability on one side or both side in one linear direction.

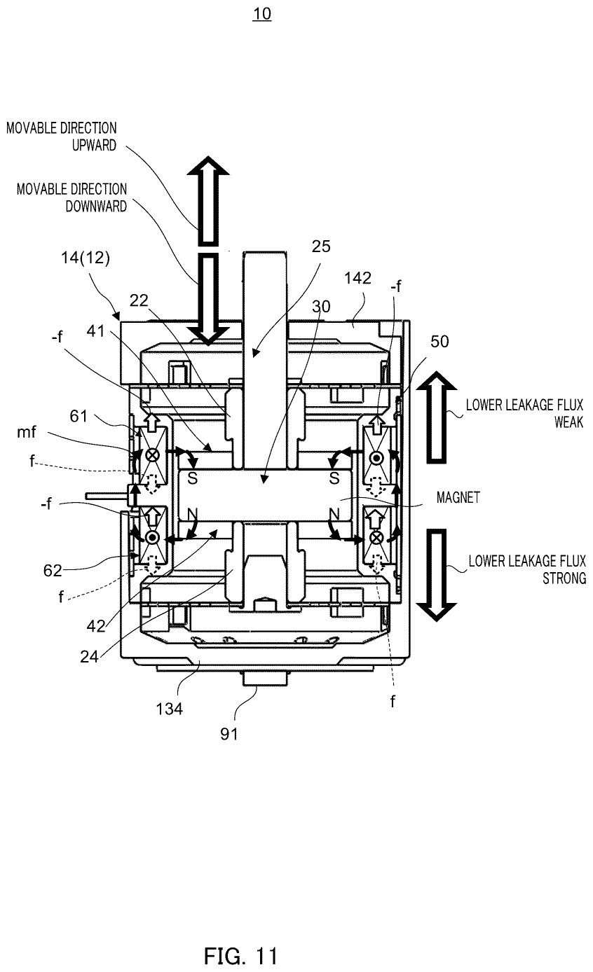

In actuator 10, coils 61 and 62, outer yoke 70, magnet 30, and yokes 41 and 42 constitute a magnetic circuit for moving movable body 20. In actuator 10, coils 61 and 62 are energized from a power supply section (not illustrated) via terminal part 75, and movable body 20 is moved. Movable body 20 can reciprocate in both directions in the axial direction which is a reciprocation direction, or in one direction which is one side in the axial direction. For example, actuator 10 moves in both directions in the axial direction (see the arrow directions in FIG. 11).

In actuator 10 of the present embodiment, movable body 20 reciprocates in the moving direction (also referred to as the axial direction of coils 61 and 62) along a holding-portion main body (protective wall portion) 522 disposed between the coils and movable body 20 inside coils 61 and 62 held by coil holding part 52. The moving direction is not only the axial direction of coils 61 and 62, but also the magnetization direction of magnet 30, and is also the axial direction of coil holding part 52.

In addition, as shown in FIG. 8, actuator 10 may be configured to accommodate unit 15 in which fixed body 50 and movable body 20 are connected to each other by elastic supporting parts 81 and 82 in case 12 having case main body 13 and lid portion 14. Accordingly, it is possible to accurately assemble main parts of actuator 10 in a different step from case 12.

### <Movable Body 20>

Movable body 20 in a non-moving state is disposed via elastic supporting parts 81 and 82 such that the center of its length in the reciprocation direction faces, at a predetermined distance in a direction orthogonal to the axial direction of movable body 20, the center of the length of coil holding part 52 in the reciprocation direction. In the present embodiment, it is preferable that the centers of the lengths in the reciprocation direction of magnet 30 and yokes 41 and 42 are disposed at positions facing, in a direction orthogonal to the reciprocation direction, the center of the length between vertically spaced coils 61 and 62 in the reciprocation direction. Note that magnetic fluid may be interposed between holding-portion main body 522 and movable body 20.

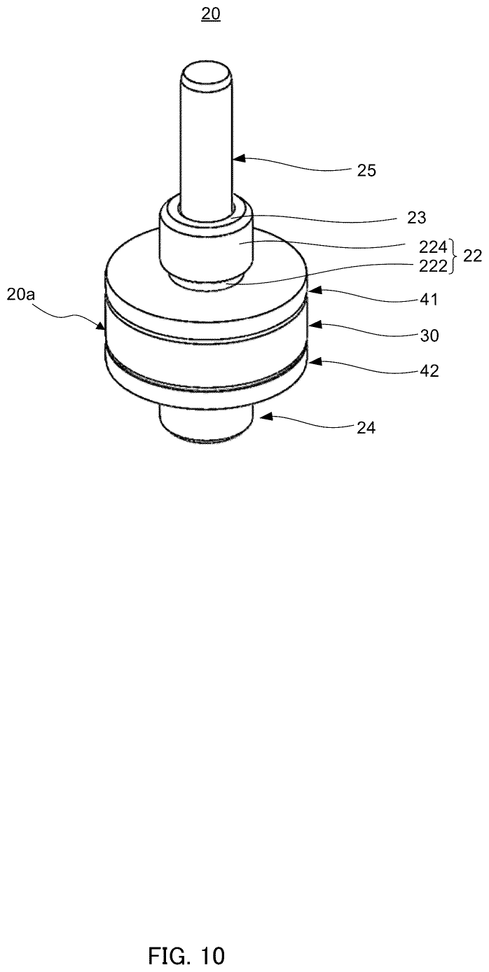

As shown in FIGS. 7, 9, and 10, movable body 20 includes output shaft portion 25, first spring fixation portion 26, and second spring fixation portion 28 in addition to magnet 30, yokes 41 and 42, and spring retaining parts 22 and 24.

In movable body 20, yokes 41 and 42, spring retaining parts 22 and 24, first spring fixation portion 26, and second spring fixation portion 28 are continuously disposed in opposite directions in the reciprocation direction around magnet 30. Specifically, in movable body 20, yokes 41 and 42 are disposed on front and back surfaces 30a and 30b of magnet 30 in a stacked manner, and elastic supporting parts 81 and 82 are engaged with one end portions of spring retaining parts 22 and 24 that are, at the other end portions, engaged with opening portions 412 and 422 of yokes 41 and 42.

In movable body 20, outer circumferential surface 20a of magnet 30 and yokes 41 and 42 face inner circumferential surface 522a of holding-portion main body 522 with a predetermined distance to inner circumferential surface 522a. When movable body 20 reciprocates, outer circumferential surface 20a reciprocates without coming into contact with inner circumferential surface 522a.

Magnet 30 is solid and magnetized in the reciprocation direction. Specifically, magnet 30 is formed in a disk shape and has front and back surfaces 30a and 30b facing away from each other in the reciprocation direction (thickness direction) as magnetic pole surfaces of different polarities (for example, front surface 30a is an S-pole, and back surface 30b is an N-pole).

Magnet 30 is disposed so as to be spaced apart by a distance from coils 61 and 62 (to be described later in detail) inward of coils 61 and 62 in a radial direction. Here, the “radial direction” is a direction orthogonal to the axes of coils 61 and 62, and is also a direction orthogonal to the reciprocation direction. The “distance” in the radial direction is a distance between coils 61 and 62 including holding-portion main body 522 and magnet 30, and is a distance that allows movement in the reciprocation direction of movable body 20 without contact between the magnet and the movable body. In addition, there is a predetermined distance also between holding-portion main body 522 and magnet 30.

In the present embodiment, magnet 30 is disposed such that the center of the outer circumferential surface faces the center of holding-portion main body 522 in a direction orthogonal to the axial direction, the center being the center in the width direction, the outer circumferential surface being situated on the outer side in the radial direction. Note that magnet 30 may have a shape other than a disk shape, such as a cylindrical shape or a plate shape, as long as it is disposed inside coils 61 and 62 with two magnetized surfaces facing in the extending direction of the axes of coils 61 and 62, that is, in the reciprocation direction.

In the present embodiment, magnet 30 is a solid body. Thus, unlike the case of a tubular member, an effort to process an opening portion is saved, and the areas of the front and back surfaces serving as the magnetic pole surfaces are not reduced by formation of the opening portion. In addition, it is desirable that the center of magnet 30 in the axial direction coincide with the center of movable body 20 in the axial direction.

The magnetization direction of magnet 30 is parallel to the moving direction of movable body 20.

Yokes 41 and 42 are magnetic materials, and the yokes together with magnet 30 form a movable-body-side magnetic circuit. Yokes 41 and 42 concentrate the magnetic flux of magnet 30 to allow efficient flow without leakage, and effectively distribute the magnetic flux flowing between magnet 30 and coils 61 and 62.

In addition, yokes 41 and 42 may have a function of fixing spring retaining parts 22 and 24 in addition to a function as a part of the magnetic circuit. Yokes 41 and 42 may further have a function as a main body portion of movable body 20 and a function as a weight in movable body 20.

In the present embodiment, yokes 41 and 42 are formed in an annular flat plate shape having the same outer diameter as that of magnet 30. Yokes 41 and 42 are fixed to magnet 30 such that the outer circumferential surfaces thereof are flush with the outer circumferential surface of the magnet, and form outer circumferential surface 20a of movable body 20 together with the outer circumferential surface of the magnet.

Yokes 41 and 42 are members with the same shape disposed to sandwich magnet with magnet 30 interposed therebetween, but may be members with different shapes.

Yokes 41 and 42 are attached to magnet 30 by being attracted to magnet 30, and are also fixed to magnet 30 via, for example, a thermosetting adhesive such as an epoxy resin or an anaerobic adhesive.

Opening portions 412 and 422 are formed in respective central portions of yokes 41 and 42 so as to extend therethrough in the axial direction, that is, in the thickness direction. One end portions of upper and lower spring retaining parts 22 and 24 are internally fitted and fixed to opening portions 412 and 422, respectively.

Opening portions 412 and 422 support spring retaining parts 22 and 24 such that the respective axes of spring retaining parts 22 and 24 (here coinciding with the centers of elastic supporting parts 81 and 82) are located on the central axis of movable body 20. Opening portions 412 and 422 allow adjustment of the degree of opening in yokes 41 and 42 to adjust the weight of movable body 20 and set a suitable reciprocating output.

In the present embodiment, when movable body 20 is not reciprocating, yokes 41 and 42 are positioned on the inner side (radially inner side) of coils 61 and 62 so as to face coils 61 and 62, respectively, in a direction orthogonal to the axial direction of coils 61 and 62.

In yokes 41 and 42, the height position of the upper surface of yoke 41 on the upper side (front side) of magnet 30 is preferably opposed to the position of the center of the upper coil 61 in the height direction (reciprocation direction). In addition, the height position of the lower surface of yoke 42 on the lower side (back surface side) of magnet 30 is preferably opposed to the position of the center of lower coil 62 in the height direction (reciprocation direction).

Spring retaining parts 22 and 24 have a function of fixing a movable-body-side magnetic circuit to elastic supporting parts 81 and 82, and have a function as a weight of movable body 20. Spring retaining parts 22 and 24 are disposed symmetrically in the axial direction to sandwich magnet 30 and yokes 41 and 42, and increase the reciprocating output of movable body 20 driven by power supply to the coil.

In the present embodiment, spring retaining parts 22 and 24 are formed in the same shape. For this reason, the details of spring retaining part 24 are omitted, and the explanation thereof is given by adding the reference numeral of spring retaining part 24 to the corresponding names in the description of spring retaining part 22. Since spring retaining parts 22 and 24 are formed in the same shape, it is possible to reduce a cost of producing components in manufacturing of actuator 10.

In the present embodiment, spring retaining parts 22 and 24 also function as a shaft of the movable body extending along the central axis of movable body 20, and are interposed between yokes 41 and 42 and elastic supporting parts 81 and 82.

Spring retaining parts 22 and 24 include joint portions 222 and 242 and spring fixation portions 224 and 244. Joint portions 222 and 242 and spring fixation portions 224 and 244 are continuously disposed in the reciprocation direction.

Spring retaining parts 22 and 24 are tubular members and have through-hole 23 extending inside. The base end portion of output shaft portion 25 is inserted into through-hole 23 of spring retaining part 22 and is firmly fixed thereto.

Joint portions 222 and 242 are tubular members disposed on the axis of movable body 20, and are joined to yokes 41 and 42, respectively. Joint portions 222 and 242 are joined by inserting one end portion sides into opening portions 412 and 422 of yokes 41 and 42, respectively. On the other hand, the other end portions of joint portions 222 and 242 are disposed to face away from each other in the opposite directions across magnet 30, and form opposite end portions of movable body 20 which are separated from each other in the moving direction. Elastic supporting parts 81 and 82, which will be described later, are joined to the other end portions, respectively.

Spring retaining parts 22 and 24 are bonded to yokes 41 and 42 by press-fitting, but the present invention is not limited thereto, and may be bonded by bonding using a thermosetting adhesive such as an epoxy resin or an anaerobic adhesive, for example. Joint portions 222 and 242 are tubular members, but they may be solid cylindrical bodies or rod-shaped bodies having recessed portions on the axis.

Spring fixation portion 224 is a tubular member that is provided so as to protrude from joint portion 222 to the other side (upward) of spring retaining part 22 and has an outer diameter larger than that of joint portion 222. In spring fixation portion 224, a joining surface, which is a distal end (upper end) surface thereof, is disposed around output shaft portion 25.

Output shaft portion 25 is connected to movable body 20, moves together with movable body 20, and outputs a motion of movable body 20 to the outside. Output shaft portion 25 is disposed on the axis of movable body 20, the base end side is fixed to movable body 20 by being internally fitted to spring retaining part 22, and the other end side is exposed to the outside of actuator 10 through central opening portion 146 of lid portion 14. Output shaft portion 25 is inserted through inner circumferential portion 802 which

is an end portion (the other end portion) of the upper leaf spring as elastic supporting part 81 on the inner diameter side. Inner circumferential portion 802 is a central portion of the circular leaf spring and is sandwiched between spring fixation portion 224 and first spring fixation portion 26 in a state of being in contact with the joining surface of spring fixation portion 224. Spring fixation portion 224 is thus joined to elastic supporting part 81.

Output shaft portion 25 protrudes from movable body 20 to the side of elastic supporting part 81 opposite to magnet 30 in one direction in the moving direction of movable body 20, and is movable forward and backward outside fixing body 50. A center portion of a back surface of operation surface portion 5 is fixed to a distal end portion of output shaft portion 25 to be orthogonal to an extending direction of output shaft portion 25. The user who operates operation surface portion 5 directly transmits the driving of movable body 20 via operation surface portion 5 and output shaft portion 25. Accordingly, operation input apparatus 1 can respond at a high speed and perform strong feedback in a case of performing vibration output, displacement output (the displacement of movable body 20 in response to the operation), and load detection. In addition, it is possible to express an operation feeling (haptic sensation) that can cope with an operation with a long stroke.

On the other hand, spring fixation portion (lower spring fixation portion) 244 disposed on the side opposite to spring fixation portion 224 of first spring retaining part 22 across magnet 30 is joined to inner circumferential portion 802 which is an end portion of the lower leaf spring being elastic supporting part 82 on the inner diameter side.

Spring fixation portion 244 is a tubular member that is provided so as to protrude from joint portion 242 to the other side (downward) in spring retaining part 24 and has an outer diameter larger than that of joint portion 242. At spring fixation portion 244, inner circumferential portion 802 is held between the joining surface being the distal end (lower end) surface of the spring connection portion and second spring fixation portion 28 inserted into a through-hole opened in the joining surface in a state in which inner circumferential portion 802 of the lower leaf spring serving as elastic supporting part 82 is in contact with the joining surface.

Specifically, second spring fixation portion 28 is inserted at shaft-shaped insertion portion 282 into the through-hole in spring connection portion 244, thereby holding inner circumferential portion 802 of elastic supporting part 82 between flange 284 disposed on the outer circumference of the base end portion of the insertion portion and the joining surface of spring fixation portion 244. Thus, spring fixation portion 244 and elastic supporting part 82 are joined to each other.

Second spring fixation portion 28 may be a rivet such as a blind rivet, for example. Second spring fixation portion 28 fixes shaft-shaped insertion portion 282 in the through-hole in spring fixation portion 244 by press-fitting such as caulking.

It should be noted that only by disposing spring retaining parts 22 and 24 in the movable-body-side magnetic circuit, the upper leaf spring and the lower leaf spring as elastic supporting parts 81 and 82 can be easily assembled to movable body 20, and the assemblability can be improved.

Note that, spring retaining parts 22 and 24 may be formed from a magnetic material, but are preferably formed from a non-magnetic material. When spring retaining parts 22 and 24 are formed from a non-magnetic material, the magnetic flux from yoke 41 does not flow upward, and the magnetic flux from yoke 42 does not flow downward, and the magnetic fluxes can thus efficiently flow toward coils 61 and 62 located on the outer circumferential side of yokes 41 and 42.

### <Elastic Supporting Parts 81 and 82>

Elastic supporting parts 81 and 82 are disposed on opposite sides of movable body in the moving direction, and support movable body 20 movably in the moving direction. Elastic supporting parts 81 and 82 are leaf springs, and are disposed so as to sandwich movable body 20 in the moving direction of movable body 20, and are disposed on both movable body 20 and fixing body 50 so as to intersect the moving direction.

Specifically, elastic supporting parts 81 and 82 are disposed to straddle, on one hand, the opposite end portions (upper and lower end portions) of movable body 20 that are spaced apart from each other in the reciprocation direction and, on the other hand, the opening edge portions of fixing body 50 (coil holding part 52) that are disposed radially outward from the opposite end portions. In the present embodiment, elastic supporting parts 81 and 82 are disposed along a direction orthogonal to the reciprocation direction and face each other to sandwich movable body 20 in the reciprocation direction.

Elastic supporting parts 81 and 82 may be non-magnetic materials or magnetic materials (specifically, ferromagnetic materials). Elastic supporting parts 81 and 82 may be formed from a stainless-steel plate such as SUS304, SUS316 as long as they are non-magnetic leaf springs. When elastic supporting parts 81 and 82 are formed from a magnetic material, a stainless-steel plate such as SUS301 is applicable. As a material of elastic supporting parts 81 and 82, for example, a magnetic material (for example, SUS301) is known to be more durable and inexpensive than a non-magnetic material (for example, SUS304, SUS316, or the like). In the present embodiment, elastic supporting parts 81 and 82 are formed from SUS301.

Elastic supporting parts 81 and 82 support movable body 20 such that the movable body does not come into contact with fixing body 50 whether the movable body is in reciprocating motion and not in reciprocating motion. Elastic supporting parts 81 and 82 may be formed from any material as long as they are configured to elastically support movable body 20 movably.

Each of elastic supporting parts 81 and 82 is a plurality of plate-shaped spiral springs which have a flat plate shape in a normal state. In each of elastic supporting parts 81 and 82, arc-shaped deformation arm portions 804 extend radially outward at regular intervals from the outer edge portion of inner circumferential portion 802 having the annular plate shape, and are connected to outer circumferential fixation portion 806 having the annular plate shape at the end portions of deformation arm portions 804.

Inner circumferential portions 802 have a shape disposed on the joining surfaces of spring fixation portions 224 and 244 of spring retaining parts 22 and 24, and have, for example, an outer diameter substantially the same as the outer diameter of the joining surfaces of spring fixation portions 224 and 244.

Deformation arm portions 804 are elastically deformable, are joined to outer circumferential fixation portion 806 at one end portions, are joined to inner circumferential portion 802 at the other end portions, and connect outer circumferential fixation portion 806 and inner circumferential portion 802 to each other. A plurality of deformation arm portions 804 are disposed in a spiral shape between inner circumferential portion 802 and outer circumferential fixation portion 806 while being spaced from one another by a predetermined interval in the circumferential direction. Movable body 20 may be supported by three or more elastic supporting parts (leaf springs) 81 and 82. The plurality of leaf springs are attached to extend along a direction orthogonal to the reciprocation direction.

In elastic supporting parts 81 and 82, inner circumferential portions 802 are joined respectively to the opposite end portions (spring fixation portions 224 and 244) that are separated from each other in the axial direction (reciprocation direction) of movable body 20. Further, the outer circumferential fixation portion 806 sides of elastic supporting parts 81 and 82 are disposed so as to protrude radially outward (in the radial direction) at the opposite end portions of movable body 20.

Outer circumferential fixation portion 806 is sandwiched between opposite opening edges of coil holding part 52 and case 12 in a state where a notch is formed in an outer circumferential edge and movable-range forming portion 54 of coil holding part 52 is engaged with the notch.

Specifically, in elastic supporting part 81, outer circumferential fixation portion 806 is sandwiched and fixed in case 12 between ring-shaped upper end surface 527a of flange portion 527 and pressing portion 148 of lid portion 14. Note that, upper end surface 527a means an upper (one-side) end surface of the portion of the upper side (one side) of upper (one-side) flange portion 527 other than movable-range forming portions 54.

Further, in lower elastic supporting part 82, outer circumferential fixation portion 806 is fixed to the lower end portion of coil holding part 52 at the outside of movable body in the radial direction in actuator 10. Specifically, outer circumferential fixation portion 806 of elastic supporting part 82 is fixed to a portion of annular lower end surface 528a of lower flange portion 528 forming the lower end portion of coil holding part 52, the portion being other than movable-range forming portions 54.

In the plurality of elastic supporting parts 81 and 82, outer circumferential fixation portion 806 being one end of each of elastic supporting parts 81 and 82 on the outer circumferential side is fixed to fixing body 50 and inner circumferential portion 802 being the other end of each of elastic supporting parts 81 and 82 on the inner circumferential side is fixed to movable body 20 such that the directions of the whirls of elastic supporting parts 81 and 82 are the same, for example.

As described above, a plurality of whirl-shaped leaf springs are used as the plurality of elastic supporting parts 81 and 82 in the present embodiment. Elastic supporting parts 81 and 82 are attached respectively to the opposite end portions of movable body 20 which are distant from each other in the moving direction, and elastically support movable body 20 with respect to fixing body 50. Thus, when the movement amount of movable body 20 is large, the movable body moves in a translational direction (here, the direction on a plane perpendicular to the moving direction) even slightly while rotating. When the whirl directions of the plurality of leaf springs are opposite each other, the plurality of leaf springs move in a buckling direction or a pulling direction to each other, whereby smooth movement is prevented.

Since actuator 10 includes a pair of elastic supporting parts 81 and 82, actuator 10 can improve linear drive properties of movable body 20 and stably perform the driving of movable body 20 without being affected by an impact or a disturbance from the outside. In particular, since the stability of the linear driving can be increased, both characteristics of the stability of a magnetic sensor output and the stability of a haptic sensation output can be increased.

Elastic supporting parts 81 and 82 of the present embodiment are fixed to movable body 20 such that the whirl directions are the same. Thus, even when the movement amount of movable body 20 is large, elastic supporting parts 81 and 82 can move smoothly, i.e., can be deformed in the axial direction. Accordingly, elastic supporting parts 81 and 82 produce a greater amplitude and can increase the vibration output not only during movement but also during vibration.

However, depending on a desired vibration range of movable body 20, the whirl directions of the plurality of elastic supporting parts 81 and 82 may be designed to be opposite directions to each other.

Meanwhile, outer circumferential fixation portion 806 of upper elastic supporting part 81 is, at the outside in the radial direction, fixed to the upper end portion of coil holding part 52. Specifically, outer circumferential fixation portion 806 of elastic supporting part 81 is fixed to a portion of annular upper end surface 527a of upper flange portion 527 forming the upper end portion of coil holding part 52 (see FIG. 7), the portion being other than movable-range forming portions 54. Details of the configuration of coil holding part 52 will be described later.

Outer circumferential fixation portion 806 of elastic supporting part 82 is clamped and fixed by annular lower end surface 528a of flange portion 528 and step portion 138 formed on a circumferential edge portion of bottom portion 134 within case 12. Note that, lower end surface 528a means an upper (other-side) end surface of the portion of the lower side (other side) of lower (other-side) flange portion 528 other than movable-range forming portions 54.

Outer circumferential fixation portions 806 are formed in an annular shape. The outer circumferential portions of the outer circumferential fixation portions are sandwiched between upper and lower end surfaces 527a and 528a of coil holding part 52 (see FIG. 7) and pressing portion 148 and step portion 138. With this configuration, outer circumferential fixation portions 806 are fixed to fixing body 50.

### <Fixed Body 50>

As shown in FIG. 7, fixing body 50 holds coils 61 and 62, and supports, via elastic supporting parts 81 and 82, movable body 20 inside coils 61 and 62 in the radial direction such that movable body 20 is freely movable in the moving direction (the coil axial direction, or the axial direction of movable body 20).

Fixing body 50 includes coils 61 and 62, outer yoke 70, and coil holding part 52 that hold coils 61 and 62.

Actuator 10 is configured such that substantially all the components for generating vibrations, such as coils 61 and 62, movable body 20, and case 12 via elastic supporting parts 81 and 82 are connected to coil holding part 52.

Coil holding part 52 is a tubular member, holds coils 61 and 62 disposed on the outer circumferential surface, and surrounds magnet 30 with inner circumferential surface 522a. Movable body 20 including magnet 30 is movably disposed inside the coil holding part. Coil holding part 52 may also be formed in a bobbin shape, and in this case, coils 61 and 62 are wound on the outer circumference of the inner tubular holding-portion main body (protective wall) of coil holding part 52.

Coil holding part 52 is a tubular member formed from a resin such as a phenolic resin or polybutylene terephthalate (PBT). In the present embodiment, coil holding part 52 is formed from a material containing a phenolic resin such as Bakelite having high flame retardancy.

When coil holding part 52 is formed from a material containing a phenolic resin, a higher flame retardancy is obtained. It is thus possible to improve the safety at the time of driving even when heat is generated by Joule heat when a current flows through coils 61 and 62 held by coil holding part 52. Moreover, the dimensional accuracy is increased and the positional accuracy of coils 61 and 62 is increased accordingly. It is thus possible to reduce variations in characteristics of movement, reciprocating motion or vibration.

Specifically, coil holding part 52 includes tubular holding-portion main body 522, middle flange portion 526, and flange portions 527 and 528 protruding in the radial direction from the outer circumference of holding-portion main body 522, terminal part 75, and movable-range forming portions 54.

Holding-portion main body 522 functions as a protective wall portion for protecting coils 61 and 62 against collision by movable body 20 when movable body 20 disposed inside is being driven. The thickness of holding-portion main body 522 is a thickness that gives such a strength that coils 61 and 62 on the outer circumferential side are not affected at all even when moving movable body 20 makes contact with bobbin main-body portion 522.

Coils 61 and 62 are disposed on the outer circumferential side of holding-portion main body 522 side by side in the coil axial direction between middle flange portion 526 and flange portions 527 and 528 (coil attachment portions 52b and 52c). Holding-portion main body 522 positions coils 61 and 62 such that the coils radially externally surround the outer circumferential surfaces of yokes 41 and 42 (the outer circumferential surfaces of magnet 30 and yokes 41 and 42) of movable body 20.

Specifically, the outer circumferential surface of holding-portion main body 522 is partitioned by middle flange portion 526 and flange portions 527 and 528, and is provided with recessed coil attachment portions 52b and 52c that open radially outward on the outer circumferential side.

Terminal part 75 functions as a connector connection portion to which coil windings of coils 61 and 62 are tied for connection to an external device. Coils 61 and 62 are connected to the external device via terminal part 75, and power can be supplied from the external device to coils 61 and 62.

Terminal part 75 is an electrically conductive member disposed to protrude from the outer circumferential portion of holding-portion main body 522. In the present embodiment, terminal part 75 is press-fitted to the outer circumferential surface of middle flange portion 526 disposed on the outer circumference of holding-portion main body 522 centrally in the moving direction. Terminal part 75 is thus disposed to protrude from the outer circumferential surface of middle flange portion 526.

Flange portions 527 and 528 are disposed respectively on opposite end portions of holding-portion main body 522 which are separate from each other in the axial direction of the bobbin main-body portion (which is also the moving direction and the upper-lower direction in the present embodiment), so as to form the upper and lower end portions of coil holding part 52.

Elastic supporting parts 81 and 82 are fixed to end portions of flange portions 527 and 528 on the sides away from middle flange portion 526 (upper and lower end portions in the present embodiment).

Movable-range forming portions 54 are disposed on the upper and lower end portions of coil holding part 52, and form a moving range between lid portion 14 and bottom portion 134 of case 12 and movable body 20 when coil holding part 52 is accommodated in case 12.

Movable-range forming portions 54 are projecting side portions protruding from flange portions 527 and 528 in the reciprocation direction (upper-lower direction). Movable-range forming portions 54 are disposed at predetermined intervals on upper and lower annular end surfaces (also referred to as “upper end surface and lower end surface” or “opening end surfaces”) 527a and 528a of flange portions 527 and 528. Upper end surface 527a is an opening end surface on one side, and lower end surface 528a is an opening end surface on the other side.

Flange portion 527 includes, on the opening end surface on one side, projecting movable-range forming portions 54 protruding in the moving direction. The one opening end surface functions as a top surface receiving portion that receives lid portion 14 via movable-range forming portions 54. Flange portion 528 includes, on the opening end surface on the other side, projecting movable-range forming portions 54 protruding in the moving direction. The other opening end surface functions as a bottom surface receiving portion that receives bottom portion 134 via movable-range forming portions 54.

Further, movable-range forming portions 54 are fitted into the notches formed in elastic supporting parts 81 and 82, to perform radial positioning of elastic supporting parts 81 and 82.

Movable-range forming portions 54 are fitted in the notches. Accordingly, it is possible to uniformly set the attachment positions of elastic supporting parts 81 and 82 with respect to coil holding part 52 of each individual unit 15, so as to perform stable position determination of elastic supporting parts 81 and 82 with respect to coil holding part 52. Further, with respect to coil holding part 52, elastic supporting parts 81 and 82 are not fixed to the fixing body side via a plurality of components. Thus, a structure less susceptible to component tolerances is achieved, and movement in the circumferential direction and the radial direction such as rotation is restricted. It is thus possible to suppress variations in elastic supporting parts 81 and 82 in products, and to achieve stable characteristics.

Coil holding part 52 is accommodated in case 12 such that movable-range forming portions 54 at the upper and lower end surfaces are in contact with the edge portion of lid portion 14 and the edge portion of bottom portion 134, and is fixed to the edge portion of lid portion 14 and the edge portion of bottom portion 134.

### <Coil>

In actuator 10, coils 61 and 62, together with magnet 30 and yokes 41 and 42, are used for generating a drive source of actuator 10, in which case the axial direction of coils 61 and 62 (magnetization direction of magnet 30) is the moving direction.

Coils 61 and 62 generate a magnetic field by energization based on a detection result of magnetic sensor 91 to move movable body 20. Coils 61 and 62 are disposed radially outside movable body 20. Coils 61 and 62 together with magnet 30 constitute a magnetic circuit similar to a voice coil motor.

Coils 61 and 62 are disposed on coil attachment portions 52b and 52c, and coils 61 and 62 are disposed at positions facing yokes 41 and 42 in a direction orthogonal to the reciprocation direction in the present embodiment.

Coils 61 and 62 are held by coil holding part 52 such that the center position of the length of the coils in the coil axial direction (reciprocation direction) is substantially the same position (including the same position) in the reciprocation direction as the center position of the length of movable body 20 in the reciprocation direction (the center position of magnet in the reciprocation direction). Note that, coils 61 and 62 of the present embodiment are configured to be wound in directions opposite to each other, through which currents flow in the opposite directions during energization. Coils 61 and 62 are fixed by bonding or the like to recessed coil attachment portions 52b and 52c, and the outer circumferential surfaces of the coils are surrounded by outer yoke 70 inside case 12.

The end portions of coils 61 and 62 are tied and connected to terminal part 75 of middle flange portion 526. Coils 61 and 62 are connected to an external power supply section via terminal part 75. For example, the respective end portions of coils 61 and 62 may be connected to a direct current (DC) supply section, and direct current (DC) power may be supplied from the direct current (DC) supply section to coils 61 and 62. Thus, coils 61 and 62 can generate, between the magnet and coils 61 and 62, thrust allowing movement on one side in a direction toward each other or away from each other in their axial direction. Further, the respective end portions of coils 61 and 62 may be connected to an alternating current (AC) supply section, and an alternating current (AC) power supply (alternating current (AC) voltage) may be supplied from the alternating current (AC) supply section to coils 61 and 62. Thus, coils 61 and 62 can generate, between the magnet and coils 61 and 62, thrust allowing movement in a direction toward each other or away from each other in their axial direction.

### <Outer Yoke 70>

Outer yoke 70 is a cylindrical magnetic body that surrounds the outer circumferential surface of coil holding part 52 and is disposed at a position that covers coils 61 and 62 radially outward. Outer yoke 70 prevents leakage magnetic flux from actuator 10 to the outside in the radial direction in the magnetic circuit.

Outer yoke 70 is disposed such that the center of the length of outer yoke 70 in the reciprocation direction is located at the same height as the center of magnet 30 in the reciprocation direction that is disposed inside outer yoke 70. The shielding effect of outer yoke 70 makes it possible to reduce the leakage magnetic flux to the outside of the reciprocating actuator.

Outer yoke 70 also makes it possible to increase the thrust constant so as to increase the electromagnetic conversion efficiency in the magnetic circuit. Outer yoke 70 utilizes the magnetic attraction force of magnet 30, and functions as a magnetic spring together with magnet 30. The magnetic spring makes it possible to reduce a stress that would be caused when elastic supporting parts 81 and 82 are mechanical springs, so as to improve the durability of elastic supporting parts 81 and 82.

### <Case 12>

Case 12 includes: bottomed cylindrical case main body 13 having circumferential wall portion 132 and bottom portion 134; and lid portion 14 for closing opening portion 135 of case main body 13. Case 12 has a columnar shape. The columnar shape is a shape having a height (thickness) allowing generation of sufficient thrust in the reciprocation direction in cooperation with coils 61 and 62 facing the outer circumference of the movable body. For example, case 12 of the present embodiment is formed in a cylindrical shape by bottomed cylindrical case main body 13 and lid portion 14. However, the case is not limited to this shape. The case may be elliptical cylindrical or polygonal prismatic. The length of the case in the reciprocation direction is longer or shorter than the length of the case in a direction perpendicular to the reciprocation direction. The elliptical shape of the elliptical cylindrical shape and elliptical shape in the present embodiment is mainly an ellipse including parallel straight-line-like portions, and thus means an oval shape.

Lid portion 14 and bottom portion 134 respectively form top surface portion 142 and the lower surface portion (bottom portion 134) of actuator 10 in the present embodiment, and are disposed to face movable body 20 of unit 15 with a predetermined gap being interposed between the lid portion and the bottom portion, on the one hand, and the movable body, on the other hand, in the reciprocation direction of movable body 20.

Lid portion 14 includes protruding portion 144 projecting radially outward from a part of the outer circumference of top surface portion 142 and is engaged with cutout portion 122 of case main body 13. Protruding portion 144 engages lid portion 14 with cutout portion 122 of case main body 13 to perform positioning when lid portion 14 is attached to case main body 13. Each of lid portion 14 and bottom portion 134 limits a movable range of movable body 20. Lid portion 14 and bottom portion 134 have a function as a movable-range reducing part that is a hard stop (movable range limitation) of movable body 20.

When lid portion 14 is attached to case main body 13, protruding portion 144 of lid portion 14 is disposed above terminal part 75 exposed in cutout portion 122 of case main body 13 to the outside at the central portion of cutout portion 122 in the longitudinal direction. Thus, the position of terminal part 75 of actuator 10 can be grasped only in plan view of lid portion 14.

Magnetic sensor 91 and circuit board 92 are disposed on case main body 13.

Magnetic sensor 91 is mounted on circuit board 92, detects a change in the magnetic flux caused by the movement of magnet 30 of movable body 20, and detects the displacement of movable body 20.

### <Magnetic Sensor 91>

Magnetic sensor 91 is an example of an operation amount detection part that detects a moving amount of movable body 20 in the moving direction that is moved by a user operation via operation surface portion 5. Magnetic sensor 91 detects the position of movable body 20 moving in response to a user's operation. Magnetic sensor 91 is disposed at a distance from movable body 20 in the moving direction of movable body 20. The moving direction of movable body 20 may be the side opposite to the side on which movable body 20 moves. That is, the position of magnetic sensor 91 may be the same side or a different side as long as it is in the moving direction of movable body 20.

It is preferable that magnetic sensor 91 be disposed on a central axis extending in the reciprocation direction of movable body 20 (a position overlapping the axis of output shaft portion 25) or in the vicinity of the central axis.

Magnetic sensor 91 together with circuit board 92 is attached to the outer surface of case main body 13, and the arrangement position of magnetic sensor 91 is positioned on the axis of output shaft portion 25 of movable body 20.

Since magnetic sensor 91 is disposed on the outer surface of case 12, it can be assembled outside actuator 10, and the assemblability of actuator 10 can be improved.

In addition, it is possible to easily attach or replace magnetic sensor 91 without disassembling actuator 10. In addition, magnetic sensor 91 included in actuator 10 can be easily inspected.

It is preferable that magnetic sensor 91 includes a Hall element. It is preferable that circuit configuration of the magnetic sensor at a subsequent stage be easier than, for example, in that case of simply using a Hall element, and it is also preferable that the magnetic sensor be a Hall IC which compares an output of the Hall element with a threshold value for output of High/Low. For the Hall IC, the output voltage range is defined by the power supply, and the subsequent-stage circuitry (microcomputer) can thus be easily created.

Further, as a magnetic sensor for which the output voltage range is defined by a power supply, a Hall sensor incorporating an amplifier, such as a linear Hall IC in which the output of the Hall element is amplified by the amplifier for linear output may also be used for magnetic sensor 91. Accordingly, circumferential circuitry can be configured inexpensively and easily without using other sensors, amplifiers, and transducers such as dedicated AD converters.

### <Circuit Board (Control Part) 92>

Circuit board 92 includes a microcontroller, an actuator driver, and the like mounted thereon and includes a drive control part that controls driving of the actuator. In circuit board 92, magnetic sensor 91 detects an operation load received by movable body 20 via output shaft portion 25, and coils 61 and 62 are energized according to the detection result to control the movement of movable body 20. Note that, the drive control part may not be provided in actuator 10. The drive control part is a control part of operation input apparatus 1 and is controlled by microcontroller 400 that controls each part of entire operation input apparatus 1.

As a result, actuator 10 can detect the operation load and perform haptic feedback specialized for the corresponding pressing operation. In particular, by the load detection, it is possible to perform detection specialized for the pressing operation.

As described above, actuator 10 can receive the operation load by output shaft portion 25 and generate the haptic feedback based on the operation load received by output shaft portion 25 to present it as the operation feeling of the user who operates operation surface portion 5. It is thus possible to more accurately reproduce a user operation also as an operation of a switch haptic sensation, a slider haptic sensation, or the like in response to the user operation to present it as a feedback.

When magnetic sensor 91 is used, a magnet originally necessary for forming an actuator is used for the sensor. It is thus possible to provide an inexpensive movable-body-position detecting means.

Since actuator 10 includes magnetic sensor 91 as a sensor for detecting the displacement of movable body 20, actuator 10 can easily detect the operation and provide haptic feedback.

Since case 12 is formed from a non-magnetic material, the case lower surface provided with magnetic sensor 91 is formed from a non-magnetic material. As a result, magnetic sensor 91 can detect the stable magnetic flux density in the magnetic circuit including magnet 30 and accurately detect the position of movable body 20.

Further, the magnetization direction of magnet 30 is parallel to the moving direction of movable body 20. Thus, magnetic sensor 91 detects the magnetic flux density of the distribution of a single magnetic pole, and thus can enhance the sensor detectability, so as to perform a stable sensor output.

In addition, movable body 20 is accommodated in coils 61 and 62 in a state of being drivable in the axial direction. Thus, it is possible to form a magnetic circuit capable of generating a thrust more efficiently. Further, the magnetic flux density to the bottom portion 134 side is increased. It is thus possible to accurately and easily detect magnetic sensor 91 disposed on bottom portion 134.

### <Operation of Actuator 10>

FIG. 11 is a view for describing an operation of the actuator according to Embodiment 1 of the present invention.

With reference to FIG. 11, a description will be given of operation of actuator 10 in relation to one example in which magnet 30 is magnetized such that front surface 30a, which is one side of magnet 30 in the magnetization direction (upper side in the present embodiment), is the S-pole, and back surface 30b, which is the other side in the magnetization direction (lower side in the present embodiment), is the N-pole.

In actuator 10, movable body 20 is considered to correspond to a mass in a vibration model of a spring-mass system, and a sharp peak can be reduced by damping a reciprocating motion, for example, when a resonance is sharp (has a sharp peak). Damping the vibration makes the resonance less sharp, so that the maximum amplitude value and the maximum movement amount of movable body 20, for example, at the time of resonance do not vary, and vibrations of the suitable and stable maximum movement amount are output.

Flow mf of the magnetic flux is formed, which is emitted from the back surface 30b side of magnet 30 to yoke 42 and then toward the coil 62 side and passes through outer yoke 70 and coil 61 to enter magnet 30 via yoke 41 on the upper side of magnet 30.

Accordingly, when energization is performed as illustrated in FIG. 11, the Lorentz force in the −f direction is generated in coils 61 and 62 by interaction between the magnetic field of magnet 30 and the currents flowing through coils 61 and 62 in accordance with Fleming's left hand rule.

The Lorentz force in the −f direction is in a direction orthogonal to the direction of the magnetic field and to the direction of the current flowing through coils 61 and 62. Since coils 61 and 62 are fixed to fixing body 50 (coil holding part 52), in accordance with the law of action and reaction, a force opposed to the Lorentz force in −f direction is generated as a thrust force in the f direction in movable body 20 having magnet 30. As a result, the movable body 20 side including magnet 30 moves toward the f direction, that is, toward bottom portion 134 (bottom surface of case main body 13).

On the other hand, when the energization direction of coils 61 and 62 is switched in the opposite direction and coils 61 and 62 are energized, the Lorentz force in a direction reverse to the f direction is generated. The generation of the Lorentz force in this f direction causes in movable body 20 the force opposite to the Lorentz force in the f direction as thrust (thrust in the −f direction) in accordance with the law of action and reaction, so that movable body 20 moves in the f direction, i.e., toward the top surface of lid portion 14 of fixing body 50.

Actuator 10 makes it possible to provide the operator with a so-called haptic sensation and force sensation feedback (which may also be referred to as force feedback) via output shaft portion 25 in response to the user's operation by moving movable body 20 toward only one of lid portion 14 and bottom portion 134.

In addition, coils 61 and 62 can also be supplied with a current alternately in opposite directions to cause coils 61 and 62 to perform a reciprocating motion or vibrate, and this can be used to actuate movable body 20 through an operation of the operator.

In addition, in actuator 10, a magnetic attraction force acts between magnet 30 and outer yoke 70, which functions as a magnetic spring in a non-driven (non-vibrated) state in which actuator 10 is not energized. The magnetic attraction force generated between magnet 30 and outer yoke 70 and a restoring force that brings elastic supporting parts 81 and 82 back to their original shapes cause movable body 20 to return to its original position.

Actuator 10 includes: fixing body 50 including coils 61 and 62; and movable body disposed radially inside coils 61 and 62 and including magnet 30 magnetized in the axial direction of coils 61 and 62. In addition, actuator 10 includes flat plate-shaped elastic supporting parts 81 and 82 that elastically hold movable body 20 such that movable body 20 is freely movable in the moving direction that is the coil axial direction.

Further, coils 61 and 62 are disposed on the outer circumference of holding-portion main body 522 of coil holding part 52, outer circumferential surface 20a of movable body is disposed on the inner circumferential side of holding-portion main body 522 with a gap being interposed between the outer circumferential surface of the movable body and the holding-portion main body, and coils 61 and 62 are, at the outer circumferential surface, surrounded by outer yoke 70.

Accordingly, in actuator 10, the leakage magnetic flux to the radially outer side is suppressed, and outer yoke 70 together with magnet 30, yokes 41 and 42, and coils 61 and 62 functions as a magnetic path. Thus, generation of thrust by the magnetic force can be improved. Further, the detection of the magnetic flux density by magnetic sensor 91 on the bottom surface side is not influenced at all.

As illustrated in FIG. 11, when movable body 20 moves to the lid portion 14 side, or the upper side (arrow “Upward in movable direction”), magnet 30 is separated from magnetic sensor 91. Thus, the leakage magnetic flux detected by magnetic sensor 91 at a lower portion of case 12 is weak.

Further, when movable body 20 moves toward the bottom portion 134 side (arrow “Downward in movable direction”), magnet 30 approaches magnetic sensor 91, and the leakage magnetic flux detected by magnetic sensor 91 becomes strong. Accordingly, magnetic sensor 91 can detect the magnetic flux density in response to the operation of movable body 20. It is thus possible to directly apply a haptic sensation directly reproducing movement, vibration, and/or impact via output shaft portion 25 based on the detection result.

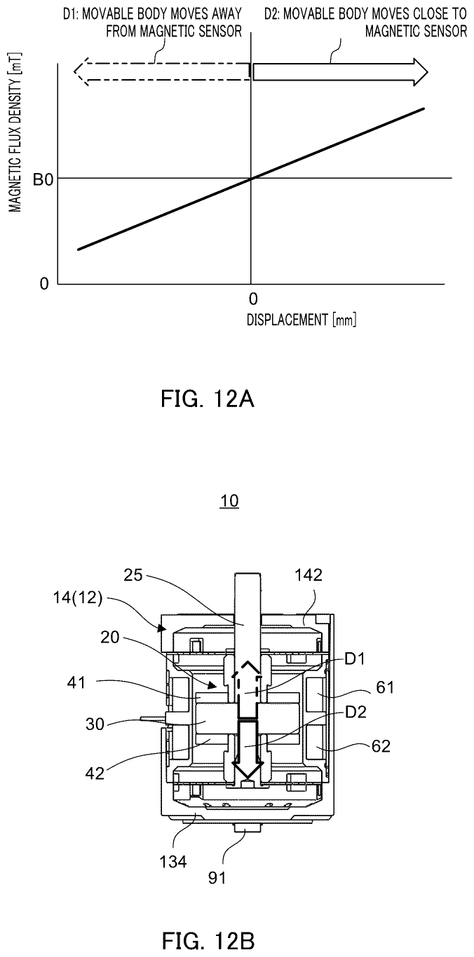

FIGS. 12A and 12B are diagrams for explaining sensing of the magnetic sensor, and FIG. 12A illustrates the relation between the magnetic flux density detected by the magnetic sensor and the displacement of the magnet, and FIG. 12B schematically illustrates the actual operation of the movable body corresponding to the detection of FIG. 12A.

As illustrated in FIGS. 12A and 12B, when movable body 20 having a configuration in which magnet 30 is sandwiched between magnet 30 and yokes 41 and 42 moves in direction D1, that is, toward lid portion 14, movable body 20 becomes remote from magnetic sensor 91, and the magnetic flux density decreases. In addition, when movable body 20 moves in direction D2, that is, toward bottom portion 134, or in this case, toward magnetic sensor 91 disposed at a lower portion, the detected magnetic flux density increases.

As described above, magnetic sensor 91 can linearly detect the relationship between the magnetic flux density and the displacement of the movable body, and can suitably detect the position of movable body 20 based on the relationship.

Actuator 10 has a structure in which unit 15 is accommodated in case 12, and the outer circumferential surface of circumferential wall portion 132 of case 12 formed from a resin can thus be formed as a smooth surface. Thus, when actuator 10 is attached to an electronic device, it is possible to reliably and easily perform attachment of a cushioning material such as a sponge to be interposed between actuator 10 and a mounting point.

Moreover, since actuator 10 has the configuration in which unit 15 is disposed in case 12, fixation of elastic supporting parts 81 and 82, which requires high dimensional accuracy, can be achieved by attaching elastic supporting parts 81 and 82 to coil holding part 52.

Thus, arrangement of movable body 20 including the fixation of elastic supporting parts 81 and 82 can be determined with reference to coil holding part 52, so that it is possible to increase the accuracy of the haptic sensation generation direction of the product. Specifically, only increasing the dimensional accuracy of coil holding part 52 formed as one component from a resin or the like makes it possible to easily dispose coils 61 and 62 and movable body 20 (magnet 30) attached via elastic supporting parts 81 and 82 in an accurate positional relationship, for example.

Further, terminal part 75 are disposed on coil holding part 52 to protrude outward, so that tying and soldering of the coil wire of the coils are facilitated, and connection between an external device and coils 61 and 62 can be facilitated.

As described above, actuator 10 can perform haptic sensation presentation while having impact resistance.

Actuator 10 is driven by a pulse (a direct current (DC) pulse or an alternating current (AC) pulse) input to coils 61 and 62. That is, the energization direction of coils 61 and 62 may be appropriately set so that thrust in the −f direction toward top surface portion 142 of lid portion 14 or thrust in the f direction toward bottom portion 134 acts on movable body 20, or so that these thrusts in the −f direction and the f direction alternately act on the movable body. As a result, movable body 20 moves in the moving direction or in the vibration direction, and the force feedback can be performed via actuator 10 itself or output shaft portion 25.

As described above, actuator 10 can be easily manufactured at a low cost, and has a detection function and a haptic feedback function that are easier to use.

### <Driving Principle of Actuator 10>

The driving principle of actuator 10 will be simply described. Actuator 10 is driven, for example, by a supplied pulse based on following Equation 1 of motion and Circuit Equation 2. In the present embodiment, the driving is performed by inputting a short pulse, but the driving may be performed so as to generate an arbitrary reciprocating motion and without using the short pulse.

Movable body 20 in actuator 10 performs reciprocating motion based on Equations 1 and 2.

$$\begin{matrix}[ 1 ] & \\ m \frac{{d}^{2} x ( t )}{d {C}^{2}} = {K}_{f} i ( t ) - {K}_{s p} x ( t ) - D \frac{dx ( t )}{dt} & ( Equation 1 )\end{matrix}$$

m: Mass [kg]
x(t): Displacement [m]
K_{f}: Thrust constant [N/A]
i(t): Current [A]
Kₛₚ: Spring constant [N/m]
D: Damping coefficient [N/(m/s)]

$$\begin{matrix}[ 2 ] & \\ e ( t ) = R i ( t ) + L \frac{di ( t )}{dt} + {K}_{e} \frac{dx ( t )}{dt} & ( Equation 2 )\end{matrix}$$

e(t): Voltage [V]
R: Resistance [Ω]
L: Inductance [H]
Kₑ: Reverse electromotive force constant [V/(m/s)]

Mass m [Kg], displacement x(t) [m], thrust constant K_{f} [N/A], current i(t) [A], spring constant Kₛₚ [N/m], damping coefficient D [N/(m/s)], and the like in actuator 10 may be changed appropriately as long as Equation 1 is satisfied. In addition, voltage e (t) [V], resistance R [Ω], inductance L [H], and reverse electromotive force constant Kₑ [V/(m/s)] may be changed appropriately as long as Equation 2 is satisfied.

Accordingly, actuator 10 is determined by mass m of movable body 20 and spring constant Kₛₚ of metallic springs (the elastic bodies or the leaf springs in the present embodiment) as elastic supporting parts 81 and 82.

### <Function of Actuators 10 (10-1, 10-2, 10-3)>

Actuators 10 (10-1, 10-2, 10-3) configured as described above have the following functions by driving movable body 20.

Movable body 20 is driven to apply a vibration stimulus or a direct stimulus to the user who operates the operation surface portion, so that a haptic sensation that acts directly on a force sense haptic sensation is applied.

Movable body 20 is also driven to apply, to the user who operates operation surface portion 5, a load that compensates for or follows a load (operation load) applied by a pressing operation by the user performed on movable body 20 via operation surface portion 5, or to reduce the load applied to the user by applying a load in a direction opposite to the direction of the load. Accordingly, a haptic sensation such as hardness or softness of the operation part (operation surface portion) is applied as the operation feeling to the user who operates operation surface portion 5.

By driving movable body 20 such that presentation of a haptic sensation applied to the user performed by outputting vibration in accordance with a position where operation surface portion 5 is pressed is repeatedly performed in a stepwise manner, it is possible to apply, to the user who operates operation surface portion 5, the operation feeling of a selection function change with multi-stage haptic sensations.

In addition, in a state where operation surface portion 5 does not protrude from front surface 4b, the operation with operation surface portion 5 can be prompted. That is, the operation surface of operation input apparatus 1 is an operation surface having a design without unevenness as a hint for causing the user to operate the operation part, that is, an operation surface without a so-called signifier affordance, and is an operation surface that is less visually recognizable.

In operation input apparatus 1 having such an operation surface, operation surface portion 5, which is the operation part itself integrated with movable body 20 of actuator 10, operates so as to suggest the position of the operation part or to induce the user toward that position, thereby suggesting the position of operation surface portion 5, that is, the operation position.

In addition, operation input apparatus 1 operates operation surface portion 5, which is the operation part itself integrated with movable body 20 of actuator 10, to be capable of performing an operation like an active human machine interface (HMI)-like operation on the user.

In addition, in the present embodiment, the operation part configured to be movable in a direction protruding from the operation surface is composed of only actuator 10 without using a power transmission mechanism together with the actuator (motor). Accordingly, in operation input apparatus 1, the structure is simplified and the assembly is facilitated. In addition, the operation part can be operated by only the actuator without using a plurality of power transmission members constituting the power transmission mechanism section to drive the operation part, so that an operation can be realized with high accuracy with respect to the operation surface portion.

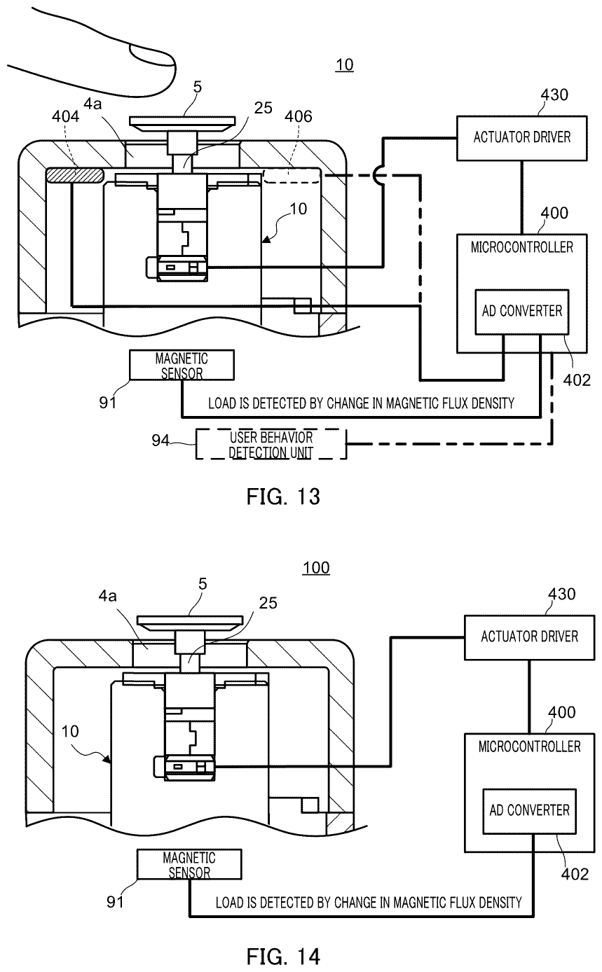

FIG. 13 is a view schematically showing a configuration of a principal part of the operation input apparatus according to Embodiment 1 of the present invention.

Operation input apparatus 1 shown in FIG. 13 includes the plurality of actuators 10 (10-1, 10-2, 10-3) and AD converter 402. Note that, operation input apparatus 1 includes microcontroller 400 as a control part that controls actuators 10, actuator driver 430, and proximity sensors 404.

As described above, magnetic sensor 91 included in actuator 10 functions to detect the load applied to the movable body via operation surface portion 5, and also functions to perform feedback control of the position of movable body 20.

In a case where operation surface portion 5 is operated, the operation load is applied to actuator 10, and the operation load is detected by magnetic sensor 91 from the change in magnetic flux density. The detected operation load is output to microcontroller 400, which is the control part, via AD converter 402.

Each of proximity sensor 404 detects the presence or absence of an object approaching operation surface portion 5 and outputs the presence or absence to microcontroller 400, which is the control part.

Proximity sensor 404 may be any type of sensor as long as the sensor detects approach and spacing of the object and a state of the object in a noncontact manner. For example, proximity sensor 404 may be an electromagnetic induction-type (high-frequency oscillation-type) proximity sensor, a capacitive proximity sensor, a magnetic proximity sensor, an optical time-of-flight (ToF) sensor, an ultrasonic ToF sensor, or the like.

Here, proximity sensor 404 is a capacitive sensor, detects a change in electrostatic capacity or an electrical change occurring in a case where the object approaches or moves away from operation surface portion 5, and outputs the change, as a detection result (detection value), to microcontroller 400 via AD converter 402.

Proximity sensor 404 is disposed at a position at which the approach of a finger can be detected in a case where an object approaching operation surface portion 5, for example, a finger of the user who operates operation surface portion 5, approaches. In operation input apparatus 1, as shown in FIG. 1, proximity sensors 404 may be disposed in placement region 403 around opening portion 4a in the front surface of apparatus case 2 (front surface 4b of cover portion 4), and any number of proximity sensors 404 may be disposed as long as the number thereof corresponds to the number of operation surface portions 5 in opening portion 4a. In addition, as indicated by proximity sensor 406 in FIG. 13, for example, a plurality of proximity sensors, each of which includes an oscillation circuit incorporating a detection electrode that generates an electric field and a detection circuit that detects a change in oscillation frequency of the oscillation circuit, may be provided at a plurality of locations.

Microcontroller (control part) 400 drives actuator 10 via actuator driver 430 based on input information. The microcontroller may be a microcontroller incorporating edge AI, and the plurality of actuators of operation input apparatus 1 may perform various operations in accordance with input information.

Microcontroller 400 drives actuator 10 via the actuator driver based on detection information on the object from proximity sensor 404, the position of movable body 20 from magnetic sensor 91, information about the load applied to movable body 20, and the like to move operation surface portion 5. For example, microcontroller 400 drives actuator 10 to present, to the user, the haptic sensation of operation surface portion 5 as described above (hardness or softness, for example, the haptic sensation of being pricked), a click sensation of a multi-stage operation, the position of the operation surface portion. Note that, microcontroller 400 digitizes an analog voltage from proximity sensor 404 by an analog-to-digital conversion circuit (ADC), determines a position indicated by information, and selects and generates a drive pattern based on the position. Microcontroller 400 outputs a command and a drive signal for driving in the selected and generated drive pattern to circuit board (control part) 92 and actuator driver 430 to operate movable body 20.

Microcontroller 400 can drive the actuator to perform active suggestion expression or sensitivity expression by observing, recognizing, and determining the information from proximity sensor 404 and magnetic sensor 91, that is, the information indicating the situation of the user.

Here, in operation input apparatus 1, the drive of actuator 10 based on the detection information on the object from proximity sensor 404 will be described.

For example, in a case where the user brings a finger close to operation surface portion 5 to move operation surface portion 5, actuator 10 can enter a protruding state or a projecting and retracting operation state, and the user can be prompted to move operation surface portion 5 via operation surface portion 5.

Microcontroller 400 may have a plurality of drive patterns of actuator 10 based on the detection information from proximity sensor 404.

Specifically, in a case where the finger of the user as an object approaches in a case where operation surface portion 5 is in a state of being flush with front surface 4b of case 2 (cover portion 4), operation surface portion 5 is caused to be positioned to protrude, so that the position thereof is recognized, on the assumption that the finger approaches for operation of operation surface portion 5. For example, in a case where the finger (object) of the user approaches operation surface portion 5, operation input apparatus 1 may cause all operation surface portions 5 to protrude. In addition, operation input apparatus 1 may drive the actuator close to proximity sensor 404 that has detected the approach of the object to bring operation surface portion 5 closest to the finger into a protruding state, so that the position thereof is checked and operation surface portion 5 is made operable.

In addition, in a case where the user operates operation surface portion 5 with the finger, microcontroller 400 has a plurality of operation patterns for cases of driving actuator in accordance with operations of operation surface portion 5 by the finger.

Specifically, microcontroller 400 drives actuator 10 via actuator driver 430 to output vibration, force, and displacement, and directly applies an operation feeling to the user via the operation part.

Microcontroller 400 can feed back a haptic sensation corresponding to the load detected by magnetic sensor 91, that is, the load input to actuator 10, to the user who operates operation surface portion 5 of actuator 10.

Microcontroller 400 drives actuator 10 in each operation pattern to apply vibration in a case where the user presses operation surface portion 5 or separates the finger from operation surface portion 5, and to further apply different vibration in a case where operation surface portion 5 is pushed in. These operations may also be referred to as vibration feedback, and different vibration may be applied to each of operation surface portions 5-1 and 5-2.

FIG. 14 is a view schematically showing a configuration of a principal part of a variation of operation input apparatus 1 in a case where the proximity sensor is not provided.

Operation input apparatus 100 of FIG. 14 has the configuration of operation input apparatus 1 shown in FIG. 13, except that proximity sensor 404 is not provided. Operation input apparatus 100 drives the operation part in an operation pattern corresponding to the pushing-in operation by the user regardless of the presence or absence of the proximity sensor, as in operation input apparatus 1. Similarly to operation input apparatus 1, microcontroller 400 of operation input apparatus 100 detects the pressing (pushing-in operation) of operation surface portion 5 by the user by magnetic sensor 91 and drives movable body 20 in an operation pattern corresponding to the operation to apply a haptic sensation as an operation feeling corresponding to the pushing-in operation.

Operation input apparatuses 1 and 100 (specifically, microcontroller 400) supply a current in accordance with the stroke of movable body 20 detected by magnetic sensor 91 such as a Hall sensor, drives movable body 20, and controls a reaction force or thrust of movable body 20 (operation surface portion 5) in response to the pushing-in.

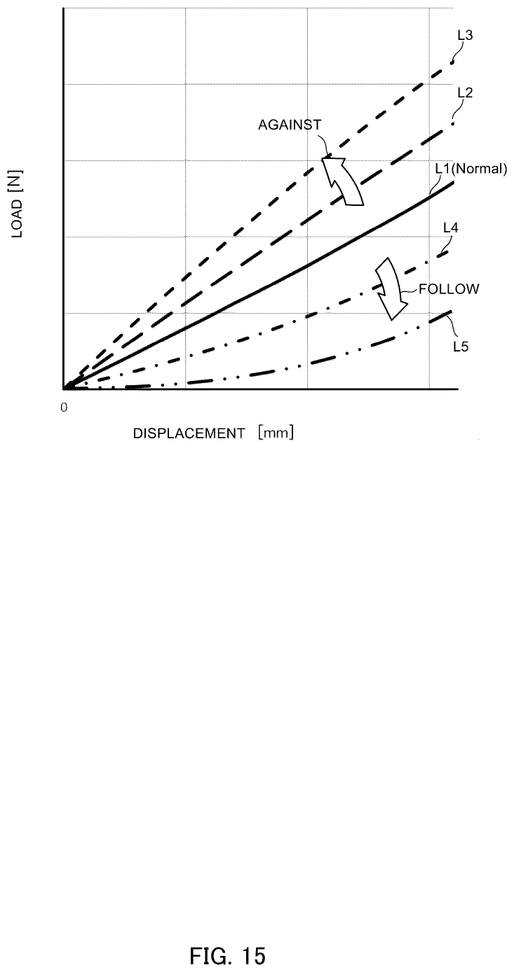

FIG. 15 is a view showing an example of operation control of the actuator, and illustrates F-S curves showing a relationship between the displacement [mm] of the movable body of the actuator and the load [N] applied to the movable body. FIG. 15 shows haptic sensations as an example of expression by proportional current inputs (graphs L1 to L5) corresponding to the F-S curves.

Actuator 10 is set to apply a reaction force (or thrust) to movable body 20 (operation surface portion 5 that is pushed in) for displacement, for example, such that a relationship with an input current shown in FIG. 15 is satisfied. For example, in a case where graph L1 is an input current of a normal haptic sensation, this input current is used as a reference and actuator 10 is controlled to be driven such that graphs L2 and L3 are obtained and a reaction force (“AGAINST”) in a direction opposite to the operation direction is applied. In addition, the actuator is driven such that graphs L4 and L5 are obtained to apply thrust that follows the pressing in the operation direction. Accordingly, actuator 10 imparts a hard haptic sensation to the user and is controlled as in the cases of L4 and L5. Microcontroller 400 can vary the current to satisfy the relationship of graphs L1 to L5 or the like in accordance with the operation amount (stroke) and can change the hardness or softness of operation surface portion (operation part) 5 as the haptic sensation to be applied. That is, actuator 10 can perform the actuation of movable body 20 by supplying a current variable in accordance with the operation amount by the user and can change the hardness or softness of the haptic sensation as the operation feeling to be applied to the user.

For example, actuators 10 (10-1 to 10-3) connected to operation surface portions 5-1 to 5-3 are driven such that the thrust is applied as described above, to present a haptic sensation to the user.

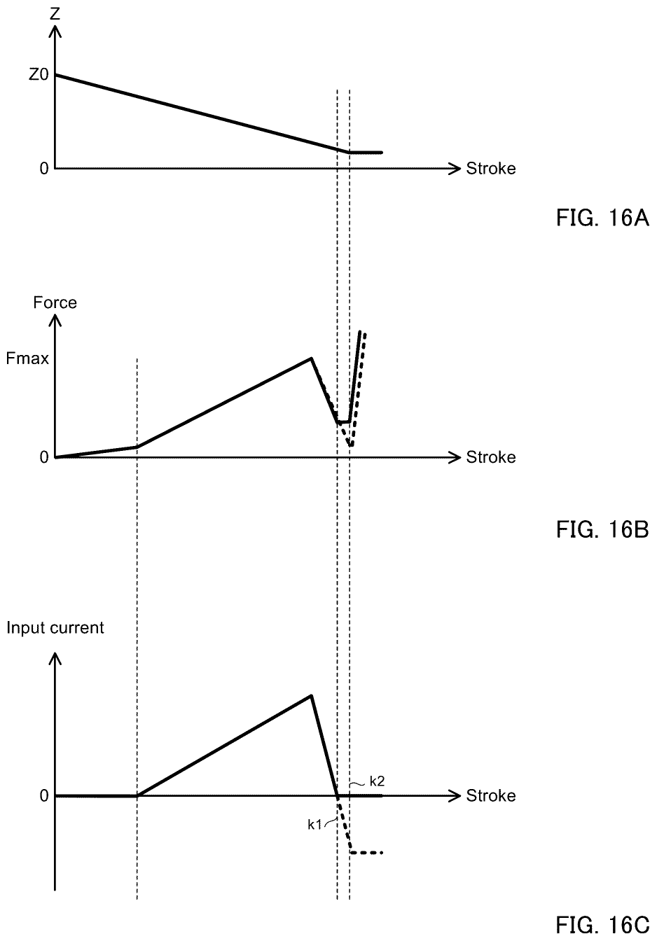

FIGS. 16A to 16C are views showing an example of operation patterns of the actuator, and specifically, FIGS. 16A to 16C are views showing an outline of a haptic sensation expressed by an operation of the actuator in a case where the operation surface portion is operated by the user. FIG. 16A shows a stroke of movable body 20 corresponding to a pushing-in amount of a button returning from top position Z0 to initial position 0. FIG. 16B shows a relationship between a stroke (“Stroke”) corresponding to the pushing-in amount as an operation pattern of the actuator corresponding to the pushing-in amount of FIG. 16A and force (here, a reaction force: “Force”) generated in accordance with the stroke. FIG. 16C shows a relationship between the stroke and the input current corresponding to the reaction force shown in FIG. 16B.

FIGS. 16A to 16C show two operation patterns in which the heights of the input currents are different between lengths of strokes (Stroke) k1 and k2, and the pattern shown by a broken line expresses a deeper haptic sensation than the pattern shown by a solid line and expresses a click sensation in a case where a click rate is low. Note that, the click rate is an indicator for expressing buckling of a switch, is calculated using a point at which buckling is caused by pushing in the switch and a reaction force value at which the reaction force is a minimum value when the switch is further pushed in, and indicates a degree of force applied to the user in a case of buckling.

As shown in FIGS. 16A to 16C, actuator 10 varies a bias current (input current) supplied to the coil in accordance with the pushing-in amount (operation amount) of movable body 20 by the user pressing operation surface portion 5.

Actuator 10 applies a reaction force to movable body 20 or adds thrust to movable body 20 in response to the pushing-in amount of movable body 20 by means of, for example, the bias current to be supplied. In addition, actuator 10 controls the driving of movable body 20 by decreasing the bias current to be supplied or causing the bias current to flow in an opposite direction at a stage where the bias current exceeds a threshold value. That is, actuator 10 can set the bias current to be variable in accordance with the operation amount of operation surface portion 5 and can vary the operation feeling in a case of operating operation surface portion 5 such that the operation feeling corresponds to the preference of the user.

As described above, actuator 10 performs the actuation of movable body 20 by varying the bias current in accordance with the operation amount by the user, applies a reaction force to the movable body, and can express a buckling haptic sensation as the operation feeling to the user by means of a current that decreases or a current that flows in the opposite direction at a stage where the current exceeds the threshold value. In this way, operation input apparatus 1 can vary the current supplied to coils 61 and 62 to change the expression of the hardness or softness of the operation feeling, the buckling haptic sensation, and the like, and can impart a more excellent operation haptic sensation.

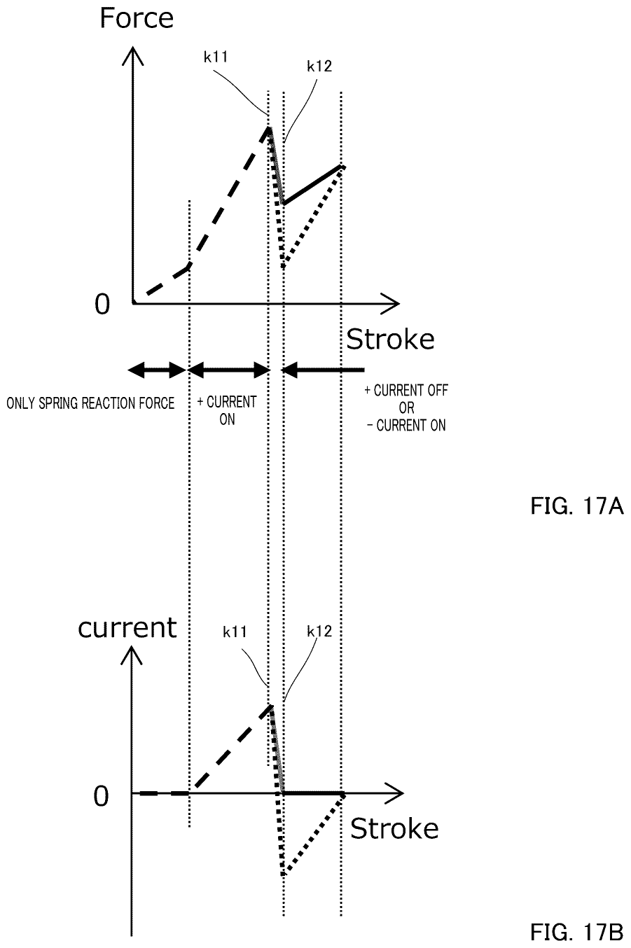

FIGS. 17A and 17B are views showing an example of operation patterns of operation input apparatus 1, and specifically, FIGS. 17A and 17B are views showing an example of a waveform for describing a case of expressing a switch in operation pattern control of the actuator. FIG. 17A is a view showing a relationship between a stroke (“Stroke”) of the pushed-in movable body 20 and force (“Force”), so-called, an F-S curve. The F-S curve indicates an operation force, a reaction force, a click rate, and the like of the operation surface portion (movable body) that determine a haptic sensation of the switch. In addition, FIG. 17B shows a relationship between the stroke of pushed-in movable body and a haptic sensation (specifically, an input current in a case of applying a reaction force (“Force”) in an upward direction, that is, in a case of force feedback (FFB)). Note that, the click rate can be said to be a proportion between an actuation force acting on a finger pushing in and a force of pushing in.

In FIGS. 17A and 17B, in a case where operation surface portion 5 is pushed in, operation surface portion 5 moves (performs a stroke) downward while receiving a reaction force of elastic supporting parts 81 and 82. That is, at the start of pushing in operation surface portion 5, the user who presses operation surface portion 5 receives only the reaction force (force opposite to a pushing-in direction) of elastic supporting parts (for example, leaf springs) 81 and 82 as a haptic sensation.

Then, in a case where the user pushes in operation surface portion 5 while receiving the reaction force of elastic supporting parts 81 and 82 and operation surface portion 5 reaches a predetermined stroke position, microcontroller 400 starts feeding power to actuator (coil) at “+ current ON.” Accordingly, the reaction force against the pushing force of the user is increased, and a haptic sensation of pressing the button is applied to the user.

As described above, microcontroller 400 varies the current in accordance with the operation amount (stroke) and applies the force (reaction force: “AGAINAST”) to operation surface portion 5 while increasing the force, and decreases the current (“+ current OFF”) or causes the current to flow in the opposite direction (in FIG. 17B, the current flows from set value k11 to k12) at a stage where the set value (threshold value) k11 is exceeded, so that a buckling haptic sensation is expressed. With this buckling haptic sensation, it is possible to recognize the input of the switch as a haptic sensation.

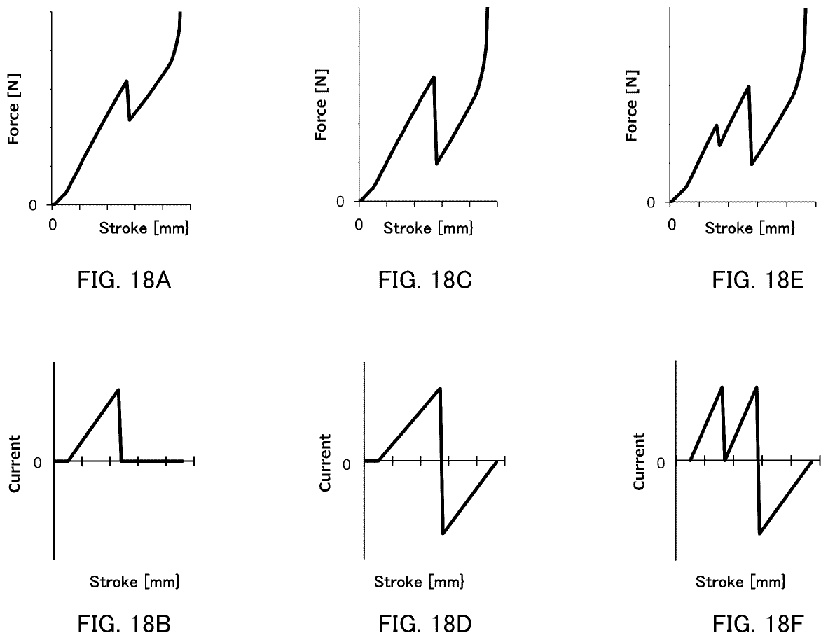

FIGS. 18A to 18F are views showing an example of operation patterns in a case of expressing a switch in operation pattern control of the actuator, and are views for describing switch expression based on the switch expression of FIGS. 17A and 17B. Note that, FIGS. 18A, 18C, and 18E are “F-S curves” in which a vertical axis corresponds to a load and a horizontal axis corresponds to a moving amount. FIGS. 18A and 18B show a relationship between a force (reaction force or thrust: “Force [N]”), a pushing-in amount (“Stroke [mm]”), and an input current (“Current”) in a case of expressing a switch having a low click rate. FIGS. 18C and 18D show a relationship between a force (reaction force or thrust: “Force [N]”) and a pushing-in amount, and a relationship between an input current (“Current”) and the pushing-in amount (“Stroke [mm]”) in a case of expressing a switch having a high click rate. FIGS. 18E and 18F show a relationship between a thrust and a pushing-in amount, and a relationship between an input current and a pushing-in amount in a case of expressing a two-stage click. In a case of expressing a low click rate in this way in the switch expression, actuator 10 is controlled such that the depth of pushing in is imparted more as a haptic sensation, as compared to a case of expressing a high click rate.

In FIGS. 18E and 18F, the increased reaction force is increased by decreasing the + current or turning OFF the + current at predetermined two positions in the stroke, and causing the − current to flow to increase the thrust. Then, a reaction force is applied at a predetermined pushed-in position instead of the increased thrust, and the haptic sensations are applied twice to enable the haptic sensation of the two-stage switch to be applied. Although the haptic sensations are applied at two stages here, a multi-stage switch expression can be realized by controlling movable body 20 to be pushed in to generate a reaction force and thrust at a plurality of set positions and configuring movable body 20 to apply a haptic sensation of three or more stages.

In this way, actuator 10 actuates movable body 20 in a multi-stage manner in the moving direction in accordance with the operation amount of movable body 20 due to the operation by the user, so as to apply an operation feeling to the user.

In each switch expression of FIGS. 18A to 18F, as in the operation in the switch expression shown in FIGS. 17A and 17B, in a case where movable body 20 to be pushed in reaches a predetermined stroke (set value), the current is turned OFF or a reaction force (force “AGAINST”) is generated, so that a click sensation and a switch-like tactile sensation can be appropriately generated.

As shown in FIGS. 15 to 18F, operation input apparatus 1 (specifically, microcontroller 400) drives actuator 10 to express a switch that generates vibration feedback or force feedback.

### <Example of Operation Using Operation Pattern: Vibration Feedback (FB)>

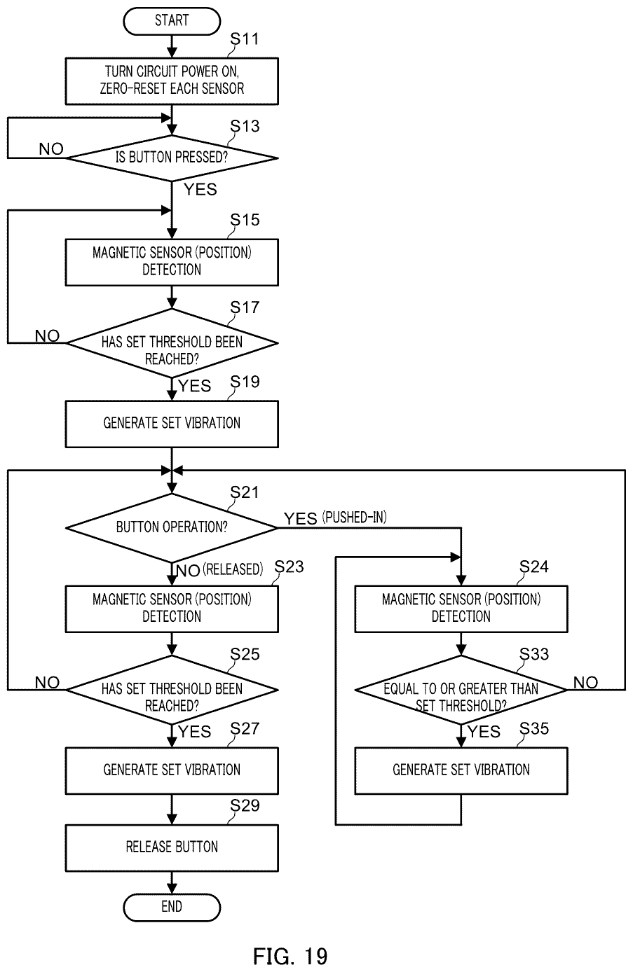

FIG. 19 is a flowchart showing an example of an operation using the operation patterns of the operation input apparatus, and shows control of an operation of vibration feedback that applies vibration to the user in response to the operation. Note that, in the following flowchart, operation surface portion 5 as the operation part is referred to as a “button.”

As shown in FIG. 19, in step S11, in a case where a circuit power supply is turned on, sensors, such as proximity sensors 404 and magnetic sensors 91, are zero-reset. Next, in step S13, microcontroller 400 monitors the pressing of the button via magnetic sensor 91, and in a case where the button is pressed, microcontroller 400 detects position information on movable body 20 via magnetic sensor 91 in step S15. That is, in step S15, microcontroller 400 detects the position of movable body 20 by means of magnetic sensor 91 to detect a pressed state (pushed-in position) of movable body 20, that is, the position of the operated button (operation surface portion 5).

Next, in step S17, microcontroller 400 determines whether or not the position (stroke) of movable body 20 has reached a set threshold value (depth from a pushing-in start position). In step S17, microcontroller 400 determines whether or not the displacement amount of operation surface portion 5 (the displacement amount of movable body 20 due to being pressed) has reached a predetermined amount (a predetermined length of movement). In addition, for the determination in step S17, the threshold value is set including a dead zone in order to prevent malfunction such as vibration caused in a case where a predetermined position is not reached. Note that, the threshold value is set to provide an appropriate operation feeling for generating a haptic sensation.

In step S17, in a case where the position of movable body 20 displaced through the operation has reached a predetermined position, that is, in a case where operation surface portion 5 has been pressed by a predetermined length, the process proceeds to step S19. In step S19, microcontroller 400 drives actuator 10 via actuator driver 430 to cause actuator 10 to perform a predetermined operation (for example, to generate vibration set as in the switch expression shown in FIGS. 15 to 17).

Next, in step S21, microcontroller 400 determines whether or not the button (operation surface portion 5) is operated via magnetic sensor 91, and in a case where no operation is performed (in a case where the button is “released”), the process proceeds to step S23. In step S23, microcontroller 400 detects a position where the pushing-in of the button is stopped (the “release” position of the button) and the process proceeds to step S25.

On the other hand, in step S21, in a case where the pushing-in operation of the button is performed, the process proceeds to step S24, and microcontroller 400 detects the position of movable body 20, that is, the pushed-in position of operation surface portion 5 via magnetic sensor 91 and the process proceeds to step S33.

In step S33, microcontroller 400 determines whether or not the pushed-in position of the button is the set threshold value (step S33). In step S33, in a case where it is equal to or greater than the set threshold value, microcontroller 400 generates an operation pattern set for the operation, for example, vibration in step S35, and in a case where the set threshold value is not reached, the process returns to step S21 and the process is repeated.

In step S25, microcontroller 400 determines whether or not the position where the pushing-in of the button is stopped has reached the set threshold value, and in a case where the position has reached the threshold value, the process proceeds to step S27, and in a case where the position has not reached the threshold value, the process returns to step S21 and the process is repeated.

That is, in step S25, in a case where the button operation is released and the pushing-in amount when the button operation is released has reached the set pushing-in amount (threshold value), the process proceeds to step S27. In step S27, microcontroller 400 generates vibration by using the operation pattern for generating the set vibration, and the finger that receives the vibration as a haptic sensation is separated from the button (step S29).

As described above, microcontroller 400, that is, operation input apparatus 1 feeds back vibration corresponding to the operation to the user in a case where the user pushes in and operates operation surface portion 5.

### <Example of Operation Using Operation Pattern: Force Feedback (FFB)>

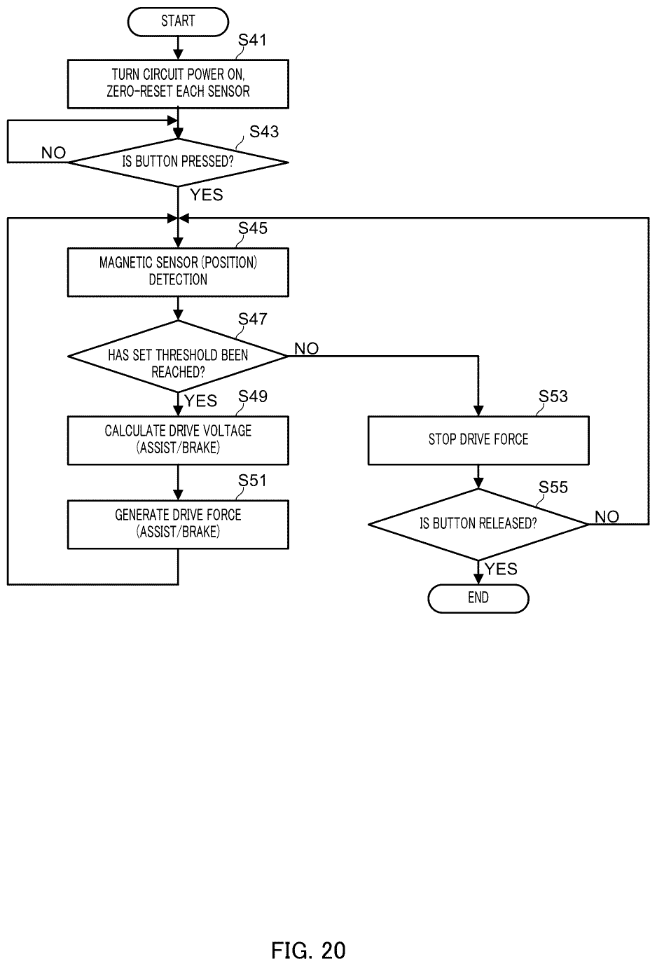

FIG. 20 is a flowchart showing an example of an operation using the operation patterns of the operation input apparatus, and specifically, FIG. 20 shows processing of a force feedback operation as an example of processing of applying a haptic sensation that assists the operation by the user who operates operation surface portion 5.

As shown in FIG. 20, in step S41, in a case where a circuit power supply is turned on, sensors, such as proximity sensors 404 and magnetic sensors 91, are zero-reset. Next, in step S43, microcontroller 400 monitors the pressing of the button via magnetic sensor 91, and in a case where the button is pressed, microcontroller 400 detects position information on movable body 20 via magnetic sensor 91 in step S45. That is, in step S45, microcontroller 400 detects the position of movable body 20 by means of magnetic sensor 91 to detect a state of operated movable body 20, that is, the pressed state (pushed-in position) of operation surface portion 5.

Next, in step S47, microcontroller 400 determines whether or not the position of movable body 20 has reached a predetermined position, that is, whether or not the detected position has reached a set position (threshold value). That is, in step S47, microcontroller 400 determines whether or not the displacement amount of operation surface portion 5 (the displacement amount of movable body 20 due to being pressed) has reached a predetermined amount (a predetermined length of movement). In step S47, in a case where the position of movable body 20 has reached a set predetermined position, that is, in a case where operation surface portion 5 has been pressed by a predetermined length, the process proceeds to step S49. Note that, similarly to the threshold value in step S17, the threshold value in step S47 is set including a dead zone in order to prevent malfunction such as vibration in a case where a predetermined position is not reached.

In step S49, microcontroller 400 calculates a drive voltage of actuator 10, that is, sets a driving force (specifically, assisting or braking the operation by the user) for operating the actuator, and the process proceeds to step S51.

In step S51, microcontroller 400 drives the actuator via actuator driver 430 to generate a driving force such as an assisting force (thrust) or braking force (reaction force). Accordingly, movable body 20 moves, applies a haptic sensation that stimulates the force sense of the user via operation surface portion 5, and the process returns to step S45 to repeat the process.

In step S47, in a case where the position (displacement amount) of movable body 20 has not reached the set threshold value, the process proceeds to step S53, and microcontroller 400 stops the generation of the driving force by actuator 10 and the process proceeds to step S55.

In step S55, microcontroller 400 detects whether or not the finger of the user is separated from the button based on the input information from magnetic sensor 91, returns to step S45 and repeats the process in a case where the finger is not separated, and ends the process in a case where the finger is separated.

<Operation Pattern Control of Example of Operation: One-Stage Switch Expression with Morphing Function>

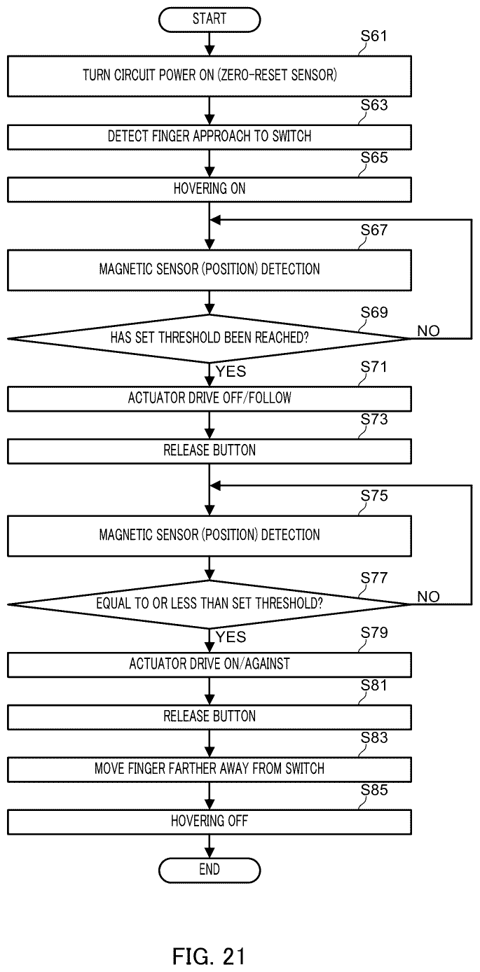

FIG. 21 is a flowchart showing an example of an operation using the operation patterns of the operation input apparatus according to Embodiment 1 of the present invention, and specifically, FIG. 21 shows operation processing of switch expression that applies a one-stage haptic sensation with a morphing function. Note that, hereinafter, operation surface portion 5 as the operation part in operation input apparatus 1 is referred to as a button, and a portion including operation surface portion 5 is also referred to as a switch.

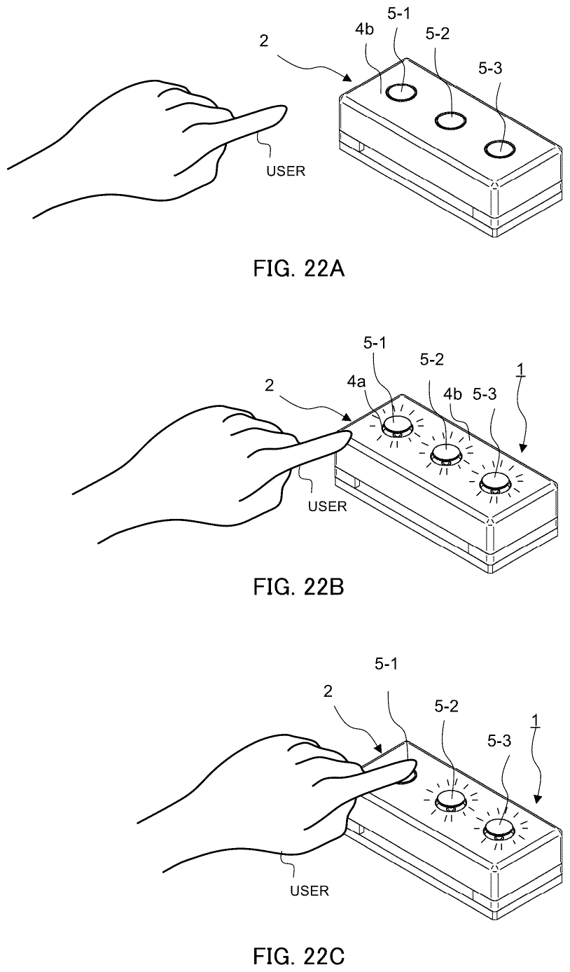

As shown in FIG. 21, in step S61, first, in a case where a circuit power supply is turned on, operation input apparatus 1 is driven, and proximity sensors 404 and magnetic sensors 91 are zero-reset. FIGS. 22A to 22C show an example of operation input apparatus 1 in this state. FIGS. 22A and 22B are views showing an example of an operation of the operation input apparatus according to Embodiment 1 of the present invention.

As shown in FIG. 22A, in order to move operation surface portion 5 (5-1) of the switch portion, the user brings a finger close to operation surface portion 5 with respect to operation input apparatus 1. Then, in step S63, proximity sensor 404 detects the approach of the finger to the switch and outputs detection information to microcontroller 400 (see FIG. 13). In step S63, microcontroller 400 (see FIG. 13) detects the approach of the finger via proximity sensor 404 and the process proceeds to step S65.

In step S65, microcontroller 400 drives actuator 10 to displace operation surface portion 5 (and also movable body 20). That is, operation surface portion 5 (and also movable body 20) is displaced to the hovering state (“Hovering ON”), which is a state in which operation surface portion 5 is moved upward and protrudes, in an operation of hinting an operation to be performed on operation surface portion 5 itself (see FIG. 22B). In this way, in the switch having operation surface portion 5, operation surface portion 5 itself presents the operation position of operation surface portion 5 to the user or prompts the operation using operation surface portion 5 by protruding and displacing (morphing) from front surface 4b.

In addition, microcontroller 400 brings operation surface portion 5 into a state where the user can perform an operation. The state where the user can move operation surface portion 5 is a state where when operation surface portion 5 directly connected to actuator 10 is operated, actuator 10 can be operated in a plurality of operation patterns by microcontroller 400 in order to give a haptic sensation corresponding to the operation.

This state is shown in FIG. 22B. That is, in a case where the finger of the user approaches operation surface portion 5, all operation surface portions 5, which are the operation part of operation input apparatus 1, rise. Accordingly, operation surface portion enters a state that is easy to see and easy to operate, and allows the user to visually recognize the position of operation surface portion 5 and prompts the operation by operation surface portion 5 as a result of displacement or motion of operation surface portion 5 itself.

Note that, in the present embodiment, microcontroller 400 is configured to emit light in a case of driving actuator 10 (10-1, 10-2, 10-3) to raise, that is, to cause operation surface portion 5 to hover as shown in FIG. 22B.

Specifically, a light emitter such as an LED is provided in operation surface portion itself or in the vicinity of operation surface portion 5. The light emitters are subjected to drive control by microcontroller 400 to emit light in accordance with the movement of movable body 20. Therefore, light emission allows visual recognition of the position of operation surface portion 5 or the operation being performed, and can prompt the user to perform an operation using operation surface portion 5. In addition, each time operation surface portion 5-1, 5-2, or 5-3 is pressed, on and off of the switch can be switched, and in this case, the light emitters may be controlled to light up or to be turned off.

Then, as shown in FIG. 22C, in a case where the user presses operation surface portion 5 (5-1) waiting in the hovering state, in step S67, magnetic sensor 91 detects the position of movable body 20 due to the operation of operation surface portion 5. That is, in step S67, magnetic sensor 91 detects the displacement of movable body 20, that is, detects the load applied to movable body 20 by the pushing-in operation of the button (operation surface portion 5), and transmits the detected detection information to microcontroller 400.

In step S69, microcontroller 400 determines whether or not a numerical value corresponding to the position of movable body 20 has reached a set threshold value corresponding to a set position, repeats the determination until the set threshold value is reached, and proceeds to step S71 in a case where the set threshold value is reached. Note that, since the set threshold value also includes the dead zone and the threshold value is a value outside the dead zone, the threshold value is set to be higher than an exact regular set value.

In step S71, microcontroller 400 applies, as the switch operation, a haptic sensation of further pressing in addition to a haptic sensation of pressing in the pressing direction in a case where operation surface portion 5 is pressed. That is, in step S71, microcontroller 400 operates to present a haptic sensation of following the operation by the user without applying force in the direction opposite to the pressing direction to movable body 20 via actuator 10 to the user (“Actuator drive OFF Follow”).

Next, in step S73, microcontroller 400 detects the release of the pressed state of operation surface portion 5, which is the button, via magnetic sensor 91, and in step S75, microcontroller 400 acquires the released position via magnetic sensor 91 and the process proceeds to step S77.

In step S77, microcontroller 400 determines whether or not a value indicating the position where the button is released (specifically, the pressed state is released) is equal to or less than the set threshold value, and in a case where the value is equal to or less than the set value, the process proceeds to step S79. In a case where the value is not equal to or less than the set value, the process returns to step S75 and the process is repeated.

In step S79, microcontroller 400 drives actuator 10 in a predetermined operation and applies the operation to the finger of the user via operation surface portion 5, which is the button. In the predetermined operation in step S79, for example, force feedback driving (“Actuator drive ON/Against”) is performed, that is, a load (against the pressing) in a direction opposite to the pressing direction is applied to operation surface portion 5 to move operation surface portion 5.

Accordingly, in a case where the user stops pressing the button or separates the finger from the button, a haptic sensation of releasing the button from the pressed state is applied to the user. Next, in step S81, microcontroller 400 detects that the finger is separated from the button (operation surface portion 5) but is positioned close to operation input apparatus 1 (operation surface portion 5) based on the detection information input from magnetic sensors 91 and proximity sensors 404.

Next, in step S83, in a case where microcontroller 400 detects via proximity sensors 404 that the finger is spaced apart, the process proceeds to step S85. In step S85, microcontroller 400 drives the actuator via actuator driver 430 to turn OFF hovering, that is, to release the state where operation surface portion 5 protrudes. Accordingly, front surface 4b of case 2 of operation input apparatus 1 enters a flat state.

In this way, in operation input apparatus 1 of the present embodiment, for example, in a case where operation surface portion 5 as the operation part is used as a switch, and the user intends to move operation surface portion 5 in a state of a seamless design, operation surface portion 5 itself is operated to allow the user to check the position thereof. In addition, it is possible to prompt the user to perform an operation by the movement of operation surface portion 5 itself.

Then, in a case where operation surface portion 5 is operated, actuator 10 is driven in various set operation patterns to drive (vibrate and displace) movable body 20, and a haptic sensation corresponding to the operation can be expressed and applied.

<Example of Operation Using Operation Pattern: Multi-Stage Switch Expression with Morphing Function>

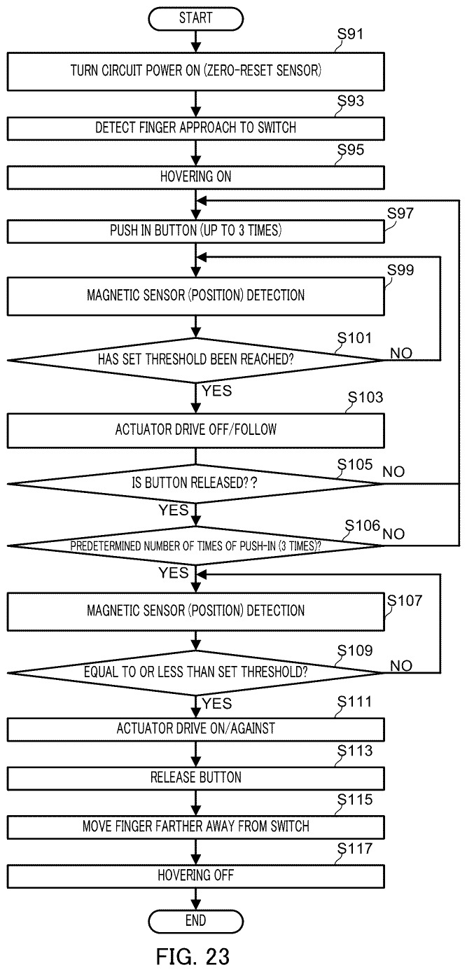

FIG. 23 is a flowchart showing an example of an operation of the actuator, and shows a case of expressing a multi-stage (for example, three-stage) switch.

As shown in FIG. 23, in step S91, first, in a case where a circuit power supply is turned on, operation input apparatus 1 is driven, and proximity sensors 404 and magnetic sensors 91 are zero-reset. In a case where a finger is brought close to operation surface portion 5 of operation input apparatus 1 as a switch to move operation surface portion 5, in step S93, proximity sensor 404 detects the approach of the finger to the switch, and detection information is output to microcontroller 400. In step S93, microcontroller 400 detects the approach of the finger and the process proceeds to step S95.

In step S95, microcontroller 400 drives actuator 10 to move operation surface portion 5 (and also movable body 20) in a manner of hinting the operation, or displaces operation surface portion 5 to a state of being moved upward and protruding, that is, a hovering state (“Hovering ON”). That is, operation surface portion 5 presents the operation position of operation surface portion 5 to the user or prompts the operation using operation surface portion 5 by protruding and displacing (morphing) from front surface 4b.

In addition, microcontroller 400 brings operation surface portion 5 into a state where the user can perform an operation. The state where the user can move operation surface portion 5 is a state where when operation surface portion 5 directly connected to actuator 10 is operated, actuator 10 can be operated in a plurality of operation patterns by microcontroller 400 in order to give a haptic sensation corresponding to the operation.

In this way, in step S95, as in the processing in step S65 (see FIG. 21), microcontroller 400 operates (raises) all operation surface portions 5, which are the operation part of operation input apparatus 1, in a case where the finger of the user approaches operation surface portion 5. Operation surface portion 5 is operated (raised) to make it easy to recognize operation surface portion 5, and the operation itself prompts the operation. In addition, a light emitter such as an LED may be provided in operation surface portion 5 itself or in the vicinity of operation surface portion 5, and the light emitter may be subjected to drive control by microcontroller 400 to emit light in accordance with the movement of movable body 20. Light emission by the light emitter allows further recognition of the position of operation surface portion 5 or operation surface portion 5 being operated, and prompts the user to perform an operation using operation surface portion 5.

Next, in step S97, operation surface portion 5, which is a button, is pushed in (up to three times), and the process proceeds to step S99. In step S99, magnetic sensor 91 detects the load applied to movable body 20 as the pushing-in operation of movable body 20 due to the operation.

In step S99, magnetic sensor 91 detects the displacement of movable body 20, that is, detects the load applied to movable body 20 by the pushing-in operation of the button (operation surface portion 5), and transmits the detected detection information to microcontroller 400. Microcontroller 400 detects the position of movable body 20 based on the detection result from magnetic sensor 91. In this case, microcontroller 400 can detect the positions of movable body 20 to be detected corresponding to the number of stages of the switch to be expressed (for example, for a predetermined number of times such as three times).

Next, in step S101, microcontroller 400 determines whether or not a value corresponding to the position of movable body 20 has reached a set value (threshold value), and repeats the determination until the set threshold value is reached. That is, in step S101, it is determined whether or not movable body 20 is pushed in by a predetermined stroke. In step S101, in a case where movable body 20 has reached the set threshold value, the process proceeds to step S103.

In step S103, microcontroller 400 causes actuator 10 to perform a predetermined operation. In this flow, microcontroller 400 applies, as the switch operation, a haptic sensation of further pressing in addition to a haptic sensation of pressing in the pressing direction in a case where operation surface portion 5 is pressed. That is, in step S103, microcontroller 400 operates to present a haptic sensation of following the operation by the user without applying force in the direction opposite to the pressing direction to movable body 20 via actuator 10 to the user (“Actuator drive OFF Follow”). This is set by an operation pattern (a reaction force and a stroke) corresponding to the number of times the button is pushed in.

Next, in step S105, microcontroller 400 determines via magnetic sensors 91 whether or not the pressed state of operation surface portion 5, which is the button, is released, and returns to step S97 in a case where the pressed state is not released, that is, in a case where the button is still being pressed (being operated) by the user. In step S105, in a case where microcontroller 400 detects that the button is in the released state, the process proceeds to step S106.

In step S106, it is detected based on the detection result of magnetic sensor 91 whether or not the number of times the button is pushed in is a predetermined number of times, and the process returns to step S97 and is repeated until the position of the stroke reaches a position corresponding to the predetermined number of times, and a haptic sensation for each number of times is applied. In step S106, in a case where the number of times the button is pushed in has reached the predetermined number of times, for example, in a case where the button is pressed up to three stages, the process proceeds to step S107.

In step S107, microcontroller 400 acquires via magnetic sensor 91 a position where the button is released, and the process proceeds to step S109.

In step S109, microcontroller 400 determines whether or not a value indicating the position where the button is released (specifically, the pressed state is released) is equal to or less than the set threshold value, determines that the button pressing is stopped in a case where the value is equal to or less than the set value, and the process proceeds to step S111. In a case where the value is not equal to or less than the set value, the process returns to step S107 and the process is repeated.

In step S111, microcontroller 400 drives actuator 10 in a predetermined operation and applies the operation to the finger of the user via operation surface portion 5, which is the button. In the predetermined operation in step S111, for example, force feedback driving (“Actuator drive ON/Against”) is performed, that is, a load (against the pressing) in a direction opposite to the pressing direction is applied to operation surface portion 5 to move operation surface portion 5. Accordingly, in a case where the user stops pressing the button or separates the finger from the button, a haptic sensation of releasing the button from the pressed state is applied to the user. Next, in step S113, microcontroller 400 detects that the finger is separated from the button (operation surface portion 5) but is positioned close to operation input apparatus 1 (operation surface portion 5) based on the detection information input from magnetic sensors 91 and proximity sensors 404.

Next, in step S115, in a case where microcontroller 400 detects via proximity sensors 404 that the finger is spaced apart, the process proceeds to step S117. In step S117, microcontroller 400 drives the actuator via actuator driver 430 to turn OFF hovering, that is, to release the state where operation surface portion 5 protrudes. Accordingly, front surface 4b of operation input apparatus 1 enters a flat state.

In this way, in operation input apparatus 1 of the present embodiment, in a case where the user intends to move operation surface portion 5 in a state of a seamless design, operation surface portion 5 itself is operated to allow the user to check the position thereof. In addition, it is possible to prompt the user to perform an operation by the movement of operation surface portion 5 itself.

Then, in a case where operation surface portion 5 is operated, actuator 10 is driven in various set operation patterns to drive (vibrate and displace) movable body 20, and a haptic sensation corresponding to the operation can be expressed and applied as an operation feeling.

As described above, with operation input apparatus 1, the position of operation surface portion 5 can be presented to the user by the actuation of operation surface portion 5 accompanying the actuation of movable body 20, and it is possible to achieve size reduction while ensuring the operability and the operation feeling of operation surface portion 5 in a case of operating operation surface portion 5.

### <Other Operations>

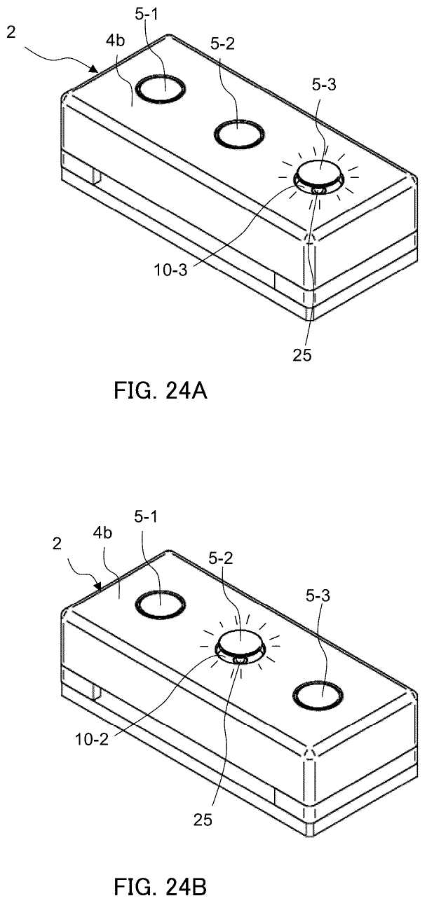

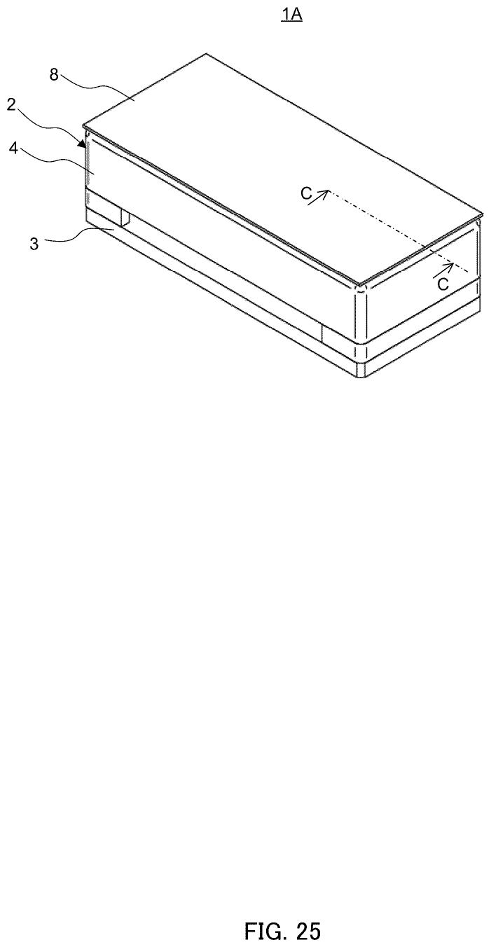

FIGS. 24A and 24B are views showing an example of an operation of the actuator.

In operation input apparatus 1, for example, as an operation of prompting the user to perform an operation by operation surface portion 5, as shown in FIGS. 24A and 24B, a plurality of actuators 10-2 and 10-3 are alternately driven such that respective operation surface portions 5 project and retract alternately from the front surface of apparatus case 2. The projection and retraction speed can also be appropriately set, so that it is possible to prompt the user to perform an operation. In addition, in a case of being operated by the approach of the finger of the user, microcontroller 400 acquires information from proximity sensors 404 (see FIG. 13) and drives actuators 10 (10-1 to 10-3).

### Embodiment 2

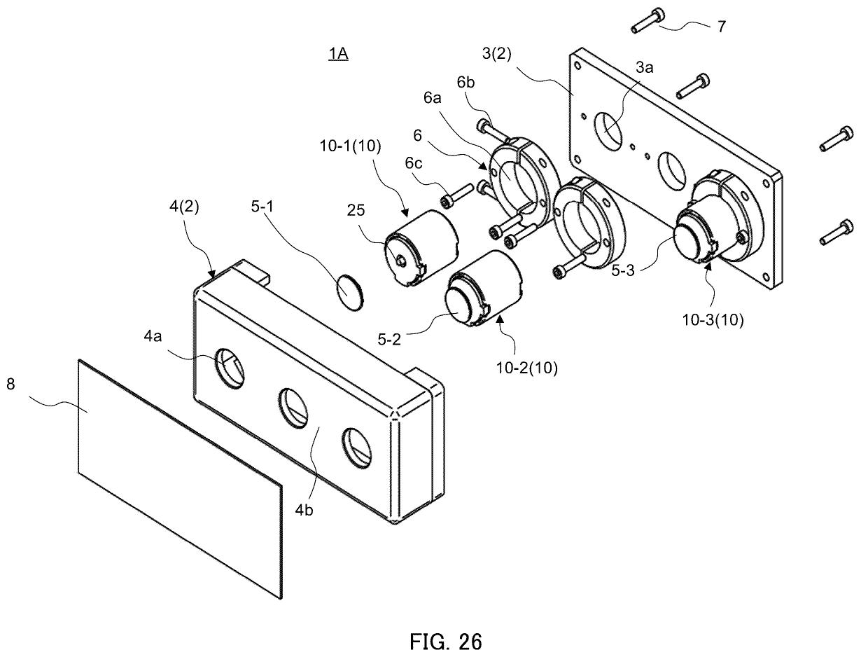

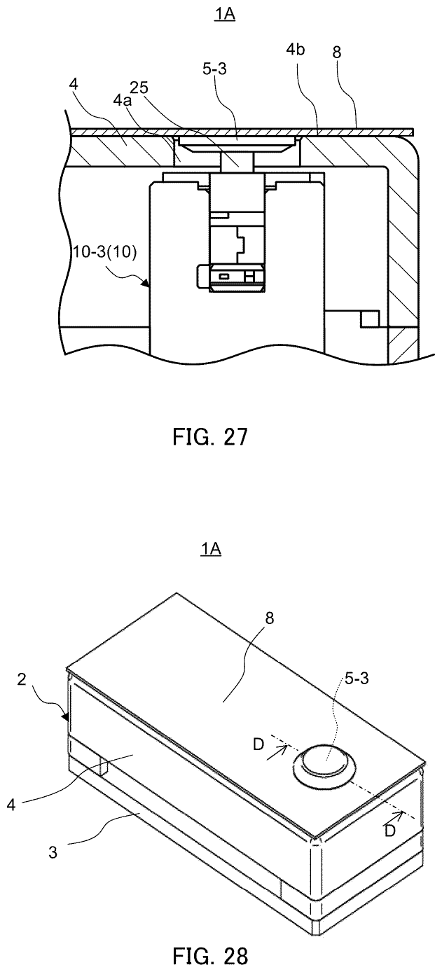

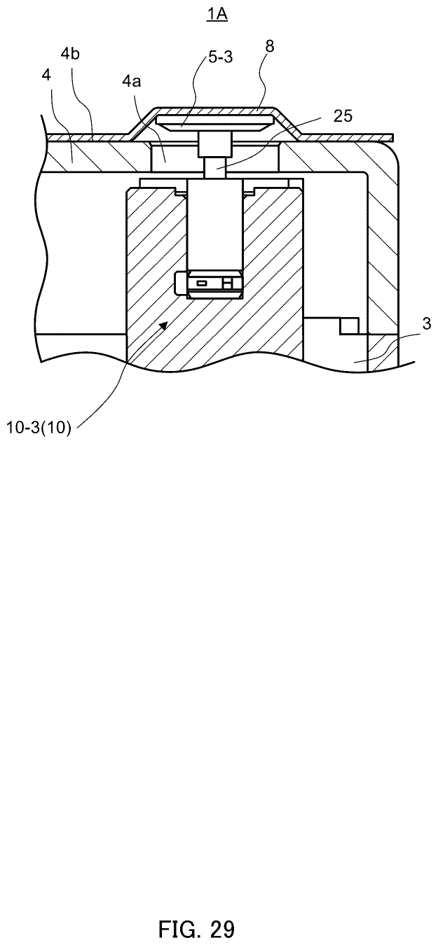

FIG. 25 is an external perspective view of an operation input apparatus according to Embodiment 2 of the present invention, FIG. 26 is an exploded perspective view of the operation input apparatus according to Embodiment 2 of the present invention, FIG. 27 is a partial sectional view taken along line C-C and seen in a direction of arrows C in FIG. 25, and FIG. 28 is an external perspective view showing the operation input apparatus according to Embodiment 2 of the present invention in which an operation surface portion is displaced. In addition, FIG. 29 is a partial sectional view taken along line D-D and seen in a direction of arrows D in FIG. 28.

Operation input apparatus 1A is different from operation input apparatus 1 in that the front surface of apparatus case 2 in which operation surface portion 5 which is an operation part is disposed is covered with soft surface-shaped flexible member (elastic surface-shaped portion) 8 to have a seamless appearance, and other configurations are the same.

That is, in operation input apparatus 1A, actuators 10-1, 10-2, and 10-3 held via holder 6 are accommodated inside apparatus case 2 as in operation input apparatus 1. Operation surface portions 5 as the operation part are respectively fixed perpendicularly to output shaft portions 25 of the movable bodies of actuators 10-1, 10-2, and 10-3.

The front surfaces of operation surface portions 5 are disposed to be movable in opening portions 4a of the front surface (front surface 4b of cover portion 4) of apparatus case 2 to be flush with front surface 4b of cover portion 4.

Deformable flexible member 8 is disposed on operation surface portions 5, and the front surface of cover portion 4, that is, the front surface of apparatus case 2 appears as a seamless front surface. In this way, flexible member 8 is disposed to cover operation surface portions 5 on front surface 4b of cover portion 4, and operation surface portions 5 can push up flexible member 8 from a back surface or push down flexible member 8 from a front surface side by the operation of movable body 20.

Flexible member 8 is formed of a sheet-like material that can expand and contract. Flexible member 8 may be formed of, for example, rubber, an elastomer, a sponge, or cloth.

As shown in FIGS. 28 and 29, in a case where operation surface portion 5 rises, flexible member 8 is pressed by operation surface portion 5 to be deformed without hindering the movement of operation surface portion 5, and flexible member 8 protrudes in a shape of operation surface portion 5.

In operation input apparatus 1A, the position of operation surface portion 5 can be checked by the user by driving the actuator to displace operation surface portion 5 on the front surface of apparatus case 2 where operation surface portion 5 is not visible. In addition, it is possible to prompt the user to perform an operation by operation surface portion 5.

Then, by pressing a portion of flexible member 8 above protruding operation surface portion 5 to operate the portion, operation input apparatus 1A applies a haptic sensation including vibration, a reaction force, displacement, and the like corresponding to the operation to the user via operation surface portion 5. Note that, operation input apparatus 1A has a function of detecting the position of operation surface portion 5 due to the operation and the load applied to operation surface portion 5.

With operation input apparatus 1A, the position of operation surface portion 5 can be presented to the user by the actuation of operation surface portion 5 accompanying the actuation of movable body 20, and it is possible to achieve size reduction while ensuring operability and an operation feeling of operation surface portion 5 in a case of operating operation surface portion 5.

Similarly to operation input apparatus 1, in operation input apparatus 1A, in a case where the user intends to operate the operation part (operation surface portion), that is, in a case where a situation of the user is observed, recognized, and determined, the operation part is moved to allow the position of the operation part to be recognized. In addition, operation input apparatus 1A can prompt the operation with operation surface portion 5 such that the user actively acts.

Such operation input apparatuses 1 and 1A of the present embodiment have a detection part (for example, user action detection part 94 shown in FIG. 13) that detects action of the user, such as proximity sensor 404. Accordingly, operation input apparatuses 1 and 1A drive actuator 10 directly connected to the operation part based on information from the detection part to apply a haptic sensation in response to the operation.

Therefore, operation input apparatuses 1 and 1A may predict next action of the user by using the detection part that detects the action of the user, and may operate the operation part depending on the action to prompt the user to operate the operation part.

For example, in a case where operation input apparatus 1 or 1A is used as the operation part of a switch that centrally operates power supplies of electric appliances including turning off the light of a house, and a detection part that detects that the user has returned home and opened the door of the entrance detects that the door of the entrance is opened, the switch is operated (light emission may be involved). Accordingly, it is possible to cause the user to recognize the location of the switch. Note that, opening and closing of the entrance door may be configured with a switch or the like that is turned on and off by opening and closing and outputs a signal indicating the on and off state to the microcontroller, or the entrance may be configured to detect the user who enters and exits the entrance using an imaging apparatus such as a camera.

In addition, in a case of driving a vehicle such as a shared car and a rental car, a place of an engine start key may be operated and made recognizable to the user when unlocking the vehicle.

In addition, in a case of getting into the vehicle, an insertion port for an ETC card, a mirror adjustment button, and a meter portion itself for checking a fuel level may be operated to be moved to allow recognition of a position to be operated.

For example, in operation input apparatuses 1 and 1A, a configuration in which a camera is provided as user action detection part 94 (see FIG. 13) instead of proximity sensor 404 is adopted, and a user who gets into a vehicle is imaged by the camera to detect the user. Microcontroller 400 that receives a detection signal from the camera that has detected the user drives actuator 10 to displace operation surface portion 5 such that operation surface portion 5 is visually recognized and a position of the insertion port for the ETC card is visually recognized. In addition, in a case where operation surface portion 5 is a button for adjusting an angle of a side mirror or a rearview mirror, the position of the button can be recognized, and adjustment of the angle of each mirror can be prompted. In addition, operation input apparatuses 1, 100, and 1A can also express human emotions such as joy, anger, and sadness by actuating movable body 20 that is integrated with operation surface portion 5 and operates as the operation part itself, at an appropriately changed actuation speed, actuation interval, and the like. For example, various expressions can be made, for example, by transmitting a force to apply a haptic sensation at a stronger and shorter interval (severe vibration) in the case of anger than in the case of sadness, and transmitting a force to apply a softer haptic sensation in the case of joy than other emotions.

However, in a configuration of force feedback added to an operation mechanism, in a case where a generation principle of vibration or force to be fed back does not utilize a phenomenon such as a collision or contact between components, an impact or sound caused by the phenomenon is not desirable from the viewpoint of operation feeling expression. In the following, an operation input apparatus capable of applying a high-quality operation feeling even from an actuator which is reduced in size will be described in consideration of the above point.

Hereinafter, the present embodiment will be described in detail with reference to the drawings. The same reference numerals will be assigned to common components in each figure, and description thereof will be omitted as appropriate.

### Embodiment 3

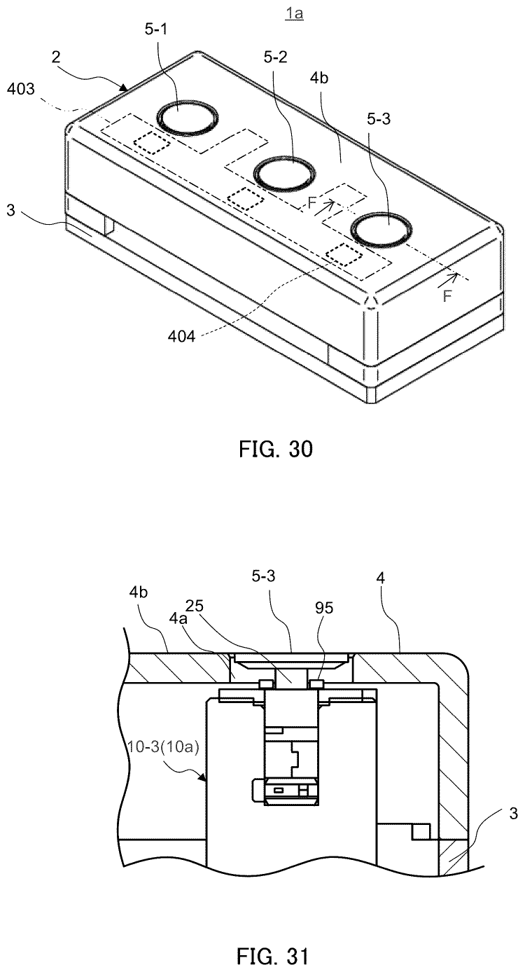

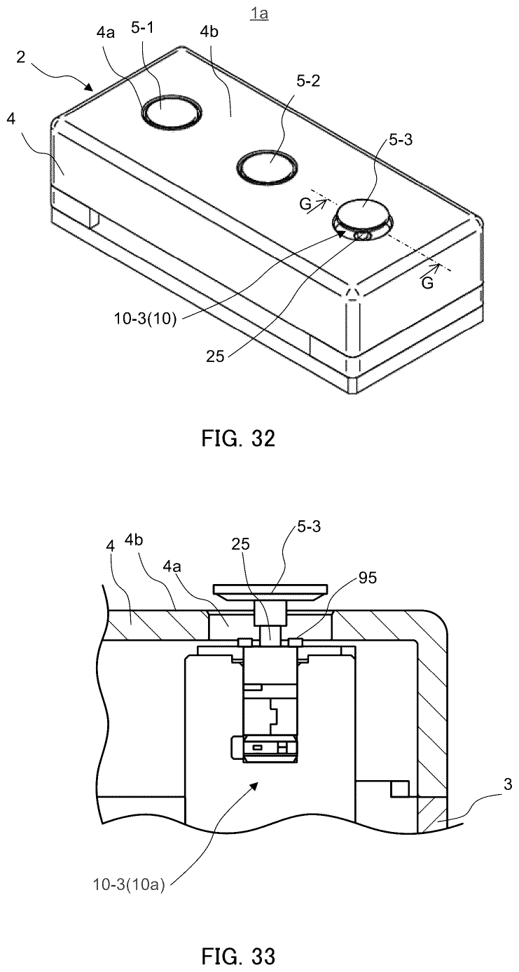

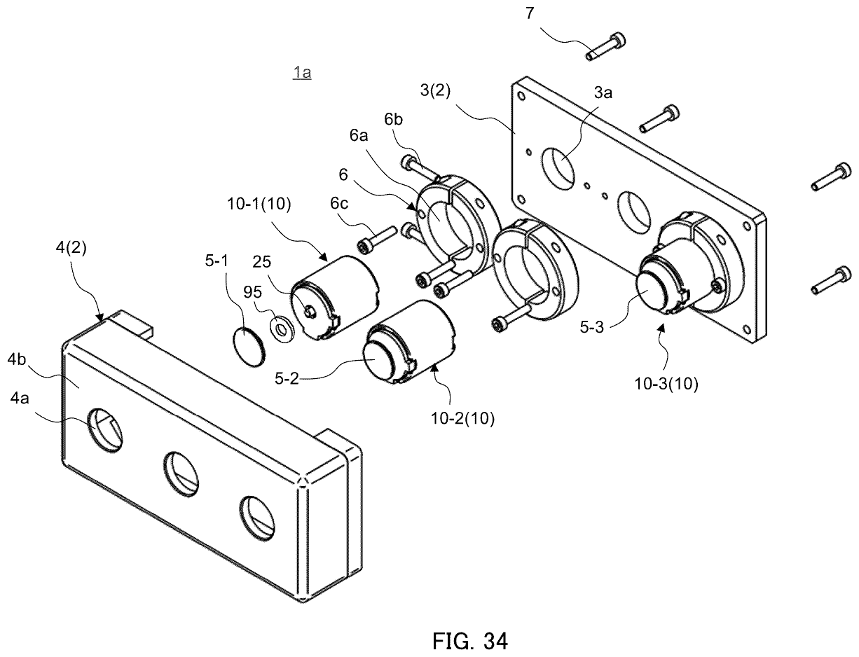

FIG. 30 is an external perspective view of an operation input apparatus according to Embodiment 3 of the present invention, and FIG. 31 is a partial sectional view taken along line F-F and seen in a direction of arrows F in FIG. 30. FIG. 32 is an external perspective view of a state where an operation surface portion is displaced in the operation input apparatus according to Embodiment 3 of the present invention, and FIG. 33 is a partial sectional view taken along line G-G and seen in a direction of arrows G in FIG. 32. In addition, FIG. 34 is an exploded perspective view of the operation input apparatus according to Embodiment 3 of the present invention. Note that, in the present embodiment, expressions related to directions, such as up, down, left, right, front, and rear, used for describing configurations and operations of the respective parts of the operation input apparatus are relative ones, not absolute ones. These expressions are appropriate in a case where an attitude of an operation surface is as shown in the figure, but in a case where the attitude is changed, the expressions should be changed and interpreted in accordance with the change in attitude.

Operation input apparatus 1a includes a function of applying, to a user, a haptic sensation which is an operation feeling including vibration, a reaction force, a thrust, a displacement, or the like through an operation part that is operated by the user by touching or pressing the operation part, or of presenting a position of the operation part by operation or detecting a load applied to the operation part.

For example, in a case where the user intends to operate the operation part, that is, in a case where a situation of the user is observed, recognized, and determined, operation input apparatus 1a moves the operation part. As a result, it is possible to allow recognition of the position of the operation part or recognition of the movement of the operation part. In particular, operation input apparatus 1a can drive the operation part operated by the user to prompt the operation on the operation part such that the user actively acts.

As shown in FIGS. 30 to 33, operation input apparatus 1a includes apparatus case 2, operation surface portions 5-1 to 5-3 that are disposed to be projectable and retractable on a front surface of apparatus case 2 and are operated by the user, and actuator 10a.

However, apparatus case 2 and operation surface portions 5-1 to 5-3 are not necessarily essential as the configuration of operation input apparatus 1a. For example, in a case where operation surface portions 5-1 to 5-3 are not provided, a distal end portion of output shaft portion 25, which will be described later, may function as the operation part operated by the user. That is, operation input apparatus 1a may be manufactured as single actuator 10a, and operation surface portions 5-1 to 5-3 may be mounted on actuator 10a during use (for example, in a case where actuator 10a is incorporated into apparatus case 2 to be described later).

### <Apparatus Case 2>

Apparatus case 2 is formed in a hollow rectangular parallelepiped shape and includes base portion 3 and cover portion 4. Base portion 3 has a plate shape, and box-shaped cover portion 4 of which a lower surface is open is attached to base portion 3 from above via fastening members 7.

Actuator 10a that is driven by electromagnetic drive to move operation surface portions 5-1 to 5-3 in an up-down direction, specifically, upward from front surface 4b of cover portion 4 is disposed inside apparatus case 2.

Apparatus case 2 accommodates bodies of a plurality of actuators 10-1 to 10-3.

Note that, in the following description, in a case where the plurality of operation surface portions 5-1 to 5-3 are not distinguished from each other, operation surface portions 5-1 to 5-3 may be simply referred to as “operation surface portion 5.” In addition, in a case where the plurality of actuators 10-1 to 10-3 are not distinguished from each other, actuators 10-1 to 10-3 may be simply referred to as “actuator 10a.”

Through-holes 3a are formed in base portion 3 at predetermined intervals. Actuators 10-1 to 10-3 are attached onto base portion 3 in a state of being held by holders (holding parts) 6 such that actuators 10-1 to 10-3 are positioned at positions facing through-holes 3a.

Each of holders 6 includes semi-arc-shaped divided bodies 6a that are disposed to surround each of actuators 10-1 to 10-3. Divided bodies 6a fix each of actuators 10-1 to 10-3 such that each of actuators 10-1 to 10-3 is sandwiched by fastening it with fastening members 6b, and are fixed to base portion 3 by fastening members 6c. Accordingly, actuators 10-1 to 10-3 are respectively fixed to be unable to move in left-right, front-rear, and up-down directions with respect to base portion 3.

Actuators 10-1 to 10-3 each include an output shaft portion (protruding part) 25 that is disposed to protrude upward from a central portion of an upper surface of a fixed body as a main body portion and that moves in the up-down direction.

In actuators 10-1 to 10-3, the fixed bodies are formed in a columnar shape, and output shaft portions 25 are directly fixed to operation surface portions 5-1 to 5-3, respectively.

Output shaft portions 25 extend perpendicularly to base portion 3, and their distal end portions are joined perpendicularly to operation surface portions 5-1 to 5-3, respectively.

Operation surface portions 5-1 to 5-3 are disposed in opening portions 4a formed in front surface 4b of cover portion 4 and are movable in the up-down direction in opening portions 4a.

Operation surface portions 5-1 to 5-3 have front surface portions that are disposed to be projectable and retractable with respect to apparatus case 2, and the front surface portions are flush with front surface 4b. Note that, a moving direction of movable body 20 during application of the operation feeling and a moving direction of movable body 20 during presentation of an operation position of operation surface portion 5 or during prompting of the operation of operation surface portion 5 coincide with a projection and retraction direction of operation surface portions 5-1 to 5-3.

Operation surface portions 5-1 to 5-3 are disposed to move perpendicularly to front surface 4b of cover portion 4 (case 2). This is due to the fact that movable body 20 is disposed to be movable in a direction orthogonal to front surface 4b of cover portion 4.

It is preferable that operation surface portions 5-1 to 5-3 have shapes that are easy for the user to operate. In the present embodiment, since operation surface portions 5-1 to 5-3 are operated by a finger of the user, operation surface portions 5-1 to 5-3 are formed in a disk shape having front surfaces with diameters that come into contact with finger pads in correspondence with the fingers of the user.

As shown in FIGS. 30 to 33, operation surface portions 5-1 to 5-3 are flush with front surface 4b of cover portion 4 in a non-operative state, and are displaceable to positions protruding upward from front surface 4b of cover portion 4 in an operative state. Output shaft portions 25 also follow to move up and down as operation surface portions 5-1 to 5-3 move up and down.

<Overview of Actuator 10a>

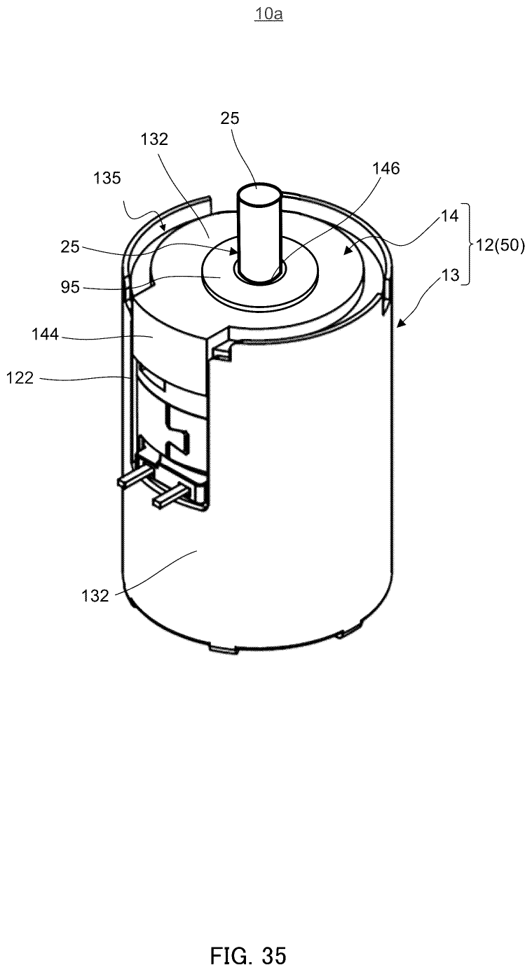

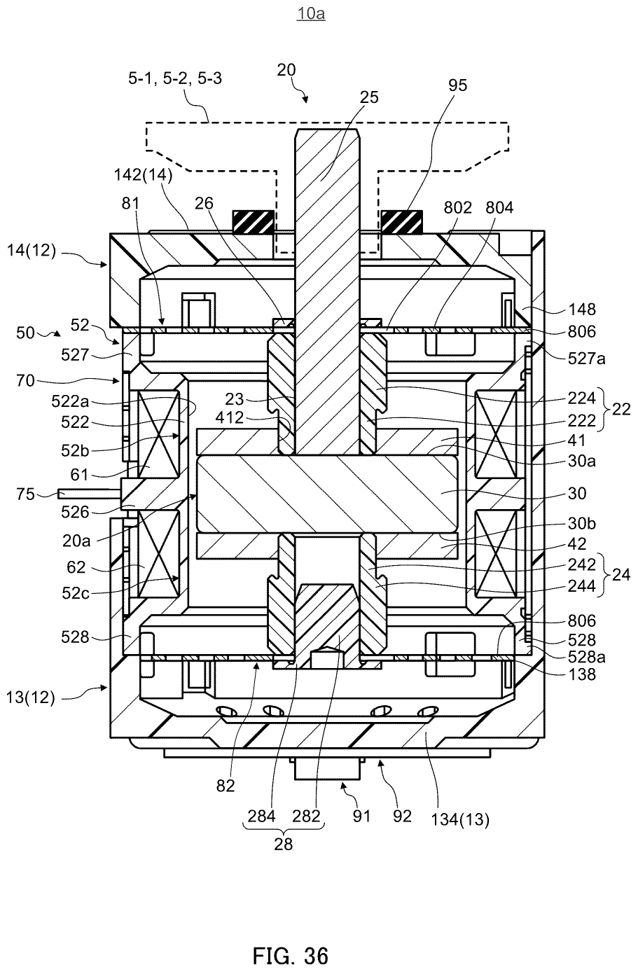

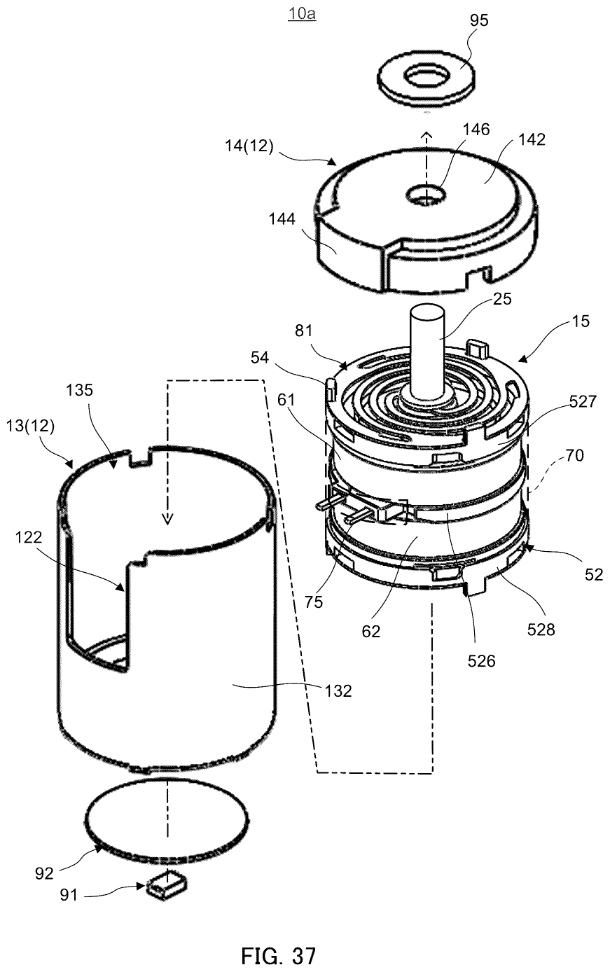

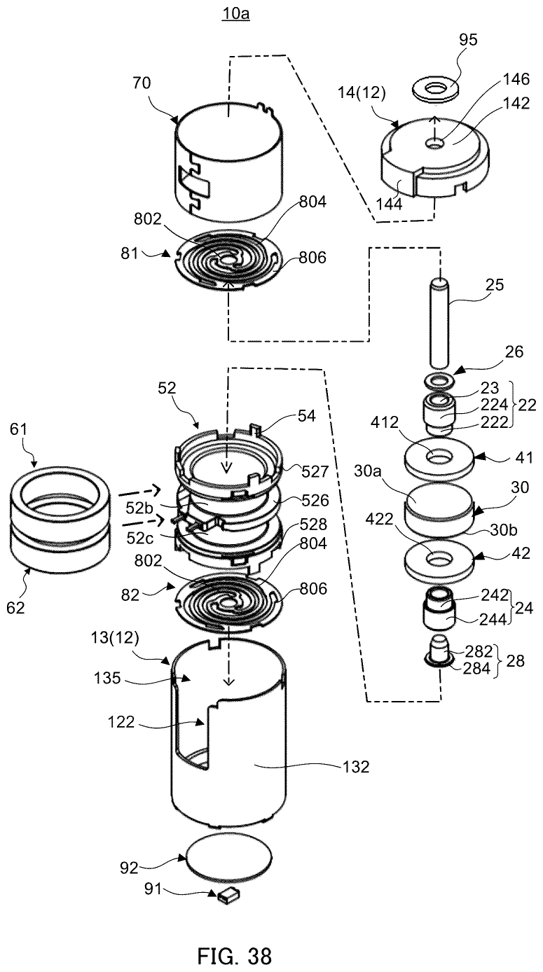

FIG. 35 is an external perspective view of the actuator in the operation input apparatus according to Embodiment 3 of the present invention, and FIG. 36 is a longitudinal sectional view showing a configuration of a principal part of the actuator. In addition, FIG. 37 is a view showing an internal structure of the actuator with a case removed, and FIG. 38 is an exploded perspective view of the actuator.

Actuator 10a includes movable body 20 to which operation surface portion 5 is connected. Actuator 10a performs an actuation of movable body 20 for applying the operation feeling to the user via operation surface portion 5 through electromagnetic drive. In addition, actuator 10a performs an actuation of movable body 20 for presenting an operation position of operation surface portion 5 to the user or for prompting the user to operate operation surface portion 5 through electromagnetic drive.

Actuator 10a is, for example, an actuator that presents perception, and is configured to transmit reciprocating motion of movable body 20 in response to a touch operation by the user on operation surface portion 5 as the operation feeling (a haptic sensation, a force feeling, or the like) of the user. Actuator 10a of the present embodiment is configured to move operation surface portion 5 itself as the operation part directly connected to the movable body to indicate the position of operation surface portion 5 and to prompt the operation of operation surface portion 5. Note that, in a case where the movable body is moved to move operation surface portion 5, the position of operation surface portion 5 may be made more reliably known to the user by light emission.

Actuator 10a is used as a device that detects an operation and feeds back an operation feeling (haptic sensation). The haptic feedback is to feed back a force feeling or the like in addition to the haptic sensation to the user through operation surface portion 5 operated by the user by means of the actuation, vibration, or the like of movable body 20. For example, the haptic feedback may also be referred to as haptic sensation feedback, tactile sensation feedback, or force feedback, and is a function used for expressing a haptic sensation and an operation feeling.

As shown in FIGS. 35 and 36, actuator 10a accommodates movable body 20 in hollow case 12 such that the movable body can reciprocate between upper and lower end surfaces, with an axial direction (up-down direction) of case 12 as a moving direction. Case 12 accommodates movable body 20 together with coils 61 and 62 such that a protruding end side of output shaft portion 25 protrudes outward. Since actuator 10a is held by holder 6 during use and is fixed to base portion 3 to be immovable, case 12 may be regarded as an example of a fixed body. Actuator 10a includes magnetic sensor 91 that detects a movement position of movable body 20. Actuator 10a is connected to operation surface portion 5 (5-1, 5-2, 5-3) (see FIGS. 32 to 34) via output shaft portion 25 provided in movable body 20, and transmits the movement of the movable body to operation surface portion 5 (5-1, 5-2, 5-3).

<Configuration of Actuator 10a>

Actuator 10a includes magnet 30 in movable body 20, includes coils 61 and 62 in fixed body 50, and causes movable body 20 to perform reciprocating motion in a straight line direction by cooperation between energized coils 61 and 62 and magnet 30. Actuator 10a includes elastic supporting parts 81 and 82 that support movable body 20 to be movable with respect to fixed body 50.

Specifically, actuator 10a includes movable body 20 including a pair of yokes 41 and 42 and a pair of spring retaining parts 22 and 24 in addition to magnet 30, and fixing body 50 including outer yoke 70 in addition to a pair of annular coils 61 and 62. A pair of elastic supporting parts 81 and 82 are provided between movable body 20 and fixing body 50.

Moreover, actuator 10a has damping member 95 provided between movable body and fixed body 50. Damping member 95 has flexibility and can absorb an impact from the outside.

Movable body 20 is attached via elastic supporting parts 81 and 82 to fixed body 50 to be movable in a moving direction of the movable body during application of the operation feeling and in a moving direction of movable body 20 during presentation of the operation position of operation surface portion 5 (5-1, 5-2, 5-3) or during prompting of the operation of operation surface portion 5.

Note that a configuration in which a pair of yokes 41 and 42, a pair of spring retaining parts 22 and 24, and a pair of coils 61 and 62 are disposed is employed, but the present invention is not limited thereto, and the number of yokes, spring retaining parts, and coils may also be one, three, or more as long as it is possible to achieve movability on one side or both side in one linear direction.

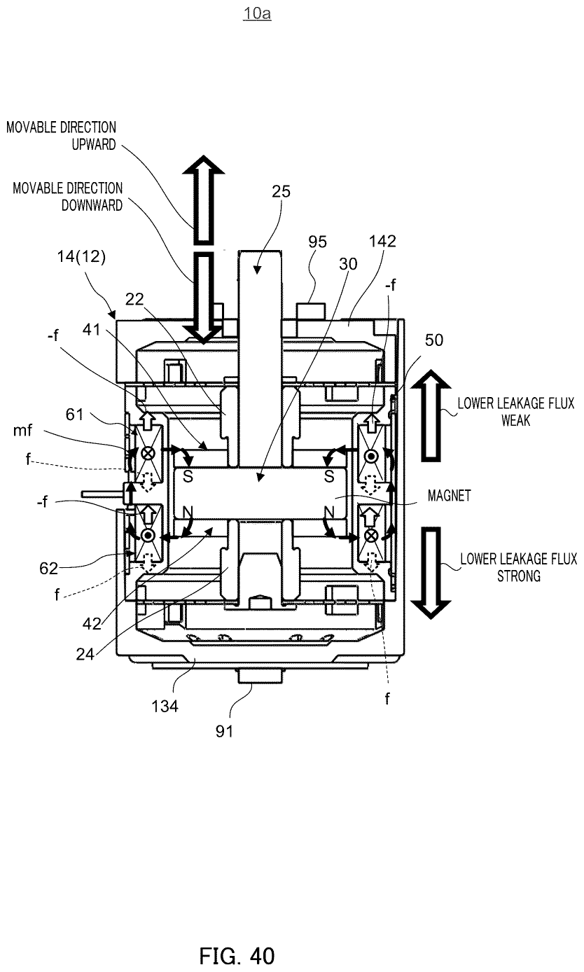

In actuator 10a, coils 61 and 62, outer yoke 70, magnet 30, and yokes 41 and 42 constitute a magnetic circuit for moving movable body 20. In actuator 10a, coils 61 and 62 are energized from a power supply section (not illustrated) via terminal part 75, and movable body 20 is moved. Movable body 20 can reciprocate in both directions in the axial direction which is a reciprocation direction, or in one direction which is one side in the axial direction. For example, actuator 10a moves in both directions in the axial direction (see the arrow directions in FIG. 40).

In actuator 10a of the present embodiment, movable body 20 reciprocates in the moving direction (also referred to as the axial direction of coils 61 and 62) along a holding-portion main body (protective wall portion, tubular member) 522 disposed between the coils and movable body 20 inside coils 61 and 62 held by coil holding part 52. The moving direction is not only the axial direction of coils 61 and 62, but also the magnetization direction of magnet 30, and is also the axial direction of coil holding part 52.

In addition, as shown in FIG. 37, actuator 10a may be configured to accommodate unit 15 in which fixed body 50 and movable body 20 are connected to each other by elastic supporting parts 81 and 82 in case 12 having case main body 13 and lid portion 14. Accordingly, it is possible to accurately assemble main parts of actuator 10a in a different step from case 12.

### <Movable Body 20>

Movable body 20 in a non-moving state is disposed via elastic supporting parts 81 and 82 such that the center of its length in the reciprocation direction faces, at a predetermined distance in a direction orthogonal to the axial direction of movable body 20, the center of the length of coil holding part 52 in the reciprocation direction. In the present embodiment, it is preferable that the centers of the lengths in the reciprocation direction of magnet 30 and yokes 41 and 42 are disposed at positions facing, in a direction orthogonal to the reciprocation direction, the center of the length between vertically spaced coils 61 and 62 in the reciprocation direction. Note that magnetic fluid may be interposed between holding-portion main body 522 and movable body 20.

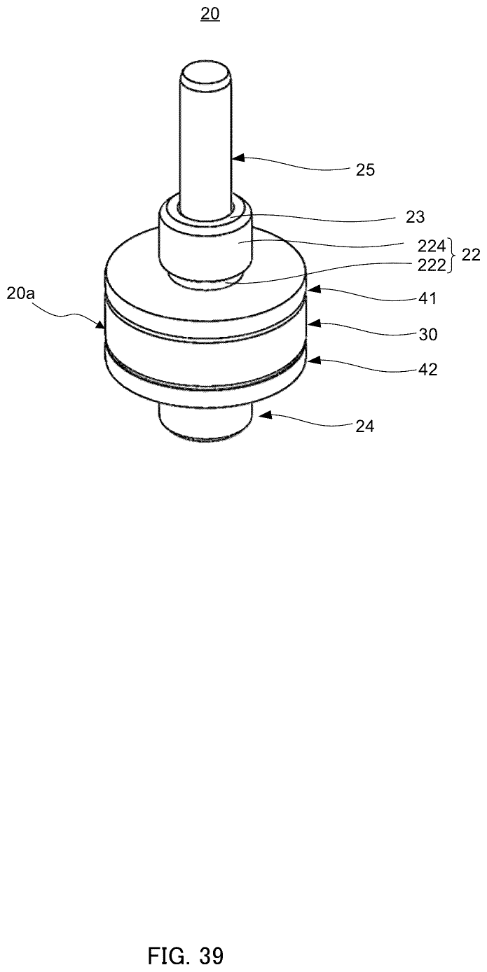

As shown in FIGS. 36, 38, and 39, movable body 20 includes output shaft portion 25, first spring fixation portion 26, and second spring fixation portion 28 in addition to magnet 30, yokes 41 and 42, and spring retaining parts 22 and 24.

In movable body 20, yokes 41 and 42, spring retaining parts 22 and 24, first spring fixation portion 26, and second spring fixation portion 28 are continuously disposed in opposite directions in the reciprocation direction around magnet 30. Specifically, in movable body 20, yokes 41 and 42 are disposed on front and back surfaces 30a and 30b of magnet 30 in a stacked manner, and elastic supporting parts 81 and 82 are engaged with one end portions of spring retaining parts 22 and 24 that are, at the other end portions, engaged with opening portions 412 and 422 of yokes 41 and 42.

In movable body 20, outer circumferential surface 20a of magnet 30 and yokes 41 and 42 face inner circumferential surface 522a of holding-portion main body 522 with a predetermined distance to inner circumferential surface 522a. When movable body 20 reciprocates, outer circumferential surface 20a reciprocates without coming into contact with inner circumferential surface 522a.

Magnet 30 is solid and magnetized in the reciprocation direction. Specifically, magnet 30 is formed in a disk shape and has front and back surfaces 30a and 30b facing away from each other in the reciprocation direction (thickness direction) as magnetic pole surfaces of different polarities (for example, front surface 30a is an S-pole, and back surface 30b is an N-pole).

Magnet 30 is disposed so as to be spaced apart by a distance from coils 61 and 62 (to be described later in detail) inward of coils 61 and 62 in a radial direction. Here, the “radial direction” is a direction orthogonal to the axes of coils 61 and 62, and is also a direction orthogonal to the reciprocation direction. The “distance” in the radial direction is a distance between coils 61 and 62 including holding-portion main body 522 and magnet 30, and is a distance that allows movement in the reciprocation direction of movable body 20 without contact between the magnet and the movable body. In addition, there is a predetermined distance also between holding-portion main body 522 and magnet 30.

In the present embodiment, magnet 30 is disposed such that the center of the outer circumferential surface faces the center of holding-portion main body 522 in a direction orthogonal to the axial direction, the center being the center in the width direction, the outer circumferential surface being situated on the outer side in the radial direction. Note that magnet 30 may have a shape other than a disk shape, such as a cylindrical shape or a plate shape, as long as it is disposed inside coils 61 and 62 with two magnetized surfaces facing in the extending direction of the axes of coils 61 and 62, that is, in the reciprocation direction.

In the present embodiment, magnet 30 is a solid body. Thus, unlike the case of a tubular member, an effort to process an opening portion is saved, and the areas of the front and back surfaces serving as the magnetic pole surfaces are not reduced by formation of the opening portion. In addition, it is desirable that the center of magnet 30 in the axial direction coincide with the center of movable body 20 in the axial direction.

The magnetization direction of magnet 30 is parallel to the moving direction of movable body 20.

Yokes 41 and 42 are magnetic materials, and the yokes together with magnet 30 form a movable-body-side magnetic circuit. Yokes 41 and 42 concentrate the magnetic flux of magnet 30 to allow efficient flow without leakage, and effectively distribute the magnetic flux flowing between magnet 30 and coils 61 and 62.

In addition, yokes 41 and 42 may have a function of fixing spring retaining parts 22 and 24 in addition to a function as a part of the magnetic circuit. Yokes 41 and 42 may further have a function as a main body portion of movable body 20 and a function as a weight in movable body 20.

In the present embodiment, yokes 41 and 42 are formed in an annular flat plate shape having the same outer diameter as that of magnet 30. Yokes 41 and 42 are fixed to magnet 30 such that the outer circumferential surfaces thereof are flush with the outer circumferential surface of the magnet, and form outer circumferential surface 20a of movable body 20 together with the outer circumferential surface of the magnet.

Yokes 41 and 42 are members with the same shape disposed to sandwich magnet with magnet 30 interposed therebetween, but may be members with different shapes. Yokes 41 and 42 are attached to magnet 30 by being attracted to magnet 30, and are also fixed to magnet 30 via, for example, a thermosetting adhesive such as an epoxy resin or an anaerobic adhesive.

Opening portions 412 and 422 are formed in respective central portions of yokes 41 and 42 so as to extend therethrough in the axial direction, that is, in the thickness direction. One end portions of upper and lower spring retaining parts 22 and 24 are internally fitted and fixed to opening portions 412 and 422, respectively.

Opening portions 412 and 422 support spring retaining parts 22 and 24 such that the respective axes of spring retaining parts 22 and 24 (here coinciding with the centers of elastic supporting parts 81 and 82) are located on the central axis of movable body 20. Opening portions 412 and 422 allow adjustment of the degree of opening in yokes 41 and 42 to adjust the weight of movable body 20 and set a suitable reciprocating output.

In the present embodiment, when movable body 20 is not reciprocating, yokes 41 and 42 are positioned on the inner side (radially inner side) of coils 61 and 62 so as to face coils 61 and 62, respectively, in a direction orthogonal to the axial direction of coils 61 and 62.

In yokes 41 and 42, the height position of the upper surface of yoke 41 on the upper side (front side) of magnet 30 is preferably opposed to the position of the center of the upper coil 61 in the height direction (reciprocation direction). In addition, the height position of the lower surface of yoke 42 on the lower side (back surface side) of magnet 30 is preferably opposed to the position of the center of lower coil 62 in the height direction (reciprocation direction).

Spring retaining parts 22 and 24 have a function of fixing a movable-body-side magnetic circuit to elastic supporting parts 81 and 82, and have a function as a weight of movable body 20. Spring retaining parts 22 and 24 are disposed symmetrically in the axial direction to sandwich magnet 30 and yokes 41 and 42, and increase the reciprocating output of movable body 20 driven by power supply to the coil.

In the present embodiment, spring retaining parts 22 and 24 are formed in the same shape. For this reason, the details of spring retaining part 24 are omitted, and the explanation thereof is given by adding the reference numeral of spring retaining part 24 to the corresponding names in the description of spring retaining part 22. Since spring retaining parts 22 and 24 are formed in the same shape, it is possible to reduce a cost of producing components in manufacturing of actuator 10a.

In the present embodiment, spring retaining parts 22 and 24 also function as a shaft of the movable body extending along the central axis of movable body 20, and are interposed between yokes 41 and 42 and elastic supporting parts 81 and 82.

Spring retaining parts 22 and 24 include joint portions 222 and 242 and spring fixation portions 224 and 244. Joint portions 222 and 242 and spring fixation portions 224 and 244 are continuously disposed in the reciprocation direction.

Spring retaining parts 22 and 24 are tubular members and have through-hole 23 extending inside. The base end portion of output shaft portion 25 is inserted into through-hole 23 of spring retaining part 22 and is firmly fixed thereto.

Joint portions 222 and 242 are tubular members disposed on the axis of movable body 20, and are joined to yokes 41 and 42, respectively. Joint portions 222 and 242 are joined by inserting one end portion sides into opening portions 412 and 422 of yokes 41 and 42, respectively. On the other hand, the other end portions of joint portions 222 and 242 are disposed to face away from each other in the opposite directions across magnet 30, and form opposite end portions of movable body 20 which are separated from each other in the moving direction. Elastic supporting parts 81 and 82, which will be described later, are joined to the other end portions, respectively.

Spring retaining parts 22 and 24 are bonded to yokes 41 and 42 by press-fitting, but the present invention is not limited thereto, and may be bonded by bonding using a thermosetting adhesive such as an epoxy resin or an anaerobic adhesive, for example. Joint portions 222 and 242 are tubular members, but they may be solid cylindrical bodies or rod-shaped bodies having recessed portions on the axis.

Spring fixation portion 224 is a tubular member that is provided so as to protrude from joint portion 222 to the other side (upward) of spring retaining part 22 and has an outer diameter larger than that of joint portion 222. In spring fixation portion 224, a joining surface, which is a distal end (upper end) surface thereof, is disposed around output shaft portion 25.

Output shaft portion 25 is connected to movable body 20, moves together with movable body 20, and outputs a motion of movable body 20 to the outside. Output shaft portion 25 is disposed on the axis of movable body 20, the base end side is fixed to movable body 20 by being internally fitted to spring retaining part 22, and the other end side is exposed to the outside of actuator 10a through central opening portion 146 of lid portion 14.

Output shaft portion 25 is inserted through inner circumferential portion 802 which is an end portion (the other end portion) of the upper leaf spring as elastic supporting part 81 on the inner diameter side. Inner circumferential portion 802 is a central portion of the circular leaf spring and is sandwiched between spring fixation portion 224 and first spring fixation portion 26 in a state of being in contact with the joining surface of spring fixation portion 224. Spring fixation portion 224 is thus joined to elastic supporting part 81. Output shaft portion 25 protrudes from movable body 20 to the side of elastic supporting part 81 opposite to magnet 30 in one direction in the moving direction of movable body 20, and is movable forward and backward outside fixing body 50. A center portion of a back surface of operation surface portion 5 is fixed to a distal end portion of output shaft portion 25 to be orthogonal to an extending direction of output shaft portion 25. The user who operates operation surface portion 5 directly transmits the driving of movable body 20 via operation surface portion 5 and output shaft portion 25. Accordingly, operation input apparatus 1a can respond at a high speed and perform strong feedback in a case of performing vibration output, displacement output (the displacement of movable body 20 in response to the operation), and load detection. In addition, it is possible to express an operation feeling (haptic sensation) that can cope with an operation with a long stroke.

On the other hand, spring fixation portion (lower spring fixation portion) 244 disposed on the side opposite to spring fixation portion 224 of first spring retaining part 22 across magnet 30 is joined to inner circumferential portion 802 which is an end portion of the lower leaf spring being elastic supporting part 82 on the inner diameter side.

Spring fixation portion 244 is a tubular member that is provided so as to protrude from joint portion 242 to the other side (downward) in spring retaining part 24 and has an outer diameter larger than that of joint portion 242. At spring fixation portion 244, inner circumferential portion 802 is held between the joining surface being the distal end (lower end) surface of the spring connection portion and second spring fixation portion 28 inserted into a through-hole opened in the joining surface in a state in which inner circumferential portion 802 of the lower leaf spring serving as elastic supporting part 82 is in contact with the joining surface.

Specifically, second spring fixation portion 28 is inserted at shaft-shaped insertion portion 282 into the through-hole in spring connection portion 244, thereby holding inner circumferential portion 802 of elastic supporting part 82 between flange 284 disposed on the outer circumference of the base end portion of the insertion portion and the joining surface of spring fixation portion 244. Thus, spring fixation portion 244 and elastic supporting part 82 are joined to each other.

Second spring fixation portion 28 may be a rivet such as a blind rivet, for example. Second spring fixation portion 28 fixes shaft-shaped insertion portion 282 in the through-hole in spring fixation portion 244 by press-fitting such as caulking.

It should be noted that only by disposing spring retaining parts 22 and 24 in the movable-body-side magnetic circuit, the upper leaf spring and the lower leaf spring as elastic supporting parts 81 and 82 can be easily assembled to movable body 20, and the assemblability can be improved.

Note that, spring retaining parts 22 and 24 may be formed from a magnetic material, but are preferably formed from a non-magnetic material. When spring retaining parts 22 and 24 are formed from a non-magnetic material, the magnetic flux from yoke 41 does not flow upward, and the magnetic flux from yoke 42 does not flow downward, and the magnetic fluxes can thus efficiently flow toward coils 61 and 62 located on the outer circumferential side of yokes 41 and 42.

### <Elastic Supporting Parts 81 and 82>

Elastic supporting parts 81 and 82 are disposed on opposite sides of movable body in the moving direction, and support movable body 20 movably in the moving direction. Elastic supporting parts 81 and 82 are leaf springs, and are disposed so as to sandwich movable body 20 in the moving direction of movable body 20, and are disposed on both movable body 20 and fixing body 50 so as to intersect the moving direction.

Specifically, elastic supporting parts 81 and 82 are disposed to straddle, on one hand, the opposite end portions (upper and lower end portions) of movable body 20 that are spaced apart from each other in the reciprocation direction and, on the other hand, the opening edge portions of fixing body 50 (coil holding part 52) that are disposed radially outward from the opposite end portions. In the present embodiment, elastic supporting parts 81 and 82 are disposed along a direction orthogonal to the reciprocation direction and face each other to sandwich movable body 20 in the reciprocation direction.

Elastic supporting parts 81 and 82 may be non-magnetic materials or magnetic materials (specifically, ferromagnetic materials). Elastic supporting parts 81 and 82 may be formed from a stainless-steel plate such as SUS304, SUS316 as long as they are non-magnetic leaf springs. When elastic supporting parts 81 and 82 are formed from a magnetic material, a stainless-steel plate such as SUS301 is applicable. As a material of elastic supporting parts 81 and 82, for example, a magnetic material (for example, SUS301) is known to be more durable and inexpensive than a non-magnetic material (for example, SUS304, SUS316, or the like). In the present embodiment, elastic supporting parts 81 and 82 are formed from SUS301.

Elastic supporting parts 81 and 82 support movable body 20 such that the movable body does not come into contact with fixing body 50 whether the movable body is in reciprocating motion and not in reciprocating motion. Elastic supporting parts 81 and 82 may be formed from any material as long as they are configured to elastically support movable body 20 movably.

Each of elastic supporting parts 81 and 82 is a plurality of plate-shaped spiral springs which have a flat plate shape in a normal state. In each of elastic supporting parts 81 and 82, arc-shaped deformation arm portions 804 extend radially outward at regular intervals from the outer edge portion of inner circumferential portion 802 having the annular plate shape, and are connected to outer circumferential fixation portion 806 having the annular plate shape at the end portions of deformation arm portions 804.

Inner circumferential portions 802 have a shape disposed on the joining surfaces of spring fixation portions 224 and 244 of spring retaining parts 22 and 24, and have, for example, an outer diameter substantially the same as the outer diameter of the joining surfaces of spring fixation portions 224 and 244.

Deformation arm portions 804 are elastically deformable, are joined to outer circumferential fixation portion 806 at one end portions, are joined to inner circumferential portion 802 at the other end portions, and connect outer circumferential fixation portion 806 and inner circumferential portion 802 to each other. A plurality of deformation arm portions 804 are disposed in a spiral shape between inner circumferential portion 802 and outer circumferential fixation portion 806 while being spaced from one another by a predetermined interval in the circumferential direction. Movable body 20 may be supported by three or more elastic supporting parts (leaf springs) 81 and 82. The plurality of leaf springs are attached to extend along a direction orthogonal to the reciprocation direction.

In elastic supporting parts 81 and 82, inner circumferential portions 802 are joined respectively to the opposite end portions (spring fixation portions 224 and 244) that are separated from each other in the axial direction (reciprocation direction) of movable body 20. Further, outer circumferential fixation portion 806 sides of elastic supporting parts 81 and 82 are disposed so as to protrude radially outward (in the radial direction) at the opposite end portions of movable body 20.

Outer circumferential fixation portion 806 is sandwiched between opposite opening edges of coil holding part 52 and case 12 in a state where a notch is formed in an outer circumferential edge and movable-range forming portion 54 of coil holding part 52 is engaged with the notch.

Specifically, in elastic supporting part 81, outer circumferential fixation portion 806 is sandwiched and fixed in case 12 between ring-shaped upper end surface 527a of flange portion 527 and pressing portion 148 of lid portion 14. Note that, upper end surface 527a means an upper (one-side) end surface of the portion of the upper side (one side) of upper (one-side) flange portion 527 other than movable-range forming portions 54.

Further, in lower elastic supporting part 82, outer circumferential fixation portion 806 is fixed to the lower end portion of coil holding part 52 at the outside of movable body in the radial direction in actuator 10a. Specifically, outer circumferential fixation portion 806 of elastic supporting part 82 is fixed to a portion of annular lower end surface 528a of lower flange portion 528 forming the lower end portion of coil holding part 52, the portion being other than movable-range forming portions 54.

In the plurality of elastic supporting parts 81 and 82, outer circumferential fixation portion 806 being one end of each of elastic supporting parts 81 and 82 on the outer circumferential side is fixed to fixing body 50 and inner circumferential portion 802 being the other end of each of elastic supporting parts 81 and 82 on the inner circumferential side is fixed to movable body 20 such that the directions of the whirls of elastic supporting parts 81 and 82 are the same, for example.

As described above, a plurality of whirl-shaped leaf springs are used as the plurality of elastic supporting parts 81 and 82 in the present embodiment. Elastic supporting parts 81 and 82 are attached respectively to the opposite end portions of movable body 20 which are distant from each other in the moving direction, and elastically support movable body 20 with respect to fixing body 50. Thus, when the movement amount of movable body 20 is large, the movable body moves in a translational direction (here, the direction on a plane perpendicular to the moving direction) even slightly while rotating. When the whirl directions of the plurality of leaf springs are opposite each other, the plurality of leaf springs move in a buckling direction or a pulling direction to each other, whereby smooth movement is prevented.

Since actuator 10a includes a pair of elastic supporting parts 81 and 82, actuator 10a can improve linear drive properties of movable body 20 and stably perform the driving of movable body 20 without being affected by an impact or a disturbance from the outside. In particular, since the stability of the linear driving can be increased, both characteristics of the stability of a magnetic sensor output and the stability of a haptic sensation output can be increased.

Elastic supporting parts 81 and 82 of the present embodiment are fixed to movable body 20 such that the whirl directions are the same. Thus, even when the movement amount of movable body 20 is large, elastic supporting parts 81 and 82 can move smoothly, i.e., can be deformed in the axial direction. Accordingly, elastic supporting parts 81 and 82 produce a greater amplitude and can increase the vibration output not only during movement but also during vibration.

However, depending on a desired vibration range of movable body 20, the whirl directions of the plurality of elastic supporting parts 81 and 82 may be designed to be opposite directions to each other.

Meanwhile, outer circumferential fixation portion 806 of upper elastic supporting part 81 is, at the outside in the radial direction, fixed to the upper end portion of coil holding part 52. Specifically, outer circumferential fixation portion 806 of elastic supporting part 81 is fixed to a portion of annular upper end surface 527a of upper flange portion 527 forming the upper end portion of coil holding part 52 (see FIG. 36), the portion being other than movable-range forming portions 54. Details of the configuration of coil holding part 52 will be described later.

Outer circumferential fixation portion 806 of elastic supporting part 82 is clamped and fixed by annular lower end surface 528a of flange portion 528 and step portion 138 formed on a circumferential edge portion of bottom portion 134 within case 12. Note that, lower end surface 528a means an upper (other-side) end surface of the portion of the lower side (other side) of lower (other-side) flange portion 528 other than movable-range forming portions 54.

Outer circumferential fixation portions 806 are formed in an annular shape. The outer circumferential portions of the outer circumferential fixation portions are sandwiched between upper and lower end surfaces 527a and 528a of coil holding part 52 (see FIG. 36) and pressing portion 148 and step portion 138. With this configuration, outer circumferential fixation portions 806 are fixed to fixing body 50.

### <Fixed Body 50>

As shown in FIG. 36, fixing body 50 holds coils 61 and 62, and supports, via elastic supporting parts 81 and 82, movable body 20 inside coils 61 and 62 in the radial direction such that movable body 20 is freely movable in the moving direction (the coil axial direction, or the axial direction of movable body 20).

Fixing body 50 includes coils 61 and 62, outer yoke 70, and coil holding part 52 that hold coils 61 and 62.

Actuator 10a is configured such that substantially all the components for generating vibrations, such as coils 61 and 62, movable body 20, and case 12 via elastic supporting parts 81 and 82 are connected to coil holding part 52.

Coil holding part 52 is a tubular member, holds coils 61 and 62 disposed on the outer circumferential surface, and surrounds magnet 30 with inner circumferential surface 522a. Movable body 20 including magnet 30 is movably disposed inside the coil holding part. Coil holding part 52 may also be formed in a bobbin shape, and in this case, coils 61 and 62 are wound on the outer circumference of the inner tubular holding-portion main body (protective wall) of coil holding part 52.

Coil holding part 52 is a tubular member formed from a resin such as a phenolic resin or polybutylene terephthalate (PBT). In the present embodiment, coil holding part 52 is formed from a material containing a phenolic resin such as Bakelite having high flame retardancy.

When coil holding part 52 is formed from a material containing a phenolic resin, a higher flame retardancy is obtained. It is thus possible to improve the safety at the time of driving even when heat is generated by Joule heat when a current flows through coils 61 and 62 held by coil holding part 52. Moreover, the dimensional accuracy is increased and the positional accuracy of coils 61 and 62 is increased accordingly. It is thus possible to reduce variations in characteristics of movement, reciprocating motion or vibration.

Specifically, coil holding part 52 includes tubular holding-portion main body 522, middle flange portion 526, and flange portions 527 and 528 protruding in the radial direction from the outer circumference of holding-portion main body 522, terminal part 75, and movable-range forming portions 54.

Holding-portion main body 522 functions as a protective wall portion for protecting coils 61 and 62 against collision by movable body 20 when movable body 20 disposed inside is being driven. The thickness of holding-portion main body 522 is a thickness that gives such a strength that coils 61 and 62 on the outer circumferential side are not affected at all even when moving movable body 20 makes contact with bobbin main-body portion 522.

Coils 61 and 62 are disposed on the outer circumferential side of holding-portion main body 522 side by side in the coil axial direction between middle flange portion 526 and flange portions 527 and 528 (coil attachment portions 52b and 52c). Holding-portion main body 522 positions coils 61 and 62 such that the coils radially externally surround the outer circumferential surfaces of yokes 41 and 42 (the outer circumferential surfaces of magnet 30 and yokes 41 and 42) of movable body 20.

Specifically, the outer circumferential surface of holding-portion main body 522 is partitioned by middle flange portion 526 and flange portions 527 and 528, and is provided with recessed coil attachment portions 52b and 52c that open radially outward on the outer circumferential side.

Terminal part 75 functions as a connector connection portion to which coil windings of coils 61 and 62 are tied for connection to an external device. Coils 61 and 62 are connected to the external device via terminal part 75, and power can be supplied from the external device to coils 61 and 62.

Terminal part 75 is an electrically conductive member disposed to protrude from the outer circumferential portion of holding-portion main body 522. In the present embodiment, terminal part 75 is press-fitted to the outer circumferential surface of middle flange portion 526 disposed on the outer circumference of holding-portion main body 522 centrally in the moving direction. Terminal part 75 is thus disposed to protrude from the outer circumferential surface of middle flange portion 526.

Flange portions 527 and 528 are disposed respectively on opposite end portions of holding-portion main body 522 which are separate from each other in the axial direction of the bobbin main-body portion (which is also the moving direction and the upper-lower direction in the present embodiment), so as to form the upper and lower end portions of coil holding part 52.

Elastic supporting parts 81 and 82 are fixed to end portions of flange portions 527 and 528 on the sides away from middle flange portion 526 (upper and lower end portions in the present embodiment).

Movable-range forming portions 54 are disposed on the upper and lower end portions of coil holding part 52, and form a moving range between lid portion 14 and bottom portion 134 of case 12 and movable body 20 when coil holding part 52 is accommodated in case 12.

Movable-range forming portions 54 are projecting side portions protruding from flange portions 527 and 528 in the reciprocation direction (upper-lower direction). Movable-range forming portions 54 are disposed at predetermined intervals on upper and lower annular end surfaces (also referred to as “upper end surface and lower end surface” or “opening end surfaces”) 527a and 528a of flange portions 527 and 528. Upper end surface 527a is an opening end surface on one side, and lower end surface 528a is an opening end surface on the other side.

Flange portion 527 includes, on the opening end surface on one side, projecting movable-range forming portions 54 protruding in the moving direction. The one opening end surface functions as a top surface receiving portion that receives lid portion 14 via movable-range forming portions 54. Flange portion 528 includes, on the opening end surface on the other side, projecting movable-range forming portions 54 protruding in the moving direction. The other opening end surface functions as a bottom surface receiving portion that receives bottom portion 134 via movable-range forming portions 54.

Further, movable-range forming portions 54 are fitted into the notches formed in elastic supporting parts 81 and 82, to perform radial positioning of elastic supporting parts 81 and 82.

Movable-range forming portions 54 are fitted in the notches. Accordingly, it is possible to uniformly set the attachment positions of elastic supporting parts 81 and 82 with respect to coil holding part 52 of each individual unit 15, so as to perform stable position determination of elastic supporting parts 81 and 82 with respect to coil holding part 52. Further, with respect to coil holding part 52, elastic supporting parts 81 and 82 are not fixed to the fixing body side via a plurality of components. Thus, a structure less susceptible to component tolerances is achieved, and movement in the circumferential direction and the radial direction such as rotation is restricted. It is thus possible to suppress variations in elastic supporting parts 81 and 82 in products, and to achieve stable characteristics.

Coil holding part 52 is accommodated in case 12 such that movable-range forming portions 54 at the upper and lower end surfaces are in contact with the edge portion of lid portion 14 and the edge portion of bottom portion 134, and is fixed to the edge portion of lid portion 14 and the edge portion of bottom portion 134.

### <Coil>

In actuator 10a, coils 61 and 62, together with magnet 30 and yokes 41 and 42, are used for generating a drive source of actuator 10a, in which case the axial direction of coils 61 and 62 (magnetization direction of magnet 30) is the moving direction.

Coils 61 and 62 generate a magnetic field by energization based on a detection result of magnetic sensor 91 to move movable body 20. Coils 61 and 62 are disposed radially outside movable body 20. Coils 61 and 62 together with magnet 30 constitute a magnetic circuit similar to a voice coil motor.

Coils 61 and 62 are disposed on coil attachment portions 52b and 52c, and coils 61 and 62 are disposed at positions facing yokes 41 and 42 in a direction orthogonal to the reciprocation direction in the present embodiment.

Coils 61 and 62 are held by coil holding part 52 such that the center position of the length of the coils in the coil axial direction (reciprocation direction) is substantially the same position (including the same position) in the reciprocation direction as the center position of the length of movable body 20 in the reciprocation direction (the center position of magnet in the reciprocation direction). Coils 61 and 62 of the present embodiment are wound in opposite directions to each other, and are configured such that a current flows in the opposite direction during energization. Coils 61 and 62 are fixed by bonding or the like to recessed coil attachment portions 52b and 52c, and the outer circumferential surfaces of the coils are surrounded by outer yoke 70 inside case 12.

The end portions of coils 61 and 62 are tied and connected to terminal part 75 of middle flange portion 526. Coils 61 and 62 are connected to an external power supply section via terminal part 75. For example, the respective end portions of coils 61 and 62 may be connected to a direct current (DC) supply section, and direct current (DC) power may be supplied from the direct current (DC) supply section to coils 61 and 62. Thus, coils 61 and 62 can generate, between the magnet and coils 61 and 62, thrust allowing movement on one side in a direction toward each other or away from each other in their axial direction. Further, the respective end portions of coils 61 and 62 may be connected to an alternating current (AC) supply section, and an alternating current (AC) power supply (alternating current (AC) voltage) may be supplied from the alternating current (AC) supply section to coils 61 and 62. Thus, coils 61 and 62 can generate, between the magnet and coils 61 and 62, thrust allowing movement in a direction toward each other or away from each other in their axial direction.

### <Outer Yoke 70>

Outer yoke 70 is a cylindrical magnetic body that surrounds the outer circumferential surface of coil holding part 52 and is disposed at a position that covers coils 61 and 62 radially outward. Outer yoke 70 prevents leakage magnetic flux from actuator 10a to the outside in the radial direction in the magnetic circuit.

Outer yoke 70 is disposed such that the center of the length of outer yoke 70 in the reciprocation direction is located at the same height as the center of magnet 30 in the reciprocation direction that is disposed inside outer yoke 70. The shielding effect of outer yoke 70 makes it possible to reduce the leakage magnetic flux to the outside of the reciprocating actuator.

Outer yoke 70 also makes it possible to increase the thrust constant so as to increase the electromagnetic conversion efficiency in the magnetic circuit. Outer yoke 70 utilizes the magnetic attraction force of magnet 30, and functions as a magnetic spring together with magnet 30. The magnetic spring makes it possible to reduce a stress that would be caused when elastic supporting parts 81 and 82 are mechanical springs, so as to improve the durability of elastic supporting parts 81 and 82.

### <Case 12>

Case 12 includes: bottomed cylindrical case main body 13 having circumferential wall portion 132 and bottom portion 134; and lid portion 14 for closing opening portion 135 of case main body 13. Case 12 has a columnar shape. The columnar shape is a shape having a height (thickness) allowing generation of sufficient thrust in the reciprocation direction in cooperation with coils 61 and 62 facing the outer circumference of the movable body. For example, case 12 of the present embodiment is formed in a cylindrical shape by bottomed cylindrical case main body 13 and lid portion 14. However, the case is not limited to this shape. The case may be elliptical cylindrical or polygonal prismatic. The length of the case in the reciprocation direction is longer or shorter than the length of the case in a direction perpendicular to the reciprocation direction. The elliptical shape of the elliptical cylindrical shape and elliptical shape in the present embodiment is mainly an ellipse including parallel straight-line-like portions, and thus means an oval shape.

Lid portion 14 and bottom portion 134 respectively form top surface portion 142 and the lower surface portion (bottom portion 134) of actuator 10a in the present embodiment, and are disposed to face movable body 20 of unit 15 with a predetermined gap being interposed between the lid portion and the bottom portion, on the one hand, and the movable body, on the other hand, in the reciprocation direction of movable body 20.

Lid portion 14 includes protruding portion 144 projecting radially outward from a part of the outer circumference of top surface portion 142 and is engaged with cutout portion 122 of case main body 13. Protruding portion 144 engages lid portion 14 with cutout portion 122 of case main body 13 to perform positioning when lid portion 14 is attached to case main body 13. Each of lid portion 14 and bottom portion 134 limits a movable range of movable body 20. Lid portion 14 and bottom portion 134 have a function as a movable-range reducing part that is a hard stop (movable range limitation) of movable body 20.

When lid portion 14 is attached to case main body 13, protruding portion 144 of lid portion 14 is disposed above terminal part 75 exposed in cutout portion 122 of case main body 13 to the outside at the central portion of cutout portion 122 in the longitudinal direction. Thus, the position of terminal part 75 of actuator 10a can be grasped only in plan view of lid portion 14.

Magnetic sensor 91 and circuit board 92 are disposed on case main body 13.

Magnetic sensor 91 is mounted on circuit board 92, detects a change in the magnetic flux caused by the movement of magnet 30 of movable body 20, and detects the displacement of movable body 20.

### <Magnetic Sensor 91>

Magnetic sensor 91 is an example of an operation amount detection part that detects a moving amount of movable body 20 in the moving direction that is moved by a user operation via operation surface portion 5. Magnetic sensor 91 detects the position of movable body 20 moving in response to a user's operation. Magnetic sensor 91 is disposed at a distance from movable body 20 in the moving direction of movable body 20. The moving direction of movable body 20 may be the side opposite to the side on which movable body 20 moves. That is, the position of magnetic sensor 91 may be the same side or a different side as long as it is in the moving direction of movable body 20.

It is preferable that magnetic sensor 91 be disposed on a central axis extending in the reciprocation direction of movable body 20 (a position overlapping the axis of output shaft portion 25) or in the vicinity of the central axis.

Magnetic sensor 91 together with circuit board 92 is attached to the outer surface of case main body 13, and the arrangement position of magnetic sensor 91 is positioned on the axis of output shaft portion 25 of movable body 20.

Since magnetic sensor 91 is disposed on the outer surface of case 12, it can be assembled outside actuator 10a, and the assemblability of actuator 10a can be improved.

In addition, it is possible to easily attach or replace magnetic sensor 91 without disassembling actuator 10a. In addition, magnetic sensor 91 included in actuator 10a can be easily inspected.

It is preferable that magnetic sensor 91 includes a Hall element. It is preferable that circuit configuration of the magnetic sensor at a subsequent stage be easier than, for example, in that case of simply using a Hall element, and it is also preferable that the magnetic sensor be a Hall IC which compares an output of the Hall element with a threshold value for output of High/Low. For the Hall IC, the output voltage range is defined by the power supply, and the subsequent-stage circuitry (microcomputer) can thus be easily created.

Further, as a magnetic sensor for which the output voltage range is defined by a power supply, a Hall sensor incorporating an amplifier, such as a linear Hall IC in which the output of the Hall element is amplified by the amplifier for linear output may also be used for magnetic sensor 91. Accordingly, circumferential circuitry can be configured inexpensively and easily without using other sensors, amplifiers, and transducers such as dedicated AD converters.

### <Circuit Board (Control Part) 92>

Circuit board 92 includes a microcontroller, an actuator driver, and the like mounted thereon and includes a drive control part that controls driving of the actuator. In circuit board 92, magnetic sensor 91 detects an operation load received by movable body 20 via output shaft portion 25, and coils 61 and 62 are energized according to the detection result to control the movement of movable body 20. Note that, the drive control part may not be provided in actuator 10a. The drive control part is a control part of operation input apparatus 1a and is controlled by microcontroller 400 that controls each part of entire operation input apparatus 1a.

As a result, actuator 10a can detect the operation load and perform haptic feedback specialized for the corresponding pressing operation. In particular, by the load detection, it is possible to perform detection specialized for the pressing operation.

As described above, actuator 10a can receive the operation load by output shaft portion 25 and generate the haptic feedback based on the operation load received by output shaft portion 25 to present it as the operation feeling of the user who operates operation surface portion 5. It is thus possible to more accurately reproduce a user operation also as an operation of a switch haptic sensation, a slider haptic sensation, or the like in response to the user operation to present it as a feedback.

When magnetic sensor 91 is used, a magnet originally necessary for forming an actuator is used for the sensor. It is thus possible to provide an inexpensive movable-body-position detecting means.

Since actuator 10a includes magnetic sensor 91 as a sensor for detecting the displacement of movable body 20, actuator 10a can easily detect the operation and provide haptic feedback.

Since case 12 is formed from a non-magnetic material, the case lower surface provided with magnetic sensor 91 is formed from a non-magnetic material. As a result, magnetic sensor 91 can detect the stable magnetic flux density in the magnetic circuit including magnet 30 and accurately detect the position of movable body 20.

Further, the magnetization direction of magnet 30 is parallel to the moving direction of movable body 20. Thus, magnetic sensor 91 detects the magnetic flux density of the distribution of a single magnetic pole, and thus can enhance the sensor detectability, so as to perform a stable sensor output.

In addition, movable body 20 is accommodated in coils 61 and 62 in a state of being drivable in the axial direction. Thus, it is possible to form a magnetic circuit capable of generating a thrust more efficiently. Further, the magnetic flux density to the bottom portion 134 side is increased. It is thus possible to accurately and easily detect magnetic sensor 91 disposed on bottom portion 134.

### <Damping Member 95>

Damping member 95 is disposed between movable body 20 and fixed body 50. In the present embodiment, a placement position of damping member 95 is top surface portion 142 of case 12 in fixed body 50, and more specifically, the position is on a surface of top surface portion 142 facing operation surface portion 5. The placement portion is an example of the facing portion that faces operation surface portion 5 at a forward position in the pressing direction of operation surface portion 5 (downward in the movable direction). The thickness of damping member 95 in a direction along the movable direction of movable body 20 is set so as not to interfere with a movable range of operation surface portion 5 in a case where movable body 20 is moved or vibrates in the movable direction through electromagnetic drive.

Accordingly, in a case where an excessive external force is applied to movable body or operation surface portion 5 and movable body 20 and operation surface portion 5 move with a stroke larger than the movable range so that operation surface portion 5 collides with damping member 95, damping member 95 can absorb the impact. By absorbing the impact, collision between movable body 20 or operation surface portion 5 and top surface portion 142 and a collision sound can be suppressed. In addition, it is possible to control the collision between movable body 20 and bottom surface 134 of case main body 13 and the collision sound. Note that, since the collision can be suppressed, movable body 20 and operation surface portion 5 can be protected from an external impact due to falling or the like, and durability of elastic supporting parts 81 and 82 that elastically support movable body 20 can be improved.

In addition, in the present embodiment, since damping member 95 is provided on the outer surface side of case 12, damping member 95 can be easily installed even after actuator 10a is fully assembled, and a buffer function can be easily retrofitted.

Note that, in the present embodiment, the thickness of damping member 95 is set so as not to interfere with the movable range of operation surface portion 5 in a case where movable body 20 is moved or vibrates in the movable direction through electromagnetic drive, but the present invention is not necessarily limited thereto. The thickness of damping member 95 may be set such that damping member 95 comes into contact with operation surface portion 5 in a case where movable body 20 is moved or vibrates in the movable direction through electromagnetic drive. In this case, by changing a material or a shape of damping member 95, it is possible to adjust the movable range of operation surface portion and movable body 20 or to finely adjust the operation feeling to be applied to the user.

<Operation of Actuator 10a>

FIG. 40 is a view for describing an operation of the actuator according to Embodiment 3 of the present invention.

With reference to FIG. 40, a description will be given of operation of actuator 10a in relation to one example in which magnet 30 is magnetized such that front surface 30a, which is one side of magnet 30 in the magnetization direction (upper side in the present embodiment), is the S-pole, and back surface 30b, which is the other side in the magnetization direction (lower side in the present embodiment), is the N-pole.

In actuator 10a, movable body 20 is considered to correspond to a mass in a vibration model of a spring-mass system, and a sharp peak can be reduced by damping a reciprocating motion, for example, when a resonance is sharp (has a sharp peak). Damping the vibration makes the resonance less sharp, so that the maximum amplitude value and the maximum movement amount of movable body 20, for example, at the time of resonance do not vary, and vibrations of the suitable and stable maximum movement amount are output.

Flow mf of the magnetic flux is formed, which is emitted from the back surface 30b side of magnet 30 to yoke 42 and then toward the coil 62 side and passes through outer yoke 70 and coil 61 to enter magnet 30 via yoke 41 on the upper side of magnet 30.

Accordingly, when energization is performed as illustrated in FIG. 40, the Lorentz force in the −f direction is generated in coils 61 and 62 by interaction between the magnetic field of magnet 30 and the currents flowing through coils 61 and 62 in accordance with Fleming's left hand rule.

The Lorentz force in the −f direction is in a direction orthogonal to the direction of the magnetic field and to the direction of the current flowing through coils 61 and 62. Since coils 61 and 62 are fixed to fixing body 50 (coil holding part 52), in accordance with the law of action and reaction, a force opposed to the Lorentz force in −f direction is generated as a thrust force in the f direction in movable body 20 having magnet 30. As a result, the movable body 20 side including magnet 30 moves toward the f direction, that is, toward bottom portion 134 (bottom surface of case main body 13).

On the other hand, when the energization direction of coils 61 and 62 is switched in the opposite direction and coils 61 and 62 are energized, the Lorentz force in a direction reverse to the f direction is generated. The generation of the Lorentz force in this f direction causes in movable body 20 the force opposite to the Lorentz force in the f direction as thrust (thrust in the −f direction) in accordance with the law of action and reaction, so that movable body 20 moves in the −f direction, i.e., toward the top surface of lid portion 14 of fixing body 50.

Actuator 10a makes it possible to provide the operator with a so-called haptic sensation and force sensation feedback (which may also be referred to as force feedback) via output shaft portion 25 in response to the user's operation by moving movable body 20 toward only one of lid portion 14 and bottom portion 134.

In addition, coils 61 and 62 can also be supplied with a current alternately in opposite directions to cause coils 61 and 62 to perform a reciprocating motion or vibrate, and this can be used to actuate movable body 20 through an operation of the operator.

In addition, in actuator 10a, a magnetic attraction force acts between magnet 30 and outer yoke 70, which functions as a magnetic spring in a non-driven (non-vibrated) state in which actuator 10a is not energized. The magnetic attraction force generated between magnet 30 and outer yoke 70 and a restoring force that brings elastic supporting parts 81 and 82 back to their original shapes cause movable body 20 to return to its original position.

Actuator 10a includes: fixing body 50 including coils 61 and 62; and movable body disposed radially inside coils 61 and 62 and including magnet 30 magnetized in the axial direction of coils 61 and 62. In addition, actuator 10a includes flat plate-shaped elastic supporting parts 81 and 82 that elastically hold movable body 20 such that movable body 20 is freely movable in the moving direction that is the coil axial direction.

Further, coils 61 and 62 are disposed on the outer circumference of holding-portion main body 522 of coil holding part 52, outer circumferential surface 20a of movable body is disposed on the inner circumferential side of holding-portion main body 522 with a gap being interposed between the outer circumferential surface of the movable body and the holding-portion main body, and coils 61 and 62 are, at the outer circumferential surface, surrounded by outer yoke 70.

Accordingly, in actuator 10a, the leakage magnetic flux to the radially outer side is suppressed, and outer yoke 70 together with magnet 30, yokes 41 and 42, and coils 61 and 62 functions as a magnetic path. Thus, generation of thrust by the magnetic force can be improved. Further, the detection of the magnetic flux density by magnetic sensor 91 on the bottom surface side is not influenced at all.

As illustrated in FIG. 40, when movable body 20 moves to the lid portion 14 side, or the upper side (arrow “Upward in movable direction”), magnet 30 is separated from magnetic sensor 91. Thus, the leakage magnetic flux detected by magnetic sensor 91 at a lower portion of case 12 is weak.

Further, when movable body 20 moves toward the bottom portion 134 side (arrow “Downward in movable direction”), magnet 30 approaches magnetic sensor 91, and the leakage magnetic flux detected by magnetic sensor 91 becomes strong. Accordingly, magnetic sensor 91 can detect the magnetic flux density in response to the operation of movable body 20. It is thus possible to directly apply a haptic sensation directly reproducing movement, vibration, and/or impact via output shaft portion 25 based on the detection result.

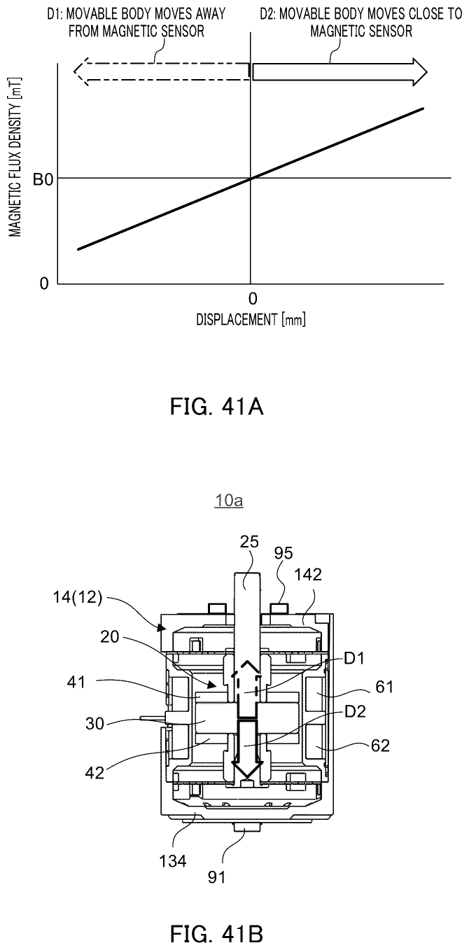

FIGS. 41A and 41B are diagrams for explaining sensing of the magnetic sensor, and FIG. 41A illustrates the relation between the magnetic flux density detected by the magnetic sensor and the displacement of the magnet, and FIG. 41B schematically illustrates the actual operation of the movable body corresponding to the detection of FIG. 41A.

As illustrated in FIGS. 41A and 41B, when movable body 20 having a configuration in which magnet 30 is sandwiched between magnet 30 and yokes 41 and 42 moves in direction D1, that is, toward lid portion 14, movable body 20 becomes remote from magnetic sensor 91, and the magnetic flux density decreases. In addition, when movable body 20 moves in direction D2, that is, toward bottom portion 134, or in this case, toward magnetic sensor 91 disposed at a lower portion, the detected magnetic flux density increases.

As described above, magnetic sensor 91 can linearly detect the relationship between the magnetic flux density and the displacement of the movable body, and can suitably detect the position of movable body 20 based on the relationship.

Actuator 10a has a structure in which unit 15 is accommodated in case 12, and the outer circumferential surface of circumferential wall portion 132 of case 12 formed from a resin can thus be formed as a smooth surface. Thus, when actuator 10a is attached to an electronic device, it is possible to reliably and easily perform attachment of a cushioning material such as a sponge to be interposed between actuator 10a and a mounting point.

Moreover, since actuator 10a has the configuration in which unit 15 is disposed in case 12, fixation of elastic supporting parts 81 and 82, which requires high dimensional accuracy, can be achieved by attaching elastic supporting parts 81 and 82 to coil holding part 52.

Thus, arrangement of movable body 20 including the fixation of elastic supporting parts 81 and 82 can be determined with reference to coil holding part 52, so that it is possible to increase the accuracy of the haptic sensation generation direction of the product. Specifically, only increasing the dimensional accuracy of coil holding part 52 formed as one component from a resin or the like makes it possible to easily dispose coils 61 and 62 and movable body 20 (magnet 30) attached via elastic supporting parts 81 and 82 in an accurate positional relationship, for example.

Further, terminal part 75 are disposed on coil holding part 52 to protrude outward, so that tying and soldering of the coil wire of the coils are facilitated, and connection between an external device and coils 61 and 62 can be facilitated.

As described above, actuator 10a can perform haptic sensation presentation while having impact resistance.

Actuator 10a is driven by a pulse (a direct current (DC) pulse or an alternating current (AC) pulse) input to coils 61 and 62. That is, the energization direction of coils 61 and 62 may be appropriately set so that thrust in the −f direction toward top surface portion 142 of lid portion 14 or thrust in the f direction toward bottom portion 134 acts on movable body 20, or so that these thrusts in the −f direction and the f direction alternately act on the movable body. As a result, movable body 20 moves in the moving direction or in the vibration direction, and the force feedback can be performed via actuator 10a itself or output shaft portion 25.

As described above, actuator 10a can be easily manufactured at a low cost, and has a detection function and a haptic feedback function that are easier to use.

<Driving Principle of Actuator 10a>

The driving principle of actuator 10a will be simply described. Actuator 10a is driven, for example, by a supplied pulse based on following Equation 1 of motion and Circuit Equation 2. In the present embodiment, the driving is performed by inputting a short pulse, but the driving may be performed so as to generate an arbitrary reciprocating motion and without using the short pulse.

Movable body 20 in actuator 10a performs reciprocating motion based on Equations 1 and 2.

$$\begin{matrix}[ 3 ] & \\ m \frac{{d}^{2} x ( t )}{{dt}^{2}} = {K}_{f} i ( t ) - {K}_{s p} x ( t ) - D \frac{dx ( t )}{dt} & ( Equation 1 )\end{matrix}$$

m: Mass [kg]
x(t): Displacement [m]
K_{f}: Thrust constant [N/A]
i(t): Current [A]
Kₛₚ: Spring constant [N/m]
D: Damping coefficient [N/(m/s)]

$$\begin{matrix}[ 4 ] & \\ e ( t ) = R i ( t ) + L \frac{di ( t )}{dt} + {K}_{e} \frac{dx ( t )}{dt} & ( Equation 2 )\end{matrix}$$

e (t): Voltage [V]
R: Resistance [Ω]
L: Inductance [H]
Kₑ: Reverse electromotive force constant [V/(m/s)]

Mass m [Kg], displacement x(t) [m], thrust constant K_{f} [N/A], current i(t) [A], spring constant Kₛₚ [N/m], damping coefficient D [N/(m/s)], and the like in actuator 10a may be changed appropriately as long as Equation 1 is satisfied. In addition, voltage e (t) [V], resistance R [Ω], inductance L [H], and reverse electromotive force constant Kₑ [V/(m/s)] may be changed appropriately as long as Equation 2 is satisfied.

Accordingly, actuator 10a is determined by mass m of movable body 20 and spring constant Kₛₚ of metallic springs (the elastic bodies or the leaf springs in the present embodiment) as elastic supporting parts 81 and 82.

### <Function of Actuators 10 (10-1, 10-2, 10-3)>

Actuators 10 (10-1, 10-2, 10-3) configured as described above have the following functions by driving movable body 20.

Movable body 20 is driven to apply a vibration stimulus or a direct stimulus to the user who operates the operation surface portion, so that a haptic sensation that acts directly on a force sense haptic sensation is applied.

Movable body 20 is also driven to apply, to the user who operates operation surface portion 5, a load that compensates for or follows a load (operation load) applied by a pressing operation by the user performed on movable body 20 via operation surface portion 5, or to reduce the load applied to the user by applying a load in a direction opposite to the direction of the load. Accordingly, a haptic sensation such as hardness or softness of the operation part (operation surface portion) is applied as the operation feeling to the user who operates operation surface portion 5.

By driving movable body 20 such that presentation of a haptic sensation applied to the user performed by outputting vibration in accordance with a position where operation surface portion 5 is pressed is repeatedly performed in a stepwise manner, it is possible to apply, to the user who operates operation surface portion 5, the operation feeling of a selection function change with multi-stage haptic sensations.

In addition, in a state where operation surface portion 5 does not protrude from front surface 4b, the operation with operation surface portion 5 can be prompted. That is, the operation surface of operation input apparatus 1a is an operation surface having a design without unevenness as a hint for causing the user to operate the operation part, that is, an operation surface without a so-called signifier affordance, and is an operation surface that is less visually recognizable.

In operation input apparatus 1a having such an operation surface, operation surface portion 5, which is the operation part itself integrated with movable body 20 of actuator 10a, operates so as to suggest the position of the operation part or to induce the user toward that position, thereby suggesting the position of operation surface portion 5, that is, the operation position.

In addition, operation input apparatus 1a operates operation surface portion 5, which is the operation part itself integrated with movable body 20 of actuator 10a, to be capable of performing an operation like an active human machine interface (HMI)-like operation on the user.

In addition, in the present embodiment, the operation part configured to be movable in a direction protruding from the operation surface is composed of only actuator 10a without using a power transmission mechanism together with the actuator (motor). Accordingly, in operation input apparatus 1a, the structure is simplified and the assembly is facilitated. In addition, the operation part can be operated by only the actuator without using a plurality of power transmission members constituting the power transmission mechanism section to drive the operation part, so that an operation can be realized with high accuracy with respect to the operation surface portion.

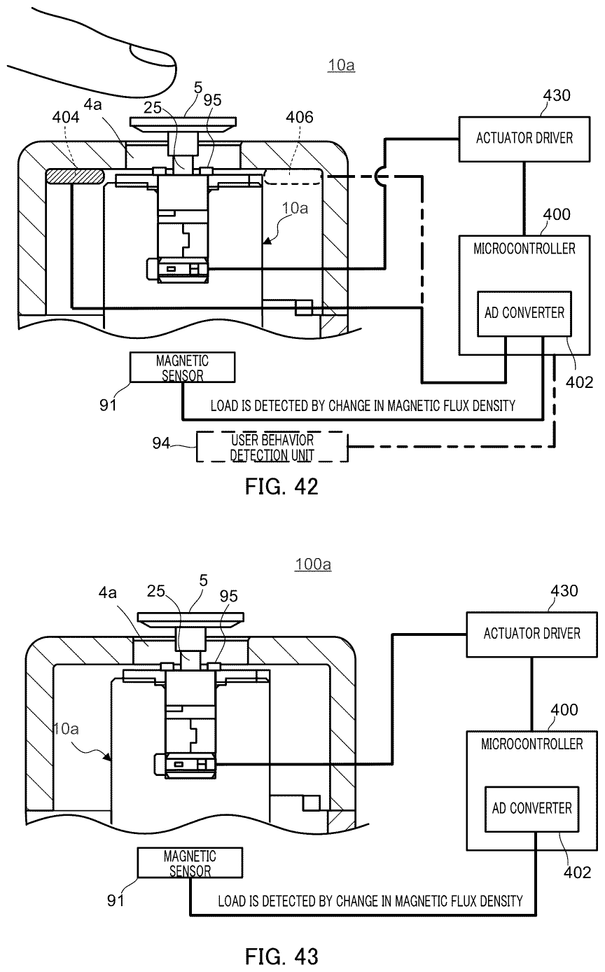

FIG. 42 is a view schematically showing a configuration of a principal part of the operation input apparatus according to Embodiment 3 of the present invention.

Operation input apparatus 1a shown in FIG. 42 includes the plurality of actuators 10a (10-1, 10-2, 10-3) and AD converter 402. Note that, operation input apparatus 1a includes microcontroller 400 as a control part that controls actuators 10a, actuator driver 430, and proximity sensors 404.

As described above, magnetic sensor 91 included in actuator 10a functions to detect the load applied to the movable body via operation surface portion 5, and also functions to perform feedback control of the position of movable body 20.

In a case where operation surface portion 5 is operated, the operation load is applied to actuator 10a, and the operation load is detected by magnetic sensor 91 from the change in magnetic flux density. The detected operation load is output to microcontroller 400, which is the control part, via AD converter 402.

Each of proximity sensor 404 detects the presence or absence of an object approaching operation surface portion 5 and outputs the presence or absence to microcontroller 400, which is the control part.

Proximity sensor 404 may be any type of sensor as long as the sensor detects approach and spacing of the object and a state of the object in a noncontact manner. For example, proximity sensor 404 may be an electromagnetic induction-type (high-frequency oscillation-type) proximity sensor, a capacitive proximity sensor, a magnetic proximity sensor, an optical time-of-flight (ToF) sensor, an ultrasonic ToF sensor, or the like.

Here, proximity sensor 404 is a capacitive sensor, detects a change in electrostatic capacity or an electrical change occurring in a case where the object approaches or moves away from operation surface portion 5, and outputs the change, as a detection result (detection value), to microcontroller 400 via AD converter 402.

Proximity sensor 404 is disposed at a position at which the approach of a finger can be detected in a case where an object approaching operation surface portion 5, for example, a finger of the user who operates operation surface portion 5, approaches. In operation input apparatus 1a, as shown in FIG. 30, proximity sensors 404 may be disposed in placement region 403 around opening portion 4a in the front surface of apparatus case 2 (front surface 4b of cover portion 4), and any number of proximity sensors 404 may be disposed as long as the number thereof corresponds to the number of operation surface portions 5 in opening portion 4a. In addition, as indicated by proximity sensor 406 in FIG. 42, for example, a plurality of proximity sensors, each of which includes an oscillation circuit incorporating a detection electrode that generates an electric field and a detection circuit that detects a change in oscillation frequency of the oscillation circuit, may be provided at a plurality of locations.

Microcontroller (control part) 400 drives actuator 10a via actuator driver 430 based on input information. The microcontroller may be a microcontroller incorporating edge AI, and the plurality of actuators of operation input apparatus 1a may perform various operations in accordance with input information.

Microcontroller 400 drives actuator 10a via the actuator driver based on detection information on the object from proximity sensor 404, the position of movable body 20 from magnetic sensor 91, information about the load applied to movable body 20, and the like to move operation surface portion 5. For example, microcontroller 400 drives actuator 10a to present, to the user, the haptic sensation of operation surface portion 5 as described above (hardness or softness, for example, the haptic sensation of being pricked), a click sensation of a multi-stage operation, the position of the operation surface portion. Note that, microcontroller 400 digitizes an analog voltage from proximity sensor 404 by an analog-to-digital conversion circuit (ADC), determines a position indicated by information, and selects and generates a drive pattern based on the position. Microcontroller 400 outputs a command and a drive signal for driving in the selected and generated drive pattern to circuit board (control part) 92 and actuator driver 430 to operate movable body 20.

Microcontroller 400 can drive the actuator to perform active suggestion expression or sensitivity expression by observing, recognizing, and determining the information from proximity sensor 404 and magnetic sensor 91, that is, the information indicating the situation of the user.

Here, in operation input apparatus 1a, the drive of actuator 10a based on the detection information on the object from proximity sensor 404 will be described.

For example, in a case where the user brings a finger close to operation surface portion 5 to move operation surface portion 5, actuator 10a can enter a protruding state or a projecting and retracting operation state, and the user can be prompted to move operation surface portion 5 via operation surface portion 5.

Microcontroller 400 may have a plurality of drive patterns of actuator 10a based on the detection information from proximity sensor 404.

Specifically, in a case where the finger of the user as an object approaches in a case where operation surface portion 5 is in a state of being flush with front surface 4b of case 2 (cover portion 4), operation surface portion 5 is caused to be positioned to protrude, so that the position thereof is recognized, on the assumption that the finger approaches for operation of operation surface portion 5. For example, in a case where the finger (object) of the user approaches operation surface portion 5, operation input apparatus 1a may cause all operation surface portions 5 to protrude. In addition, operation input apparatus 1a may drive the actuator close to proximity sensor 404 that has detected the approach of the object to bring operation surface portion 5 closest to the finger into a protruding state, so that the position thereof is checked and operation surface portion 5 is made operable.

In addition, in a case where the user operates operation surface portion 5 with the finger, microcontroller 400 has a plurality of operation patterns for cases of driving actuator 10a in accordance with operations of operation surface portion 5 by the finger.

Specifically, microcontroller 400 drives actuator 10a via actuator driver 430 to output vibration, force, and displacement, and directly applies an operation feeling to the user via the operation part.

Microcontroller 400 can feed back a haptic sensation corresponding to the load detected by magnetic sensor 91, that is, the load input to actuator 10a, to the user who operates operation surface portion 5 of actuator 10a.

Microcontroller 400 drives actuator 10a in each operation pattern to apply vibration in a case where the user presses operation surface portion 5 or separates the finger from operation surface portion 5, and to further apply different vibration in a case where operation surface portion 5 is pushed in. These operations may also be referred to as vibration feedback, and different vibration may be applied to each of operation surface portions 5-1 and 5-2.

FIG. 43 is a view schematically showing a configuration of a principal part of a variation of operation input apparatus 1a in a case where the proximity sensor is not provided.

Operation input apparatus 100a of FIG. 43 has the configuration of operation input apparatus 1a shown in FIG. 42, except that proximity sensor 404 is not provided. Operation input apparatus 100a drives the operation part in an operation pattern corresponding to the pushing-in operation by the user regardless of the presence or absence of the proximity sensor, as in operation input apparatus 1a. Similarly to operation input apparatus 1a, microcontroller 400 of operation input apparatus 100a detects the pressing (pushing-in operation) of operation surface portion 5 by the user by magnetic sensor 91 and drives movable body 20 in an operation pattern corresponding to the operation to apply a haptic sensation as an operation feeling corresponding to the pushing-in operation.

Operation input apparatuses 1a and 100a (specifically, microcontroller 400) supply a current in accordance with the stroke of movable body 20 detected by magnetic sensor 91 such as a Hall sensor, drives movable body 20, and controls a reaction force or thrust of movable body 20 (operation surface portion 5) in response to the pushing-in.

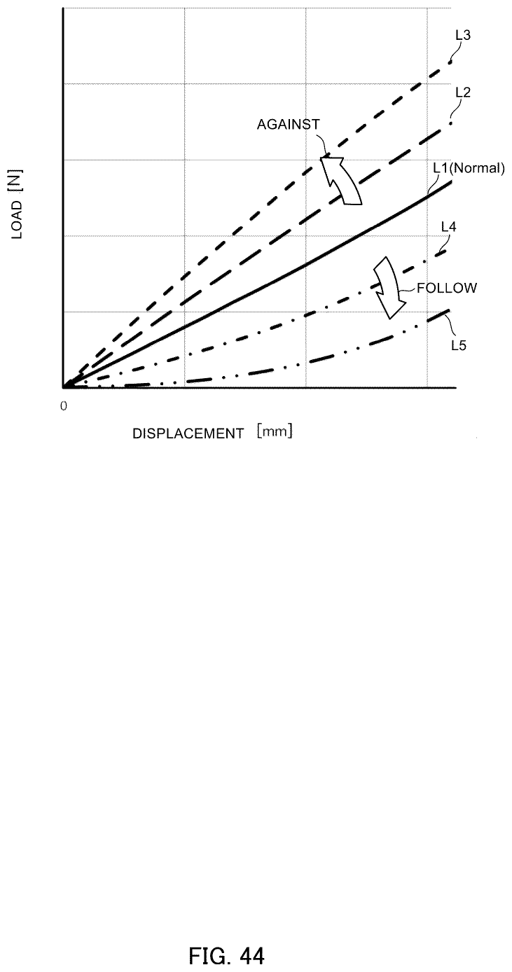

FIG. 44 is a view showing an example of operation control of the actuator, and illustrates F-S curves showing a relationship between the displacement [mm] of the movable body of the actuator and the load [N] applied to the movable body. FIG. 44 shows haptic sensations as an example of expression by proportional current inputs (graphs L1 to L5) corresponding to the F-S curves.

Actuator 10a is set to apply a reaction force (or thrust) to movable body 20 (operation surface portion 5 that is pushed in) for displacement, for example, such that a relationship with an input current shown in FIG. 44 is satisfied. For example, in a case where graph L1 is an input current of a normal haptic sensation, this input current is used as a reference and actuator 10a is controlled to be driven such that graphs L2 and L3 are obtained and a reaction force (“AGAINST”) in a direction opposite to the operation direction is applied. In addition, the actuator is driven such that graphs L4 and L5 are obtained to apply thrust that follows the pressing in the operation direction. Accordingly, actuator 10a imparts a hard haptic sensation to the user and is controlled as in the cases of L4 and L5. Microcontroller 400 can vary the current to satisfy the relationship of graphs L1 to L5 or the like in accordance with the operation amount (stroke) and can change the hardness or softness of operation surface portion (operation part) 5 as the haptic sensation to be applied. That is, actuator 10a can perform the actuation of movable body 20 by supplying a current variable in accordance with the operation amount by the user and can change the hardness or softness of the haptic sensation as the operation feeling to be applied to the user.

For example, actuators 10a (10-1 to 10-3) connected to operation surface portions 5-1 to 5-3 are driven such that the thrust is applied as described above, to present a haptic sensation to the user.

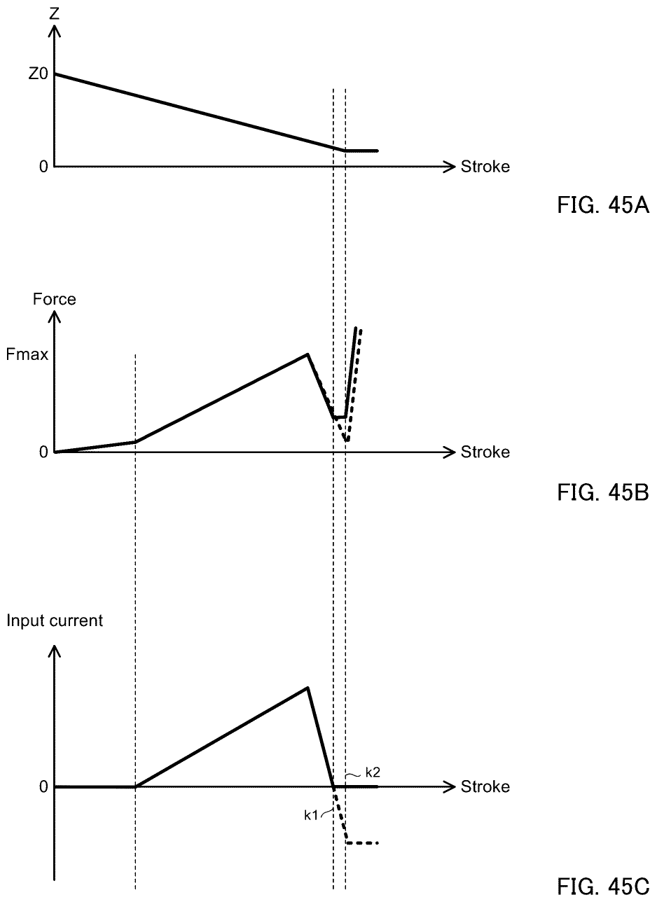

FIGS. 45A to 45C are views showing an example of operation patterns of the actuator, and specifically, FIGS. 45A to 45C are views showing an outline of a haptic sensation expressed by an operation of the actuator in a case where the operation surface portion is operated by the user. FIG. 45A shows a stroke of movable body 20 corresponding to a pushing-in amount of a button returning from top position Z0 to initial position 0. FIG. 45B shows a relationship between a stroke (“Stroke”) corresponding to the pushing-in amount as an operation pattern of the actuator corresponding to the pushing-in amount of FIG. 45A and force (here, a reaction force: “Force”) generated in accordance with the stroke. FIG. 45C shows a relationship between the stroke and the input current corresponding to the reaction force shown in FIG. 45B.

FIGS. 45A to 45C show two operation patterns in which the heights of the input currents are different between lengths of strokes (Stroke) k1 and k2, and the pattern shown by a broken line expresses a deeper haptic sensation than the pattern shown by a solid line and expresses a click sensation in a case where a click rate is low. Note that, the click rate is an indicator for expressing buckling of a switch, is calculated using a point at which buckling is caused by pushing in the switch and a reaction force value at which the reaction force is a minimum value when the switch is further pushed in, and indicates a degree of force applied to the user in a case of buckling.

As shown in FIGS. 45A to 45C, actuator 10a varies a bias current (input current) supplied to the coil in accordance with the pushing-in amount (operation amount) of movable body 20 by the user pressing operation surface portion 5.

Actuator 10a applies a reaction force to movable body 20 or adds thrust to movable body 20 in response to the pushing-in amount of movable body 20 by means of, for example, the bias current to be supplied. In addition, actuator 10a controls the driving of movable body 20 by decreasing the bias current to be supplied or causing the bias current to flow in an opposite direction at a stage where the bias current exceeds a threshold value. That is, actuator 10a can set the bias current to be variable in accordance with the operation amount of operation surface portion 5 and can vary the operation feeling in a case of operating operation surface portion 5 such that the operation feeling corresponds to the preference of the user.

As described above, actuator 10a performs the actuation of movable body 20 by varying the bias current in accordance with the operation amount by the user, applies a reaction force to the movable body, and can express a buckling haptic sensation as the operation feeling to the user by means of a current that decreases or a current that flows in the opposite direction at a stage where the current exceeds the threshold value. In this way, operation input apparatus 1a can vary the current supplied to coils 61 and 62 to change the expression of the hardness or softness of the operation feeling, the buckling haptic sensation, and the like, and can impart a more excellent operation haptic sensation.

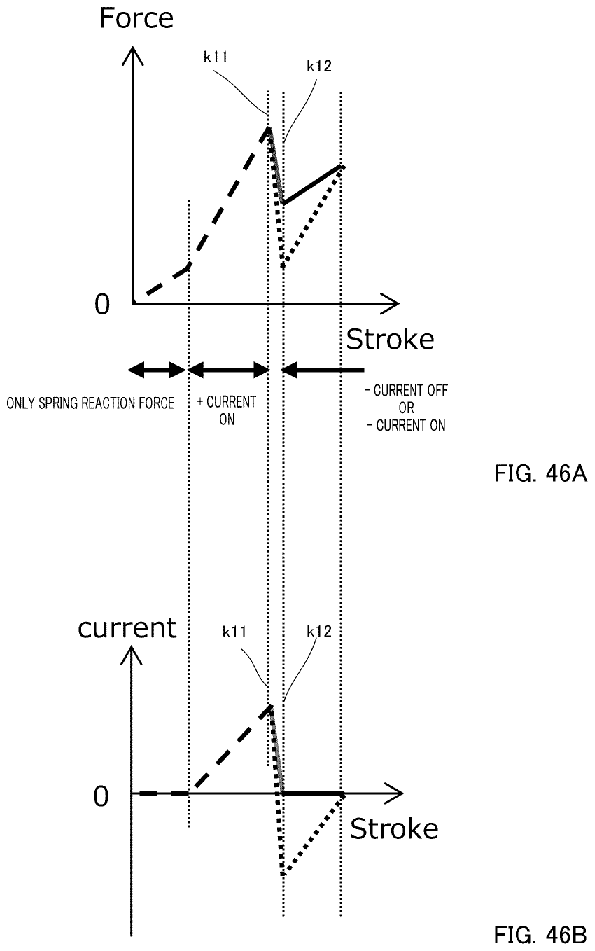

FIGS. 46A and 46B are views showing an example of operation patterns of operation input apparatus 1a, and specifically, FIGS. 46A and 46B are views showing an example of a waveform for describing a case of expressing a switch in operation pattern control of the actuator. FIG. 46A is a view showing a relationship between a stroke (“Stroke”) of the pushed-in movable body 20 and force (“Force”), so-called, an F-S curve. The F-S curve indicates an operation force, a reaction force, a click rate, and the like of the operation surface portion (movable body) that determine a haptic sensation of the switch. In addition, FIG. 46B shows a relationship between the stroke of pushed-in movable body and a haptic sensation (specifically, an input current in a case of applying a reaction force (“Force”) in an upward direction, that is, in a case of force feedback (FFB)). Note that, the click rate can be said to be a proportion between an actuation force acting on a finger pushing in and a force of pushing in.

In FIGS. 46A and 46B, in a case where operation surface portion 5 is pushed in, operation surface portion 5 moves (performs a stroke) downward while receiving a reaction force of elastic supporting parts 81 and 82. That is, at the start of pushing in operation surface portion 5, the user who presses operation surface portion 5 receives only the reaction force (force opposite to a pushing-in direction) of elastic supporting parts (for example, leaf springs) 81 and 82 as a haptic sensation.

Then, in a case where the user pushes in operation surface portion 5 while receiving the reaction force of elastic supporting parts 81 and 82 and operation surface portion 5 reaches a predetermined stroke position, microcontroller 400 starts feeding power to actuator 10a (coil) at “+ current ON.” Accordingly, the reaction force against the pushing force of the user is increased, and a haptic sensation of pressing the button is applied to the user.

As described above, microcontroller 400 varies the current in accordance with the operation amount (stroke) and applies the force (reaction force: “AGAINAST”) to operation surface portion 5 while increasing the force, and decreases the current (“+ current OFF”) or causes the current to flow in the opposite direction (in FIG. 46B, the current flows from set value k11 to k12) at a stage where the set value (threshold value) k11 is exceeded, so that a buckling haptic sensation is expressed. With this buckling haptic sensation, it is possible to recognize the input of the switch as a haptic sensation.

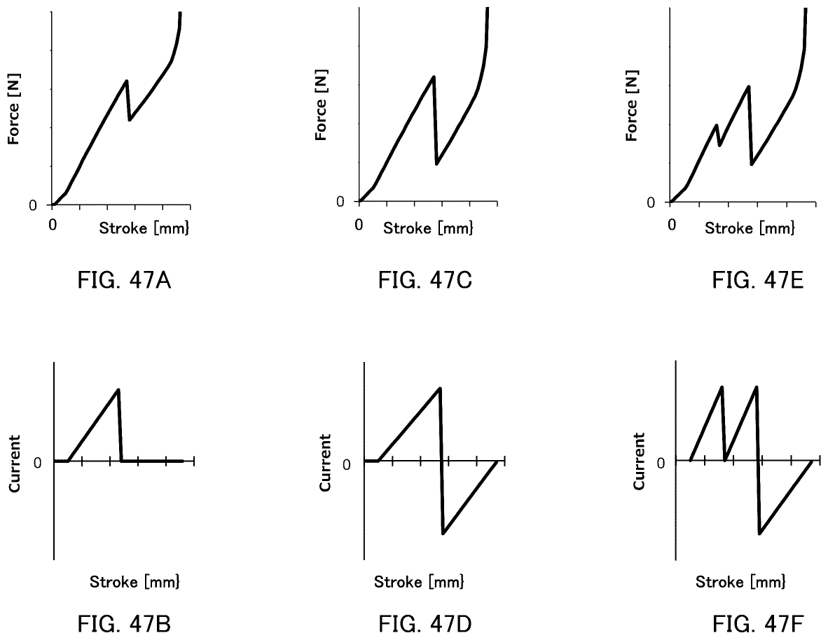

FIGS. 47A to 47F are views showing an example of operation patterns in a case of expressing a switch in operation pattern control of the actuator, and are views for describing switch expression based on the switch expression of FIGS. 46A and 46B. Note that, FIGS. 47A, 47C, and 47E are “F-S curves” in which a vertical axis corresponds to a load and a horizontal axis corresponds to a moving amount. FIGS. 47A and 47B show a relationship between a force (reaction force or thrust: “Force [N]”), a pushing-in amount (“Stroke [mm]”), and an input current (“Current”) in a case of expressing a switch having a low click rate. FIGS. 47C and 47D show a relationship between a force (reaction force or thrust: “Force [N]”) and a pushing-in amount, and a relationship between an input current (“Current”) and the pushing-in amount (“Stroke [mm]”) in a case of expressing a switch having a high click rate. FIGS. 47E and 47F show a relationship between a thrust and a pushing-in amount, and a relationship between an input current and a pushing-in amount in a case of expressing a two-stage click. In a case of expressing a low click rate in this way in the switch expression, actuator 10a is controlled such that the depth of pushing in is imparted more as a haptic sensation, as compared to a case of expressing a high click rate.

In FIGS. 47E and 47F, the increased reaction force is increased by decreasing the + current or turning OFF the + current at predetermined two positions in the stroke, and causing the − current to flow to increase the thrust. Then, a reaction force is applied at a predetermined pushed-in position instead of the increased thrust, and the haptic sensations are applied twice to enable the haptic sensation of the two-stage switch to be applied. Although the haptic sensations are applied at two stages here, a multi-stage switch expression can be realized by controlling movable body 20 to be pushed in to generate a reaction force and thrust at a plurality of set positions and configuring movable body 20 to apply a haptic sensation of three or more stages.

In this way, actuator 10a actuates movable body 20 in a multi-stage manner in the moving direction in accordance with the operation amount of movable body 20 due to the operation by the user, so as to apply an operation feeling to the user.

In each switch expression of FIGS. 47A to 47F, as in the operation in the switch expression shown in FIGS. 46A and 46B, in a case where movable body 20 to be pushed in reaches a predetermined stroke (set value), the current is turned OFF or a reaction force (force “AGAINST”) is generated, so that a click sensation and a switch-like tactile sensation can be appropriately generated.

As shown in FIGS. 15 to 47F, operation input apparatus 1a (specifically, microcontroller 400) drives actuator 10a to express a switch that generates vibration feedback or force feedback.

### <Example of Operation Using Operation Pattern: Vibration Feedback (FB)>

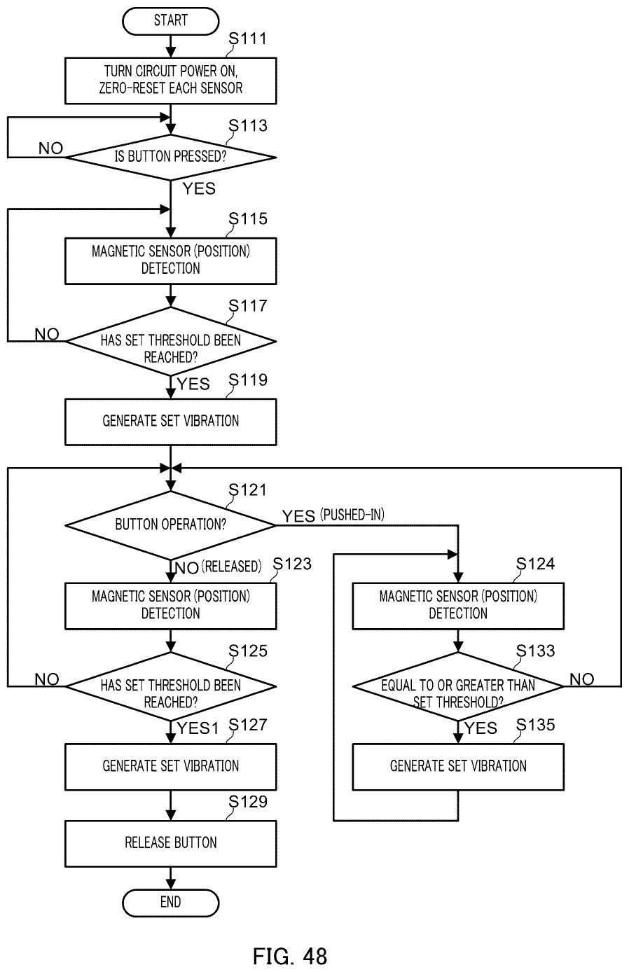

FIG. 48 is a flowchart showing an example of an operation using the operation patterns of the operation input apparatus, and shows control of an operation of vibration feedback that applies vibration to the user in response to the operation. Note that, in the following flowchart, operation surface portion 5 as the operation part is referred to as a “button.”

As shown in FIG. 48, in step S111, in a case where a circuit power supply is turned on, sensors, such as proximity sensors 404 and magnetic sensors 91, are zero-reset. Next, in step S113, microcontroller 400 monitors the pressing of the button via magnetic sensor 91, and in a case where the button is pressed, microcontroller 400 detects position information on movable body 20 via magnetic sensor 91 in step S115. That is, in step S115, microcontroller 400 detects the position of movable body 20 by means of magnetic sensor 91 to detect a pressed state (pushed-in position) of movable body 20, that is, the position of the operated button (operation surface portion 5).

Next, in step S117, microcontroller 400 determines whether or not the position (stroke) of movable body 20 has reached a set threshold value (depth from a pushing-in start position). In step S117, microcontroller 400 determines whether or not the displacement amount of operation surface portion 5 (the displacement amount of movable body 20 due to being pressed) has reached a predetermined amount (a predetermined length of movement). In addition, for the determination in step S117, the threshold value is set including a dead zone in order to prevent malfunction such as vibration caused in a case where a predetermined position is not reached. Note that, the threshold value is set to provide an appropriate operation feeling for generating a haptic sensation.

In step S117, in a case where the position of movable body 20 displaced through the operation has reached a predetermined position, that is, in a case where operation surface portion 5 has been pressed by a predetermined length, the process proceeds to step S119. In step S119, microcontroller 400 drives actuator 10a via actuator driver 430 to cause actuator 10a to perform a predetermined operation (for example, to generate vibration set as in the switch expression shown in FIGS. 44 to 46).

Next, in step S121, microcontroller 400 determines whether or not the button (operation surface portion 5) is operated via magnetic sensor 91, and in a case where no operation is performed (in a case where the button is “released”), the process proceeds to step S123. In step S123, microcontroller 400 detects a position where the pushing-in of the button is stopped (the “release” position of the button) and the process proceeds to step S125. On the other hand, in step S121, in a case where the pushing-in operation of the button is performed, the process proceeds to step S124, and microcontroller 400 detects the position of movable body 20, that is, the pushed-in position of operation surface portion 5 via magnetic sensor 91 and the process proceeds to step S133.

In step S133, microcontroller 400 determines whether or not the pushed-in position of the button is the set threshold value (step S133). In step S133, in a case where it is equal to or greater than the set threshold value, microcontroller 400 generates an operation pattern set for the operation, for example, vibration in step S135, and in a case where the set threshold value is not reached, the process returns to step S121 and the process is repeated.

In step S125, microcontroller 400 determines whether or not the position where the pushing-in of the button is stopped has reached the set threshold value, and in a case where the position has reached the threshold value, the process proceeds to step S127, and in a case where the position has not reached the threshold value, the process returns to step S121 and the process is repeated.

That is, in step S125, in a case where the button operation is released and the pushing-in amount when the button operation is released has reached the set pushing-in amount (threshold value), the process proceeds to step S127. In step S127, microcontroller 400 generates vibration by using the operation pattern for generating the set vibration, and the finger that receives the vibration as a haptic sensation is separated from the button (step S129).

As described above, microcontroller 400, that is, operation input apparatus 1a feeds back vibration corresponding to the operation to the user in a case where the user pushes in and operates operation surface portion 5.

### <Example of Operation Using Operation Pattern: Force Feedback (FFB)>

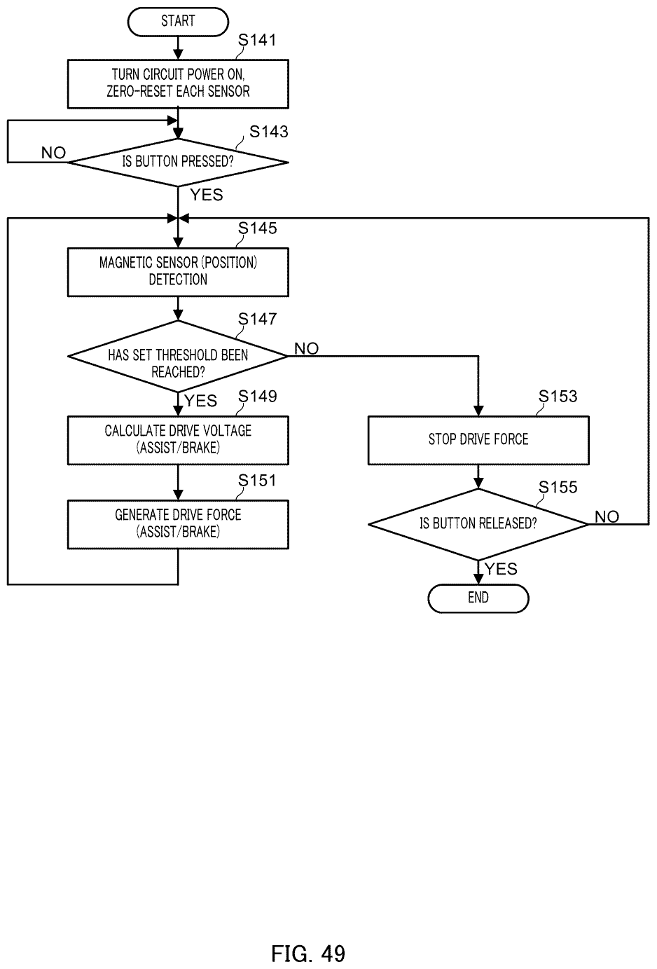

FIG. 49 is a flowchart showing an example of an operation using the operation patterns of the operation input apparatus, and specifically, FIG. 49 shows processing of a force feedback operation as an example of processing of applying a haptic sensation that assists the operation by the user who operates operation surface portion 5.

As shown in FIG. 49, in step S141, in a case where a circuit power supply is turned on, sensors, such as proximity sensors 404 and magnetic sensors 91, are zero-reset. Next, in step S143, microcontroller 400 monitors the pressing of the button via magnetic sensor 91, and in a case where the button is pressed, microcontroller 400 detects position information on movable body 20 via magnetic sensor 91 in step S145. That is, in step S145, microcontroller 400 detects the position of movable body 20 by means of magnetic sensor 91 to detect a state of operated movable body 20, that is, the pressed state (pushed-in position) of operation surface portion 5.

Next, in step S147, microcontroller 400 determines whether or not the position of movable body 20 has reached a predetermined position, that is, whether or not the detected position has reached a set position (threshold value). That is, in step S147, microcontroller 400 determines whether or not the displacement amount of operation surface portion 5 (the displacement amount of movable body 20 due to being pressed) has reached a predetermined amount (a predetermined length of movement). In step S147, in a case where the position of movable body 20 has reached a set predetermined position, that is, in a case where operation surface portion 5 has been pressed by a predetermined length, the process proceeds to step S149. Note that, similarly to the threshold value in step S117, the threshold value in step S147 is set including a dead zone in order to prevent malfunction such as vibration in a case where a predetermined position is not reached.

In step S149, microcontroller 400 calculates a drive voltage of actuator 10a, that is, sets a driving force (specifically, assisting or braking the operation by the user) for operating the actuator, and the process proceeds to step S151.

In step S151, microcontroller 400 drives the actuator via actuator driver 430 to generate a driving force such as an assisting force (thrust) or braking force (reaction force). Accordingly, movable body 20 moves, applies a haptic sensation that stimulates the force sense of the user via operation surface portion 5, and the process returns to step S145 to repeat the process.

In step S147, in a case where the position (displacement amount) of movable body 20 has not reached the set threshold value, the process proceeds to step S153, and microcontroller 400 stops the generation of the driving force by actuator 10a and the process proceeds to step S155.

In step S155, microcontroller 400 detects whether or not the finger of the user is separated from the button based on the input information from magnetic sensor 91, returns to step S145 and repeats the process in a case where the finger is not separated, and ends the process in a case where the finger is separated.

<Operation Pattern Control of Example of Operation: One-Stage Switch Expression with Morphing Function>

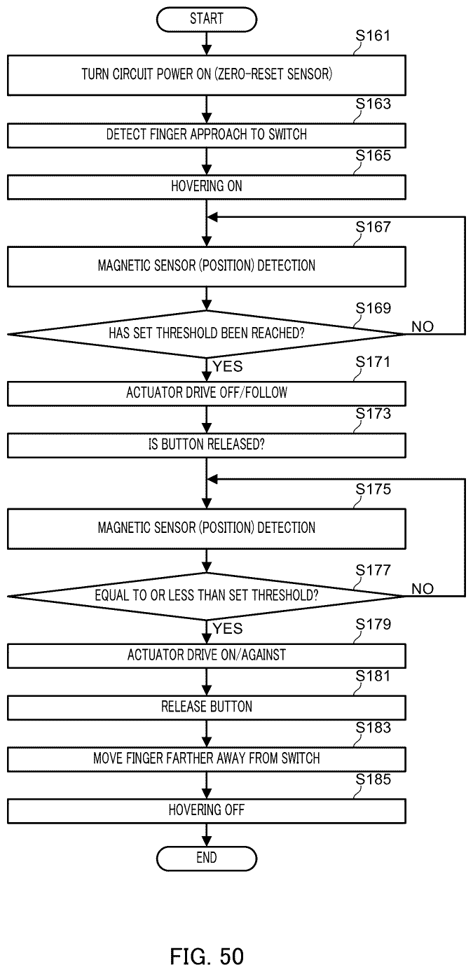

FIG. 50 is a flowchart showing an example of an operation using the operation patterns of the operation input apparatus according to Embodiment 3 of the present invention, and specifically, FIG. 50 shows operation processing of switch expression that applies a one-stage haptic sensation with a morphing function. Note that, hereinafter, operation surface portion 5 as the operation part in operation input apparatus 1a is referred to as a button, and a portion including operation surface portion 5 is also referred to as a switch.

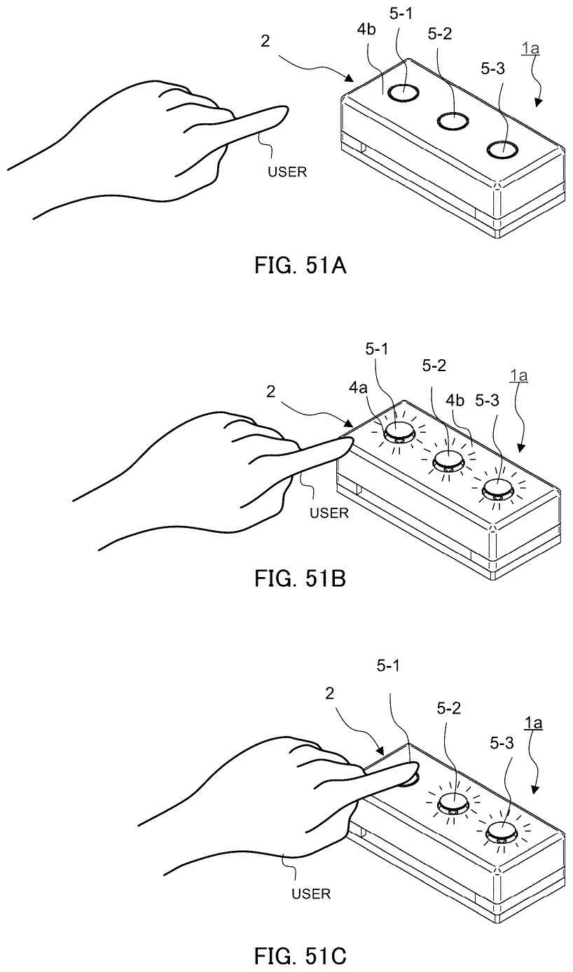

As shown in FIG. 50, in step S161, first, in a case where a circuit power supply is turned on, operation input apparatus 1a is driven, and proximity sensors 404 and magnetic sensors 91 are zero-reset. FIGS. 51A to 51C show an example of operation input apparatus 1a in this state. FIGS. 51A and 51B are views showing an example of an operation of the operation input apparatus according to Embodiment 3 of the present invention.

As shown in FIG. 51A, in order to move operation surface portion 5 (5-1) of the switch portion, the user brings a finger close to operation surface portion 5 with respect to operation input apparatus 1a. Then, in step S163, proximity sensor 404 detects the approach of the finger to the switch and outputs detection information to microcontroller 400 (see FIG. 42). In step S163, microcontroller 400 (see FIG. 42) detects the approach of the finger via proximity sensor 404 and the process proceeds to step S165.

In step S165, microcontroller 400 drives actuator 10a to displace operation surface portion 5 (and also movable body 20). That is, operation surface portion 5 (and also movable body 20) is displaced to the hovering state (“Hovering ON”), which is a state in which operation surface portion 5 is moved upward and protrudes, in an operation of hinting an operation to be performed on operation surface portion 5 itself (see FIG. 41B). In this way, in the switch having operation surface portion 5, operation surface portion 5 itself presents the operation position of operation surface portion 5 to the user or prompts the operation using operation surface portion 5 by protruding and displacing (morphing) from front surface 4b.

In addition, microcontroller 400 brings operation surface portion 5 into a state where the user can perform an operation. The state where the user can move operation surface portion 5 is a state where when operation surface portion 5 directly connected to actuator 10a is operated, actuator 10a can be operated in a plurality of operation patterns by microcontroller 400 in order to give a haptic sensation corresponding to the operation.

This state is shown in FIG. 41B. That is, in a case where the finger of the user approaches operation surface portion 5, all operation surface portions 5, which are the operation part of operation input apparatus 1a, rise. Accordingly, operation surface portion enters a state that is easy to see and easy to operate, and allows the user to visually recognize the position of operation surface portion 5 and prompts the operation by operation surface portion 5 as a result of displacement or motion of operation surface portion 5 itself.

Note that, in the present embodiment, microcontroller 400 is configured to emit light in a case of driving actuator 10a (10-1, 10-2, 10-3 illustrated in FIG. 34) to raise, that is, to cause operation surface portion 5 to hover as shown in FIG. 41B.

Specifically, a light emitter such as an LED is provided in operation surface portion itself or in the vicinity of operation surface portion 5. The light emitters are subjected to drive control by microcontroller 400 to emit light in accordance with the movement of movable body 20. Therefore, light emission allows visual recognition of the position of operation surface portion 5 or the operation being performed, and can prompt the user to perform an operation using operation surface portion 5. In addition, each time operation surface portion 5-1, 5-2, or 5-3 is pressed, on and off of the switch can be switched, and in this case, the light emitters may be controlled to light up or to be turned off.

Then, as shown in FIG. 41C, in a case where the user presses operation surface portion 5 (5-1) waiting in the hovering state, in step S167, magnetic sensor 91 detects the position of movable body 20 due to the operation of operation surface portion 5. That is, in step S167, magnetic sensor 91 detects the displacement of movable body 20, that is, detects the load applied to movable body 20 by the pushing-in operation of the button (operation surface portion 5), and transmits the detected detection information to microcontroller 400.

In step S169, microcontroller 400 determines whether or not a numerical value corresponding to the position of movable body 20 has reached a set threshold value corresponding to a set position, repeats the determination until the set threshold value is reached, and proceeds to step S171 in a case where the set threshold value is reached. Note that, since the set threshold value also includes the dead zone and the threshold value is a value outside the dead zone, the threshold value is set to be higher than an exact regular set value.

In step S171, microcontroller 400 applies, as the switch operation, a haptic sensation of further pressing in addition to a haptic sensation of pressing in the pressing direction in a case where operation surface portion 5 is pressed. That is, in step S171, microcontroller 400 operates to present a haptic sensation of following the operation by the user without applying force in the direction opposite to the pressing direction to movable body 20 via actuator 10a to the user (“Actuator drive OFF Follow”).

Next, in step S173, microcontroller 400 detects the release of the pressed state of operation surface portion 5, which is the button, via magnetic sensor 91, and in step S175, microcontroller 400 acquires the released position via magnetic sensor 91 and the process proceeds to step S177.

In step S177, microcontroller 400 determines whether or not a value indicating the position where the button is released (specifically, the pressed state is released) is equal to or less than the set threshold value, and in a case where the value is equal to or less than the set value, the process proceeds to step S179. In a case where the value is not equal to or less than the set value, the process returns to step S175 and the process is repeated.

In step S179, microcontroller 400 drives actuator 10a in a predetermined operation and applies the operation to the finger of the user via operation surface portion 5, which is the button. In the predetermined operation in step S179, for example, force feedback driving (“Actuator drive ON/Against”) is performed, that is, a load (against the pressing) in a direction opposite to the pressing direction is applied to operation surface portion 5 to move operation surface portion 5.

Accordingly, in a case where the user stops pressing the button or separates the finger from the button, a haptic sensation of releasing the button from the pressed state is applied to the user. Next, in step S181, microcontroller 400 detects that the finger is separated from the button (operation surface portion 5) but is positioned close to operation input apparatus 1a (operation surface portion 5) based on the detection information input from magnetic sensors 91 and proximity sensors 404.

Next, in step S183, in a case where microcontroller 400 detects via proximity sensors 404 that the finger is spaced apart, the process proceeds to step S185. In step S185, microcontroller 400 drives the actuator via actuator driver 430 to turn OFF hovering, that is, to release the state where operation surface portion 5 protrudes. Accordingly, front surface 4b of case 2 of operation input apparatus 1a enters a flat state.

In this way, in operation input apparatus 1a of the present embodiment, for example, in a case where operation surface portion 5 as the operation part is used as a switch, and the user intends to move operation surface portion 5 in a state of a seamless design, operation surface portion 5 itself is operated to allow the user to check the position thereof. In addition, it is possible to prompt the user to perform an operation by the movement of operation surface portion 5 itself.

Then, in a case where operation surface portion 5 is operated, actuator 10a is driven in various set operation patterns to drive (vibrate and displace) movable body 20, and a haptic sensation corresponding to the operation can be expressed and applied.

<Example of Operation Using Operation Pattern: Multi-Stage Switch Expression with Morphing Function>

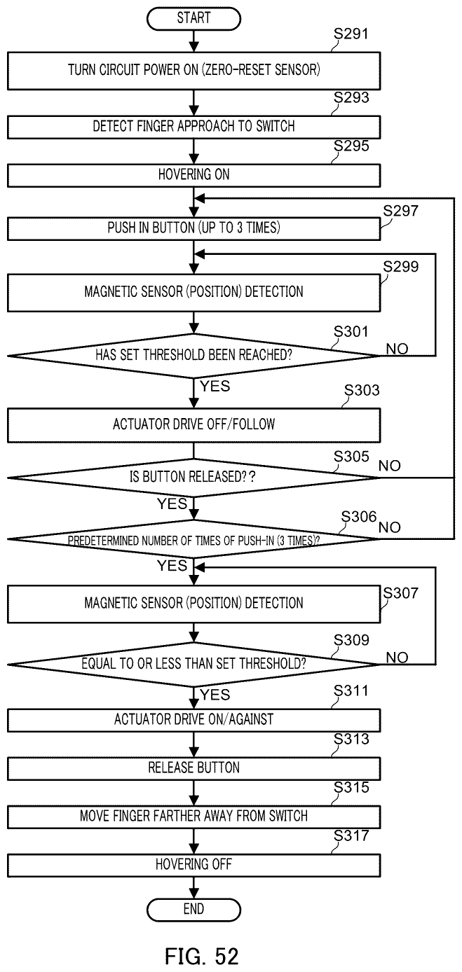

FIG. 52 is a flowchart showing an example of an operation of the actuator, and shows a case of expressing a multi-stage (for example, three-stage) switch.

As shown in FIG. 52, in step S291, first, in a case where a circuit power supply is turned on, operation input apparatus 1a is driven, and proximity sensors 404 and magnetic sensors 91 are zero-reset. In a case where a finger is brought close to operation surface portion 5 of operation input apparatus 1a as a switch to move operation surface portion 5, in step S293, proximity sensor 404 detects the approach of the finger to the switch, and detection information is output to microcontroller 400. In step S293, microcontroller 400 detects the approach of the finger and the process proceeds to step S295.

In step S295, microcontroller 400 drives actuator 10a to move operation surface portion 5 (and also movable body 20) in a manner of hinting the operation, or displaces operation surface portion 5 to a state of being moved upward and protruding, that is, a hovering state (“Hovering ON”). That is, operation surface portion 5 presents the operation position of operation surface portion 5 to the user or prompts the operation using operation surface portion 5 by protruding and displacing (morphing) from front surface 4b.

In addition, microcontroller 400 brings operation surface portion 5 into a state where the user can perform an operation. The state where the user can move operation surface portion 5 is a state where when operation surface portion 5 directly connected to actuator 10a is operated, actuator 10a can be operated in a plurality of operation patterns by microcontroller 400 in order to give a haptic sensation corresponding to the operation.

In this way, in step S295, as in the processing in step S165 (see FIG. 50), microcontroller 400 operates (raises) all operation surface portions 5, which are the operation part of operation input apparatus 1a, in a case where the finger of the user approaches operation surface portion 5. Operation surface portion 5 is operated (raised) to make it easy to recognize operation surface portion 5, and the operation itself prompts the operation. In addition, a light emitter such as an LED may be provided in operation surface portion 5 itself or in the vicinity of operation surface portion 5, and the light emitter may be subjected to drive control by microcontroller 400 to emit light in accordance with the movement of movable body 20. Light emission by the light emitter allows further recognition of the position of operation surface portion 5 or operation surface portion 5 being operated, and prompts the user to perform an operation using operation surface portion 5.

Next, in step S297, operation surface portion 5, which is a button, is pushed in (up to three times), and the process proceeds to step S299. In step S299, magnetic sensor 91 detects the load applied to movable body 20 as the pushing-in operation of movable body 20 due to the operation.

In step S299, magnetic sensor 91 detects the displacement of movable body 20, that is, detects the load applied to movable body 20 by the pushing-in operation of the button (operation surface portion 5), and transmits the detected detection information to microcontroller 400. Microcontroller 400 detects the position of movable body 20 based on the detection result from magnetic sensor 91. In this case, microcontroller 400 can detect the positions of movable body 20 to be detected corresponding to the number of stages of the switch to be expressed (for example, for a predetermined number of times such as three times).

Next, in step S301, microcontroller 400 determines whether or not a value corresponding to the position of movable body 20 has reached a set value (threshold value), and repeats the determination until the set threshold value is reached. That is, in step S301, it is determined whether or not movable body 20 is pushed in by a predetermined stroke. In step S301, in a case where movable body 20 has reached the set threshold value, the process proceeds to step S303.

In step S303, microcontroller 400 causes actuator 10a to perform a predetermined operation. In this flow, microcontroller 400 applies, as the switch operation, a haptic sensation of further pressing in addition to a haptic sensation of pressing in the pressing direction in a case where operation surface portion 5 is pressed. That is, in step S303, microcontroller 400 operates to present a haptic sensation of following the operation by the user without applying force in the direction opposite to the pressing direction to movable body 20 via actuator 10a to the user (“Actuator drive OFF Follow”). This is set by an operation pattern (a reaction force and a stroke) corresponding to the number of times the button is pushed in.

Next, in step S305, microcontroller 400 determines via magnetic sensors 91 whether or not the pressed state of operation surface portion 5, which is the button, is released, and returns to step S297 in a case where the pressed state is not released, that is, in a case where the button is still being pressed (being operated) by the user. In step S305, in a case where microcontroller 400 detects that the button is in the released state, the process proceeds to step S306.

In step S306, it is detected based on the detection result of magnetic sensor 91 whether or not the number of times the button is pushed in is a predetermined number of times, and the process returns to step S297 and is repeated until the position of the stroke reaches a position corresponding to the predetermined number of times, and a haptic sensation for each number of times is applied. In step S306, in a case where the number of times the button is pushed in has reached the predetermined number of times, for example, in a case where the button is pressed up to three stages, the process proceeds to step S307.

In step S307, microcontroller 400 acquires via magnetic sensor 91 a position where the button is released, and the process proceeds to step S309.

In step S309, microcontroller 400 determines whether or not a value indicating the position where the button is released (specifically, the pressed state is released) is equal to or less than the set threshold value, determines that the button pressing is stopped in a case where the value is equal to or less than the set value, and the process proceeds to step S311. In a case where the value is not equal to or less than the set value, the process returns to step S307 and the process is repeated.

In step S311, microcontroller 400 drives actuator 10a in a predetermined operation and applies the operation to the finger of the user via operation surface portion 5, which is the button. In the predetermined operation in step S311, for example, force feedback driving (“Actuator drive ON/Against”) is performed, that is, a load (against the pressing) in a direction opposite to the pressing direction is applied to operation surface portion 5 to move operation surface portion 5. Accordingly, in a case where the user stops pressing the button or separates the finger from the button, a haptic sensation of releasing the button from the pressed state is applied to the user. Next, in step S313, microcontroller 400 detects that the finger is separated from the button (operation surface portion 5) but is positioned close to operation input apparatus 1a (operation surface portion 5) based on the detection information input from magnetic sensors 91 and proximity sensors 404.

Next, in step S315, in a case where microcontroller 400 detects via proximity sensors 404 that the finger is spaced apart, the process proceeds to step S317. In step S317, microcontroller 400 drives the actuator via actuator driver 430 to turn OFF hovering, that is, to release the state where operation surface portion 5 protrudes. Accordingly, front surface 4b of operation input apparatus 1a enters a flat state.

In this way, in operation input apparatus 1a of the present embodiment, in a case where the user intends to move operation surface portion 5 in a state of a seamless design, operation surface portion 5 itself is operated to allow the user to check the position thereof. In addition, it is possible to prompt the user to perform an operation by the movement of operation surface portion 5 itself.

Then, in a case where operation surface portion 5 is operated, actuator 10a is driven in various set operation patterns to drive (vibrate and displace) movable body 20, and a haptic sensation corresponding to the operation can be expressed and applied as an operation feeling.

As described above, with operation input apparatus 1a, the position of operation surface portion 5 can be presented to the user by the actuation of operation surface portion 5 accompanying the actuation of movable body 20, and it is possible to achieve size reduction while ensuring the operability and the operation feeling of operation surface portion 5 in a case of operating operation surface portion 5.

### <Other Operations>

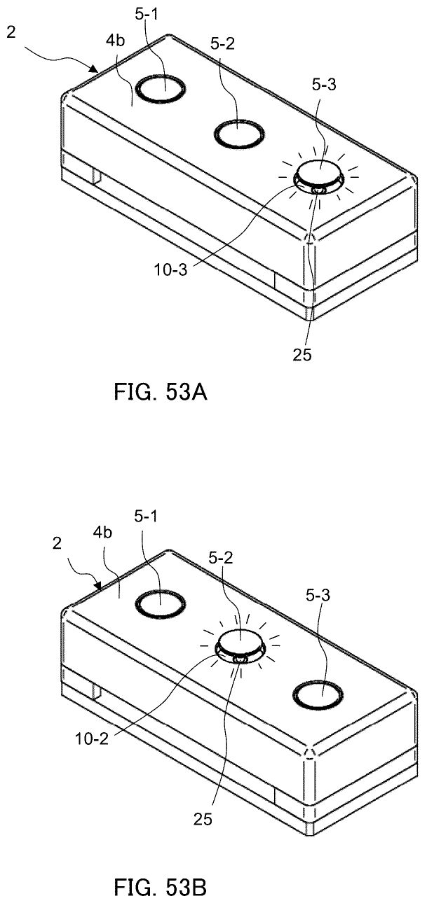

FIGS. 53A and 53B are views showing an example of an operation of the actuator.

In operation input apparatus 1a, for example, as an operation of prompting the user to perform an operation by operation surface portion 5, as shown in FIGS. 53A and 53B, a plurality of actuators 10-2 and 10-3 are alternately driven such that respective operation surface portions 5 project and retract alternately from the front surface of apparatus case 2. The projection and retraction speed can also be appropriately set, so that it is possible to prompt the user to perform an operation. In addition, in a case of being operated by the approach of the finger of the user, microcontroller 400 acquires information from proximity sensors 404 (see FIG. 42) and drives actuators 10a (10-1 to 10-3).

### (Variation of Embodiment 3)

As a variation, the front surface of apparatus case 2 in which operation surface portion 5 is disposed may be covered with a flexible sheet member having elasticity. Examples of a material of the sheet member include rubber, an elastomer, a sponge, and cloth. With such a configuration, a seamless appearance can be maintained at all times even in a case where operation surface portion 5 projects and retracts.

Subsequently, other embodiments of the present invention will be described. Other embodiments are basically the same as Embodiment 3. Therefore, for the components in the other embodiments common to those of Embodiment 3, the detailed description thereof will be omitted by assigning the same reference numerals as those in Embodiment 3, and the differences from Embodiment 3 will be mainly described. Other embodiments are different from Variation 1 of Embodiment 3 in terms of the placement position of damping member 95.

### Embodiment 4

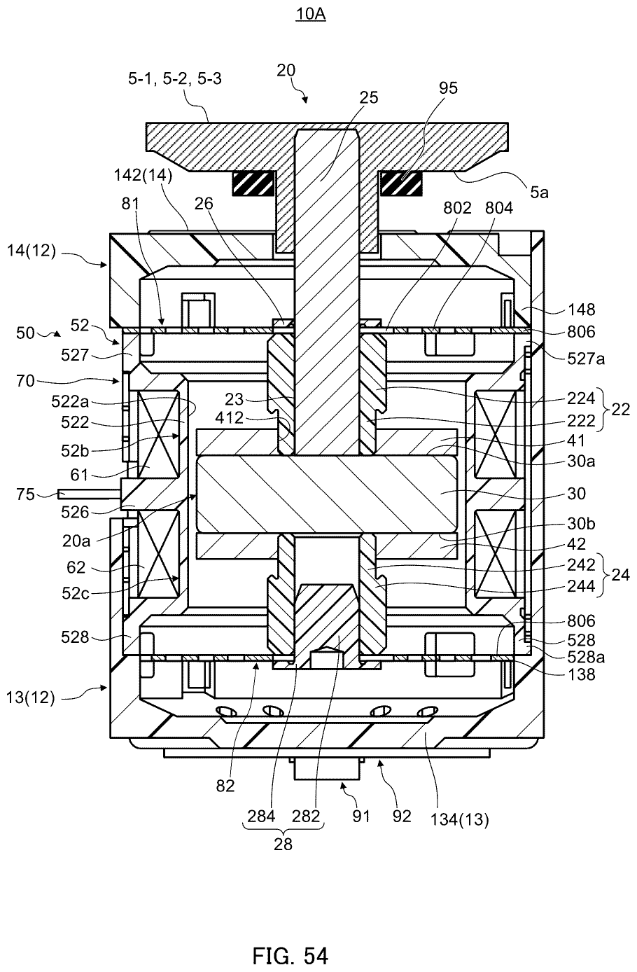

FIG. 54 is a longitudinal sectional view showing a configuration of a principal part of an actuator of an operation input apparatus according to Embodiment 4 of the present invention. In the present embodiment, damping member 95 is provided on operation back surface 5a of operation surface portion 5. Operation back surface 5a is an example of the facing portion that faces top surface portion 142 of case 12 at a rearward position in the pressing direction of operation surface portion 5 (upward in the movable direction). Details of the thickness setting of damping member 95 and the like are as described in Embodiment 3. In the present embodiment, it is necessary to assemble damping member 95 in a manufacturing process of actuator 10a, but in other points, the present embodiment can realize the same operational effects as those described in Embodiment 3.

### Embodiment 5

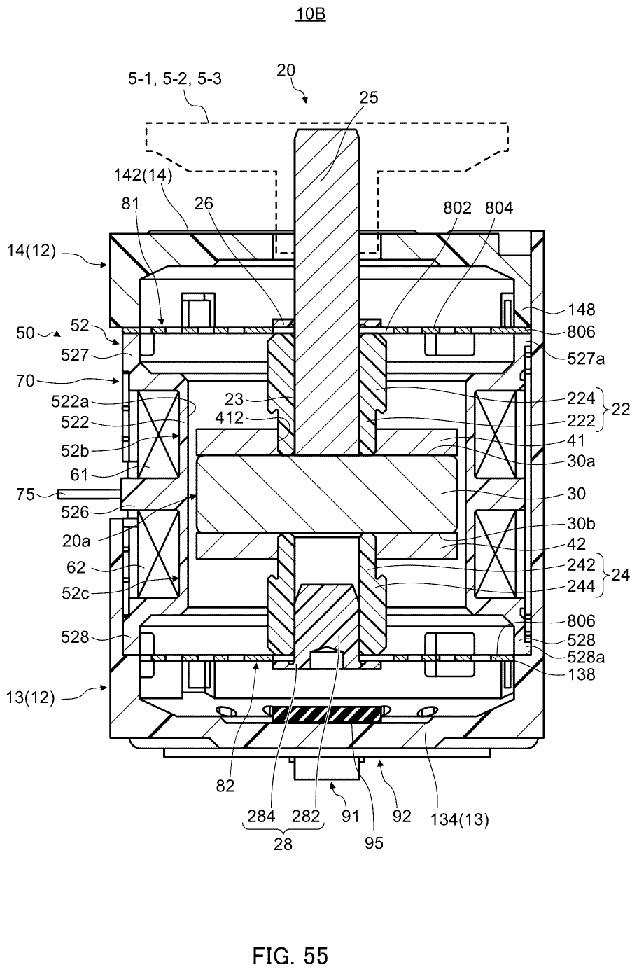

FIG. 55 is a longitudinal sectional view showing a configuration of a principal part of an actuator of an operation input apparatus according to Embodiment 5 of the present invention. In the present embodiment, damping member 95 is provided on bottom portion 134 of case 12. The placement portion is an example of the facing portion that faces movable body 20 (an end surface of flange 284 in second spring fixation portion 28) at a forward position in the pressing direction of operation surface portion 5 (downward in the movable direction). Details of the thickness setting of damping member 95 and the like are as described in Embodiment 3. In the present embodiment, it is necessary to assemble damping member 95 in a manufacturing process of actuator 10a, but in other points, the present embodiment can realize the same operational effects as those described in Embodiment 3.

### Embodiment 6

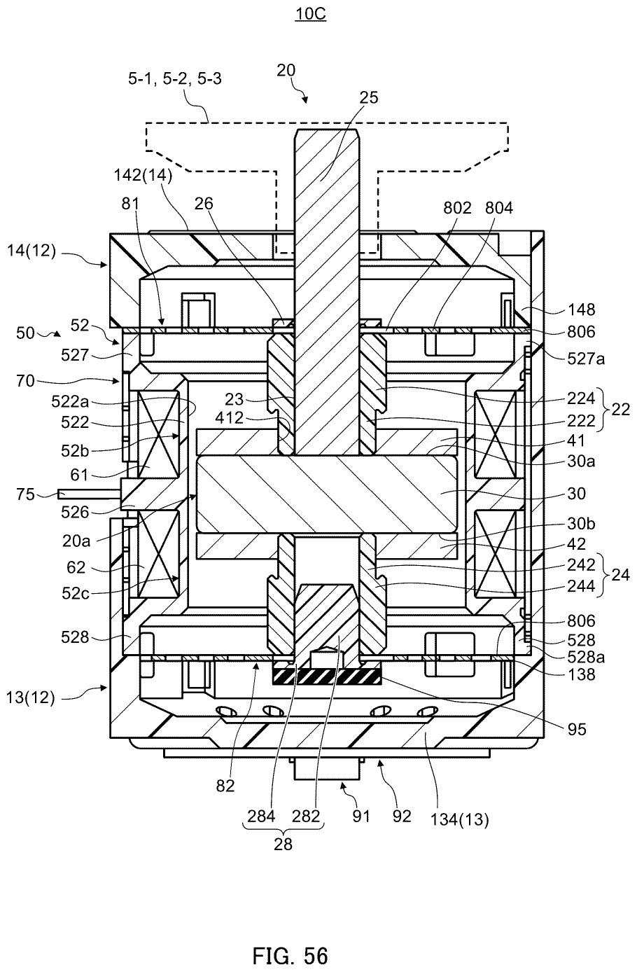

FIG. 56 is a longitudinal sectional view showing a configuration of a principal part of an actuator of an operation input apparatus according to Embodiment 6 of the present invention. In the present embodiment, damping member 95 is provided on an end surface of flange 284 in second spring fixation portion 28 of movable body 20. The placement portion is an example of the facing portion that faces fixed body 50 (bottom portion 134 of case 12) at a rearward position in the pressing direction of operation surface portion 5 (upward in the movable direction). Details of the thickness setting of damping member 95 and the like are as described in Embodiment 3. In the present embodiment, it is necessary to assemble damping member 95 in a manufacturing process of actuator 10a, but in other points, the present embodiment can realize the same operational effects as those described in Embodiment 3.

### Embodiment 7

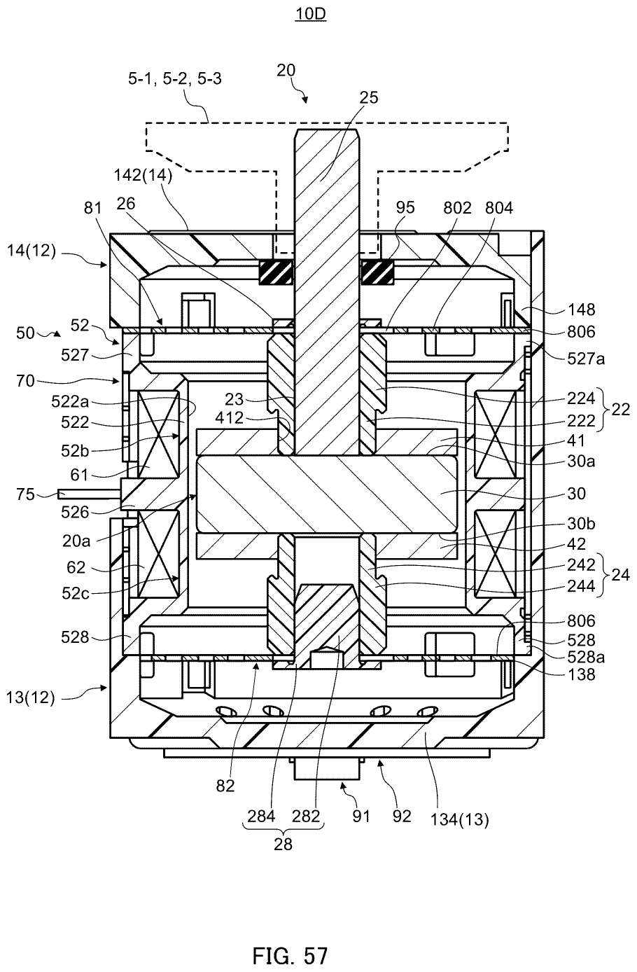

FIG. 57 is a longitudinal sectional view showing a configuration of a principal part of an actuator of an operation input apparatus according to Embodiment 7 of the present invention. In the present embodiment, damping member 95 is provided on an inner side surface of top surface portion 142 in case 12 of fixed body 50. The placement portion is an example of the facing portion that faces movable body 20 (first spring fixation portion 26) at a rearward position in the pressing direction of operation surface portion 5 (upward in the movable direction). Details of the thickness setting of damping member 95 and the like are as described in Embodiment 3. In the present embodiment, it is necessary to assemble damping member 95 in a manufacturing process of actuator 10a, but in other points, the present embodiment can realize the same operational effects as those described in Embodiment 3.

### Embodiment 8

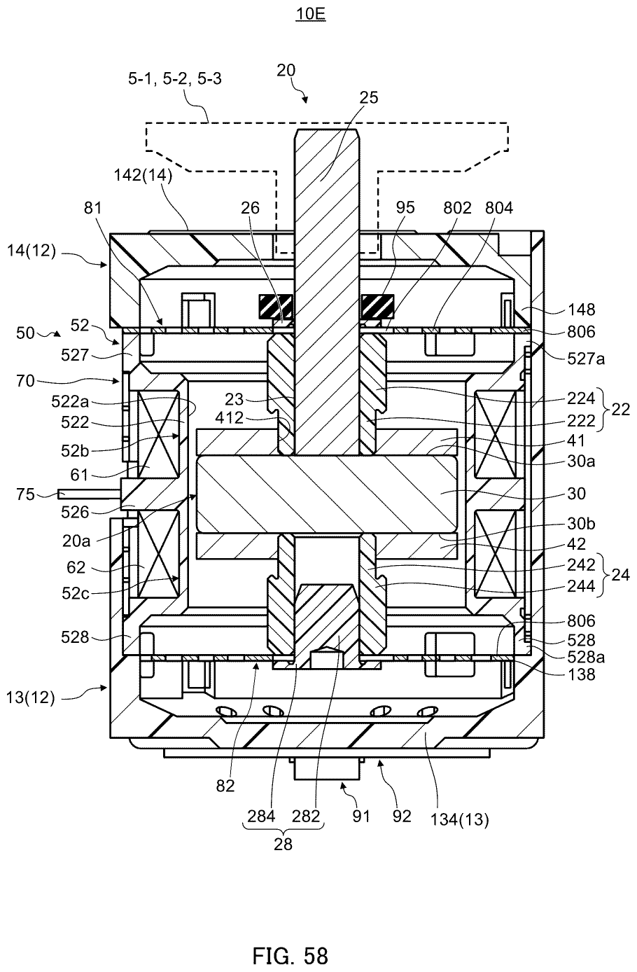

FIG. 58 is a longitudinal sectional view showing a configuration of a principal part of an actuator of an operation input apparatus according to Embodiment 8 of the present invention. In the present embodiment, damping member 95 is provided on an upper surface of first spring fixation portion 26 of movable body 20. The placement portion is an example of the facing portion that faces fixed body 50 (top surface portion 142 of case 12) at a forward position in the pressing direction of operation surface portion 5 (downward in the movable direction). Details of the thickness setting of damping member 95 and the like are as described in Embodiment 3. In the present embodiment, it is necessary to assemble damping member 95 in a manufacturing process of actuator 10a, but in other points, the present embodiment can realize the same operational effects as those described in Embodiment 3.

### Embodiment 9

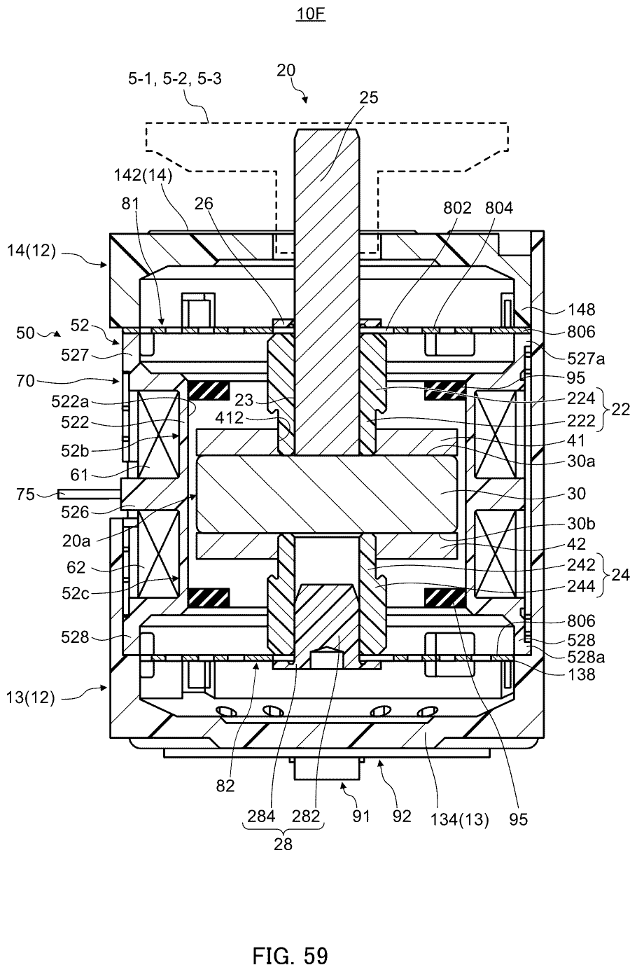

FIG. 59 is a longitudinal sectional view showing a configuration of a principal part of an actuator of an operation input apparatus according to Embodiment 9 of the present invention. In the present embodiment, damping member 95 is provided on inner circumferential surface 522a of holding-portion main body (protective wall portion, tubular member) 522 of coil holding part 52 in fixed body 50 to protrude from inner circumferential surface 522a toward the inner side in the radial direction to face movable body 20 (yokes 41 and 42). The placement portion is an example of the facing portion that faces movable body 20 (yokes 41 and 42) at forward and rearward positions in the pressing direction of operation surface portion 5 (below and upward in the movable direction). Details of the thickness setting of damping member 95 and the like are as described in Embodiment 3. In the present embodiment, it is necessary to assemble damping member 95 in a manufacturing process of actuator 10a, but in other points, the present embodiment can realize the same operational effects as those described in Embodiment 3.

### Embodiment 10

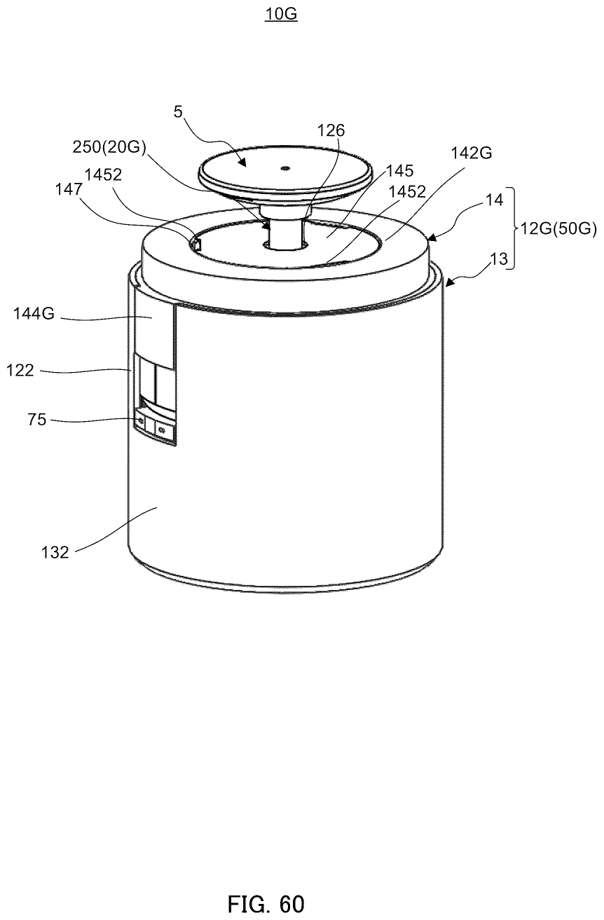

Actuator 10G of the operation input apparatus according to Embodiment 10 of the present invention will be described with reference to FIGS. 60 to 62.

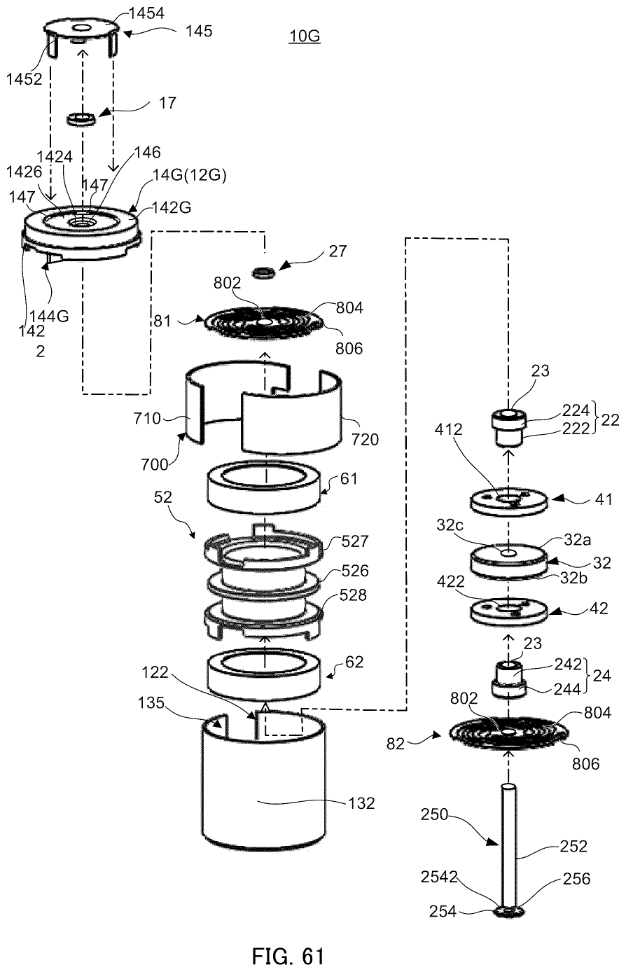

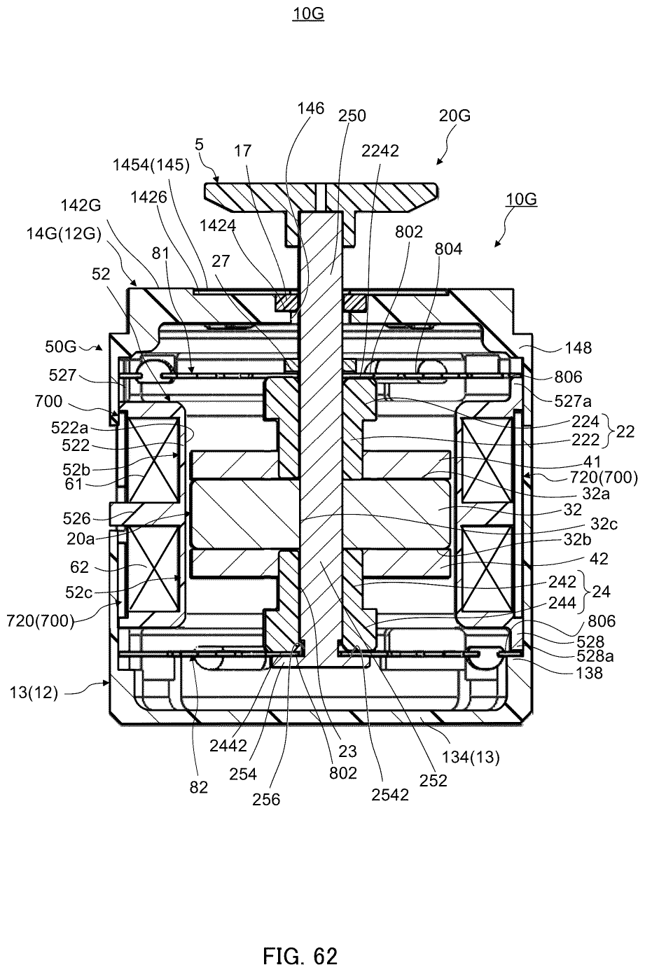

FIG. 60 is an external perspective view of the actuator according to Embodiment 10 of the present invention, and FIG. 61 is an exploded perspective view of the actuator. In addition, FIG. 62 is a longitudinal sectional view showing a configuration of a principal part of the actuator.

Actuator 10G can be applied instead of the actuator of any of operation input apparatuses 1, 1a, and 1A according to Embodiments 1 to 9. Actuator 10G has the same basic configuration as actuators 10, 10a, and 10A to 10F according to the respective embodiments, but does not include magnetic sensor 91 compared to actuators 10, 10a, and 10A to 10F, and the components such as movable body 20G, case 12G, and outer yoke 700 are different.

Hereinafter, actuator 10G will be described in detail with respect to the configuration different from actuators 10, 10a, and 10A to 10F, and the same components will be described below with the same reference numerals, and the description thereof will be omitted as appropriate.

Actuator 10G has movable body 20G to which operation surface portion 5 is connected. Actuator 10G performs an actuation of movable body 20G that presents an operation feeling to the user via operation surface portion 5 through electromagnetic drive as in actuators 10 and 10A to 10F. In addition, actuator 10G performs an actuation of movable body 20G for presenting an operation position of operation surface portion 5 to the user or for prompting the user to operate the operation surface portion, through electromagnetic drive as in actuators 10 and 10A to 10F.

Actuator 10G is an actuator that presents perception, and is configured to transmit reciprocating motion of movable body 20G in response to a touch operation by the user on operation surface portion 5 as the operation feeling (a haptic sensation, a force feeling, or the like) of the user as in actuators 10 and 10A to 10F. Other functions of actuator 10G may also prompt the operation of operation surface portion 5 or emit light to more reliably indicate the position of operation surface portion 5 to the user, and are the same as those of actuators 10 and 10A to 10F. Actuator 10G is used as a device that detects an operation and feeds back an operation feeling (haptic sensation), and has the same functions as actuators and 10A to 10F, so that the description thereof will be omitted.

As shown in FIGS. 60 to 62, actuator 10G accommodates movable body 20G in a hollow case 12G to be able to reciprocate between upper and lower end surfaces, with an axial direction (up-down direction) of case 12G as a moving direction, as in actuators 10 and 10A to 10F.

Case 12G accommodates movable body 20G together with coils 61 and 62 such that a protruding end side of output shaft portion 250 protrudes outward. Actuator 10G is held by holder 6 (see FIGS. 5 and 34) during use and is fixed to base portion 3 to be unable to move. Case 12G may be regarded as an example of the fixed body. Actuator 10G may have magnetic sensor 91 (see FIGS. 7 to 9 and FIGS. 36 to 38) that detects a movement position of movable body 20G as in actuators 10 and 10a according to Embodiments 1 and 3, and may have the same effects as those described above by magnetic sensor 91.

Actuator 10G is connected to operation surface portion 5 (5-1, 5-2, 5-3) (see FIGS. 3 to 5 and FIGS. 22 to 24) via output shaft portion 250 provided in movable body 20G, and transmits the movement of the movable body to operation surface portion 5 (5-1, 5-2, 5-3).

Actuator 10G includes magnet 32, pair of yokes 41 and 42, and pair of spring retaining parts 22 and 24 in movable body 20G, and includes a pair of annular coils 61 and 62 and outer yoke 700 in fixed body 50. In actuator 10G, movable body 20G performs reciprocating motion in a straight line direction by cooperation between energized coils 61 and 62 and magnet 32. As in actuators 10 and 10A to 10F, pair of elastic supporting parts 81 and 82 is installed between movable body 20G and fixed body 50. Elastic supporting parts 81 and 82 support movable body 20G to be movable with respect to fixed body 50.

Movable body 20G is attached via elastic supporting parts 81 and 82 to fixed body 50 to be movable in a moving direction of the movable body during application of an operation feeling and in a moving direction of movable body 20G during presentation of the operation position of operation surface portion 5 (5-1, 5-2, 5-3) or during prompting of the operation of operation surface portion 5.

Note that, yokes 41 and 42, spring retaining parts 22 and 24, and coils 61 and 62 may be provided in pairs or three or more of them may be provided as long as yokes 41 and 42, spring retaining parts 22 and 24, and coils 61 and 62 can be made movable in both or one direction in a straight line direction.

Actuator 10G forms a magnetic circuit having the same configuration as actuators 10 and 10A to 10F, and coils 61 and 62 are also energized to make movable body 20G movable. Movable body 20G can reciprocate in both directions of the axial direction, which is the reciprocation direction, or in one direction of the axial direction.

### <Movable Body 20G>

Movable body 20G is different from movable body 20 in that output shaft portion 250 is inserted into magnet 32 and one end portion has a spring stop function.

Movable body 20G has movable body fixation portion 27 and output shaft portion 250 in addition to magnet 32 and yokes 41 and 42.

In movable body 20G, yokes 41 and 42, spring retaining parts 22 and 24, movable body fixation portion 27, and second spring fixation portion 28 are continuously arranged in both directions of the reciprocation direction with magnet 32 as a center. Specifically, in movable body 20G, yokes 41 and 42 are disposed in a stacked manner on front and back surfaces 32a and 32b of magnet 32, and elastic supporting parts 81 and 82 are engaged with the other end portions of spring retaining parts 22 and 24 whose one end portions are engaged with opening portions 412 and 422 of yokes 41 and 42.

Note that, in movable body 20G, as in movable body 20, outer circumferential surface 20a of magnet 32 and yokes 41 and 42 faces inner circumferential surface 522a of holding-portion main body 522 inside inner circumferential surface 522a at a predetermined interval. In a case where movable body 20G performs reciprocating motion, outer circumferential surface 20a performs reciprocating motion without coming into contact with inner circumferential surface 522a.

Magnet 32 is magnet 30 in which an opening portion is provided in a central portion, and other configurations and functions are the same. Magnet 32 is formed in an annular shape having opening portion 32c at the center and is magnetized in a thickness direction, that is, in the reciprocation direction. An inner diameter of opening portion 32c has a dimension in which an outer diameter of output shaft portion 250 can be inserted. Magnet 32 has front and back surfaces 32a and 32b, as magnetic pole surfaces having different polarities, that are spaced apart from each other in the reciprocation direction (thickness direction).

Magnet 32 is disposed to be positioned inside coils 61 and 62 in the radial direction at an interval from coils 61 and 62 as in magnet 30. Output shaft portion 250 is inserted into and fixed to opening portion 32c of magnet 32 together with yokes 41 and 42. Accordingly, the central axis of movable body 20G easily coincides with the axes of yokes 41 and 42 by inserting output shaft portion 250 into opening portion 32c.

Yokes 41 and 42 are attracted to magnet 32 and are fixed to magnet 32, and are also fixed to magnet 32 via a thermosetting adhesive such as an epoxy resin or an anaerobic adhesive.

Opening portions 412 and 422 are formed in respective central portions of yokes 41 and 42 so as to extend therethrough in the axial direction, that is, in the thickness direction. One end portions of spring retaining parts 22 and 24 are respectively press-fitted to opening portions 412 and 422. It is preferable that axes of opening portions 412 and 422 coincide with the centers of spring retaining parts 22 and 24 and elastic supporting parts 81 and 82, and further coincide with the central axis of movable body 20G.

Output shaft portion 250 is inserted into through-holes 23 in spring retaining parts 22 and 24 and is firmly fixed thereto.

Note that, joint portions 222 and 242 are cylindrical bodies disposed on the axis of movable body 20G, and are respectively joined to yokes 41 and 42. Joint portions 222 and 242 are joined by partly inserting one end portion sides into opening portions 412 and 422 of yokes 41 and 42, respectively, and spring fixation portions 224 and 244, which are the other end portions continuous to the joint portions, and yokes 41 and 42 are positioned to be spaced apart from each other.

Spring fixation portion 224 is a tubular member that is provided to protrude from joint portion 222 to the other side (upper side) in spring retaining part 22 and that has an outer diameter larger than an outer diameter of joint portion 222. In spring fixation portion 224, bonding surface 2242, which is a distal end (upper end) surface, is disposed around output shaft portion 250. Bonding surface 2242 sandwiches elastic supporting part 81 with movable body fixation portion 27.

Movable body fixation portion 27 is a sleeve (annular member) having a through-hole into which output shaft portion 250 is inserted. Movable body fixation portion 27 is externally fitted to output shaft portion 250 and is fixed to the output shaft portion in a state of sandwiching inner circumferential portion 802 of elastic supporting part 81 between spring retaining part 22.

Meanwhile, spring fixation portion (lower spring fixation portion) 244 of spring retaining part 24, which is disposed to sandwich magnet 32 and to be opposite to spring fixation portion 224 of first spring retaining part 22, sandwiches inner circumferential portion 802 of the lower leaf spring that is elastic supporting part 82 together with shaft flange 254.

Spring fixation portion 244 has an end surface on the other end portion side (outside in the axial direction) as annular bonding surface 2442. Bonding surface 2442 has an area corresponding to inner circumferential portion 802, that is, an area of a circumferential edge portion of a central opening. Note that, edge portions of the central openings of spring fixation portion 244 and spring fixation portion 224 are subjected to chamfering processing, and spaces functioning as an adhesive reservoir portion are formed between the edge portions and output shaft portion 250.

Output shaft portion 250 has the same configuration as output shaft portion 25, and has a function as a movable body fixation portion that fixes the movable body to elastic supporting part 82 on one end portion (base end portion indicating a lower end in the drawing) side.

In output shaft portion 250, main body portion 252 is disposed to be inserted into movable body 20G on the axis of movable body 20G. Note that, a distal end portion (one end portion) of output shaft portion 250 (rod-like main body portion 252) is movable forward and backward outside fixed body 50G, to which a center portion of a back surface of operation surface portion 5 is fixed perpendicularly, and has the same functional effects as those of output shaft portion 25. Operation input apparatuses 1, 1A, 1a, 100, and 100a on which actuator 10G is mounted can respond at a high speed and perform strong feedback in a case of performing vibration output, displacement output (the displacement of movable body 20G in response to the operation), and load detection. In addition, it is possible to express an operation feeling (haptic sensation) corresponding to an operation with a long stroke.

Output shaft portion 250 is disposed to be inserted into movable body 20G on the axis of movable body 20G, and has rod-like main body portion 252 and shaft flange 254 that protrudes radially outward from the base end portion of main body portion 252.

Output shaft portion 250 (main body portion 252) is inserted through inner circumferential portion 802, which is an end portion (the other end portion) on the inner diameter side of the upper leaf spring as elastic supporting part 81, and the inner circumferential portion, which is an end portion on the inner diameter side of the lower leaf spring as elastic supporting part 82. Note that, inner circumferential portion 802 of elastic supporting part 81 is a central portion of the circular leaf spring, and is sandwiched between spring fixation portion 224 and movable body fixation portion 27 in a state of being in contact with the bonding surface of spring fixation portion 224. Accordingly, spring fixation portion 224 is joined to elastic supporting part 81.

On the base end portion side of main body portion 252, shaft flange 254 is disposed to sandwich elastic supporting part 82 between shaft flange 254 and spring retaining part 24.

Movable body fixation portion 27 fixes elastic supporting part 81 to movable body 20G. Movable body fixation portion 27 is a sleeve, and is externally fitted to output shaft portion 250 to overlap with inner circumferential portion 802 of elastic supporting part 81 in the axial direction.

Movable body fixation portion 27 is fixed around the axis of output shaft portion 250 in a state of sandwiching elastic supporting part 81 between the movable body fixation portion and spring retaining part 22. Movable body fixation portion 27 joins movable body 20G to elastic supporting part 81 to be orthogonal to the axial direction.

Shaft flange 254 fixes the leaf spring, which is elastic supporting part 82, to movable body 20G. Shaft flange 254 is disposed to face spring fixation portion 244 of spring retaining part 24 around output shaft portion 250 while sandwiching inner circumferential portion 802 of elastic supporting part 82.

Shaft flange 254 has an outer diameter larger than main body portion 252 and has contact surface 2542 having a size that faces spring fixation portion 244 of spring retaining part 24. Contact surface 2542 of the shaft flange portion is in contact with inner circumferential portion 802 at an end surface of spring fixation portion 244 on the other end portion side.

Shaft flange 254 is connected to small diameter portion 256 continuous to a base end portion of main body portion 252. Small diameter portion 256 has a smaller outer diameter than main body portion 252 and a smaller diameter than an inner diameter of inner circumferential portion 802 of elastic supporting part 82. Small diameter portion 256 is formed in a recessed shape that is open around the axis. Inner circumferential portion 802 of elastic supporting part 82 is externally fitted to small diameter portion 256. Inner circumferential portion 802 may be engaged with small diameter portion 256. Small diameter portion 256 also functions to position elastic supporting part 82 by inner circumferential portion 802 being externally fitted to small diameter portion 256 with respect to output shaft portion 250.

In addition, small diameter portion 256 functions as an adhesive reservoir for externally fitting inner circumferential portion 802, that is, is positioned inside inner circumferential portion 802 and is joined to inner circumferential portion 802, whereby small diameter portion 256 and inner circumferential portion 802 can be joined to each other.

In actuator 10G, through-holes extending in the vibration direction are formed in movable body 20G and the pair of elastic supporting parts (leaf springs) 81 and 82 that elastically hold movable body 20G with respect to fixed body 50G. Specifically, the through-holes (openings in inner circumferential portions 802, and opening portions 412, 422, and 32c) extending in the vibration direction of movable body 20G are provided in each of elastic supporting parts 81 and 82, the pair of spring retaining parts 22 and 24, the pair of yokes 41 and 42, and magnet 32 constituting movable body 20G. Output shaft portion 250 is inserted into these through-holes and constitutes the axis of movable body 20G. With this configuration, it is possible to manufacture movable body Gin which the axis of movable body 20G is positioned at a stable central position without wobbling in a case of assembling movable body 20G.

### <Fixed Body 50G>

As in fixed body 50, fixed body 50G holds coils 61 and 62 and supports movable body 20G such that the movable body is movable via elastic supporting parts 81 and 82 in the moving direction (the coil axial direction and the axial direction of movable body 20G) inside coils 61 and 62 in a radial direction.

Fixed body 50G does not include magnetic sensor 91 and circuit board 92 unlike fixed body 50, includes outer yoke 700 instead of outer yoke 70, and additionally includes sliding bearing 17, and other basic configurations are the same. Therefore, the same components will be described below with the same reference numerals and the description thereof will be omitted together with the functions.

Fixed body 50G includes coils 61 and 62 and coil holding part 52 that holds coils 61 and 62, and outer yoke 700 including a plurality of divided bodies 710 and 720 is disposed on the outer circumference of coil holding part 52 instead of outer yoke 70 that is disposed to cover coils 61 and 62.

Outer yoke 700 is a tubular magnetic body that is disposed at a position surrounding an outer circumferential surface of coil holding part 52 and covering coils 61 and 62 on the radially outer side.

Outer yoke 700 has the same functions as outer yoke 70, such as a function of serving as a magnetic spring together with magnet 32, and exerts the same effect as outer yoke 70, such as preventing a leakage magnetic flux and improving electromagnetic conversion efficiency.

Divided bodies 710 and 720 are formed in a semicircular arc shape (a character shape) by cutting a tubular member in the axial direction, and can be easily attached to sandwich coil holding part 52 from the radially outer side. Cutout portions are provided in respective divided bodies 710 and 720. In a case where divided bodies 710 and 720 are disposed between the outer circumferential edges of flange portions 527 and 528 and cover coils 61 and 62 and middle flange portion 526, terminal part 75 is inserted into the cutout portions.

Note that, in addition to coils 61 and 62, substantially all the components that generate force feedback, such as movable body 20G and case 12G via elastic supporting parts 81 and 82, are connected to coil holding part 52. Actuator 10G is configured by assembling the components to coil holding part 52 as a base.

### <Case 12G>

Case 12G is different from case 12 in a configuration of lid portion 14G. Case 12G includes bottomed tubular case main body 13 and lid portion 14G that closes opening portion 135 of case main body 13.

Lid portion 14G includes lid outer circumferential portion 1422 having an outer diameter larger than top surface portion 142G on an outer circumference of top surface portion 142G having central opening 146. Protruding portion 144G that protrudes radially outward from a portion of lid outer circumferential portion 1422 and hangs downward is provided. Protruding portion 144G like protruding portion 144 is engaged with cutout portion 122 of case main body 13.

In top surface portion 142G, first recessed portion 1424 is formed around central opening 146, and second recessed portion 1426 that is formed in an upper portion of first recessed portion 1424 and has a larger diameter than first recessed portion 1424 is formed.

Sliding bearing 17 into which output shaft portion 250 inserted into central opening 146 is inserted is disposed in first recessed portion 1424, and sliding bearing 17 is covered with bearing cover 145.

Sliding bearing 17 has an annular shape and is disposed in first recessed portion 1424 at the same center as central opening 146. It is preferable that an opening diameter of sliding bearing 17 is substantially the same as the outer diameter of output shaft portion 250. Output shaft portion 250 is suitably slidably inserted into the opening of sliding bearing 17 in the axial direction of output shaft portion 250, and sliding bearing 17 guides output shaft portion 250 accurately and stably in the axial direction.

Cover main body 1454 of bearing cover 145 that covers and fixes sliding bearing 17 is disposed in second recessed portion 1426.

Bearing cover 145 includes cover main body 1454 that is disposed in second recessed portion 1426 to close first recessed portion 1424 and second recessed portion 1426, and attachment tab portions 1452 that attach cover main body 1454 to top surface portion 142G.

Attachment tab portions 1452 are provided to hang from cover main body 1454, and are inserted into slits 147 that are through-holes formed in a circular bottom surface portion of second recessed portion 1426 along the axial direction in top surface portion 142G.

Note that, slits 147 are formed at equal intervals in a circumferential direction at a circumferential edge portion of second recessed portion 1426. The placement positions of slits 147 correspond to the placement positions of attachment tab portions 1452 provided on cover main body 1454 of bearing cover 145.

Since attachment tab portions 1452 are inserted into slits 147, bearing cover 145 is attached to top surface portion 142G, so that bearing cover 145 together with first recessed portion 1424 positions and accommodates sliding bearing 17.

Note that, portions of lid portion 14G that are configured the same as portions of lid portion 14 have the same functions. In addition, movable body 20G in actuator 10G performs reciprocating motion based on Equations 1 and 2 as in each of actuators 10 and 10a.

In an assembly method of actuator 10G according to the present embodiment, first, the pair of yokes 41 and 42 are attached to both end surfaces 32a and 32b of magnet 32 in the vibration direction (thickness direction and axial direction) with an adhesive. The pair of spring retaining parts 22 and 24 are fitted to the through-holes in the pair of yokes 41 and 42 to form a sub-assembly of movable body 20G. Thereafter, movable body 20G is disposed inside coil holding part 52 around which the pair of coils 61 and 62 are wound, and the pair of elastic supporting parts 81 and 82, which are leaf springs, are disposed at opening edge portions of coil holding part 52 at both ends in the vibration direction.

Next, the distal end portion of output shaft portion 250 is inserted into the inside of the sub-assembly through the opening in one elastic supporting part (elastic supporting part 82). Specifically, output shaft portion 250 is inserted into the main body portion of the sub-assembly from the other end portion side (spring retaining part 24 side) of the sub-assembly of movable body 20G, and elastic supporting part (leaf spring) 82 on the other end portion side is brought into contact with shaft flange 254 on the base end portion side of output shaft portion 250.

Thereafter, movable body fixation portion (sleeve) 27 is externally fitted to output shaft portion 250, which protrudes from the one end portion side (elastic supporting part 81 side) of the sub-assembly of movable body 20G, from one end portion side to the other end portion side and is brought into contact with elastic supporting part (leaf spring) 81 on the one end portion side. Accordingly, movable body fixation portion 27 sandwiches elastic supporting part 81 between the movable body fixation portion and spring retaining part 22. Thereafter, movable body 20G is assembled to coil holding part 52 by applying an adhesive between movable body fixation portion 27 and output shaft portion 250 and crimping movable body fixation portion 27 and output shaft portion 250.

In addition, coil holding part 52 that accommodates movable body 20G in this manner is accommodated in case 12G.

In an assembly method of lid portion 14G in case 12G, first, sliding bearing 17 is inserted into first recessed portion 1424 of lid portion 14G. Next, attachment tab portions 1452 of bearing cover 145 are inserted into slits 147 in top surface portion 142G of lid portion 14G, and the open side of second recessed portion 1426 is closed by cover main body 1454 of bearing cover 145. Accordingly, lid portion 14G is assembled by bending attachment tab portions 1452 that protrude to the inside of lid portion 14G to a back side of top surface portion 142G to attach bearing cover 145 to lid portion 14G.

Coil holding part 52 that accommodates movable body 20G via elastic supporting parts 81 and 82 is disposed inside case main body 12G. Then, the open end (opening portion) of case main body 12G is closed while the distal end portion of output shaft portion 250, which protrudes from the open end (opening portion) side of case main body 12G, is inserted into the through-hole in lid portion 14G. Then, in output shaft portion 250, operation surface portion 5 is inserted into a portion of the output shaft portion that protrudes from lid portion 14G to complete the assembly.

The embodiment of the present invention has been described above. The above description is an illustration of the preferred embodiment of the present invention, and the scope of the present invention is not limited to the description. That is, the configuration of the device and the shape of each part are merely an example, and it is obvious that various variations and additions to these examples are possible within the scope of the present invention.

The disclosures of Japanese Patent Application No. 2023-012967, filed on Jan. 31, 2023, and Japanese Patent Application No. 2023-101730, filed on Jun. 21, 2023, including the specifications, drawings and abstracts, are incorporated herein by reference in their entirety.

### INDUSTRIAL APPLICABILITY

The operation input apparatus according to the present invention has an effect that the position of the operation part can be presented and reduction in size can be achieved while ensuring operability and an operation feeling of the operation part during operation, and is useful as a switch or a tactile presentation apparatus.

### REFERENCE SIGNS LIST

1, 1A, 1a, 100, 100a Operation input apparatus
2 Apparatus case
3 Base portion
3a Through-hole
4 Cover portion
4a Opening portion
4b Front surface
5, 5-1, 5-2, 5-3 Operation surface portion (operation part, front surface portion)
6 Holder
6a Divided body
6b, 6c, 7 Fastening member
8 Flexible member (elastic surface-shaped portion)
10, 10a, 10-1, 10-2, 10-3, 10A, 10B, 10C, 10D, 10E, 10F Actuator
12, 12G Case
13 Case main body
14, 14G Lid portion
Unit
17 Sliding bearing
20, 20G Movable body
20a Outer circumferential surface
22, 24 Spring retaining part
23 Through-hole
25, 250 Output shaft portion (protruding part)
26 First spring fixation portion
27 Movable body fixation portion
28 Second spring fixation portion
30, 32 Magnet
30a, 32a Front surface
30b, 32b Back surface
41, 42 Yoke
50, 50G Fixed body
52 Coil holding part
52b, 52c Coil attachment portion
54 Movable-range forming portion
61, 62 Coil (annular coil)
70, 700 Outer yoke
75 Terminal part
81, 82 Elastic supporting part (leaf spring)
91 Magnetic sensor
92 Circuit board (control part)
94 User action detection part (action detection part)
95 Damping member
122 Cutout portion
132 Circumferential wall portion
134 Bottom portion (bottom surface of case main body)
135 Opening portion
138 Step portion
142, 142G Top surface portion
144, 144G Protruding portion
145 Bearing cover
146 Central opening
147 Slit
148 Pressing portion
222, 242 Joint portion
252 Main body portion
254 Shaft flange
256 Small diameter portion
224, 244 Spring fixation portion
282 Insertion portion
284 Flange
400 Microcontroller (control part)
402 AD converter
403 Placement region
404, 406 Proximity sensor
412, 422 Opening portion
430 Actuator driver
522 Holding-portion main body (protective wall portion, tubular member)
522a Inner circumferential surface
526 Middle flange portion
527, 528 Flange portion
527a, 528a End surface
710, 720 Divided body
802 Inner circumferential portion
804 Deformable arm portion
806 Outer circumferential fixation portion
1424 First recessed portion
1426 Second recessed portion
1452 Attachment tab portion
1454 Cover main body

1. An operation input apparatus, comprising:
an operation part operated by a user; and
an actuator including a movable body to which the operation part is connected, the actuator being configured to perform, through electromagnetic drive, actuation of the movable body for applying an operation feeling to the user and actuation of the movable body for presenting an operation position of the operation part to the user or for prompting the user to operate the operation part.

2. The operation input apparatus according to claim 1, wherein
the actuator elastically supports the movable body such that the movable body is movable in a moving direction in which the movable body moves during application of the operation feeling and in a moving direction in which the movable body moves during presentation of the operation position of the operation part or during prompting of the operation of the operation part.

3. The operation input apparatus according to claim 2, wherein:
the operation part includes a front surface portion that is disposed to be projectable and retractable with respect to a case, and
the moving direction of the movable body during application of the operation feeling and the moving direction of the movable body during presentation of the operation position of the operation part or during prompting of the operation of the operation part coincide with a projection and retraction direction of the front surface portion.

4. The operation input apparatus according to claim 1, wherein
the actuator actuates the movable body to cause a motion of the movable body during application of the operation feeling, and actuates the movable body to displace the movable body during presentation of the operation position of the operation part or during prompting of the operation of the operation part.

5. The operation input apparatus according to claim 2, wherein:
the actuator includes a fixed body to which the movable body is attached via an elastic supporting part to be movable in the moving direction of the movable body during application of the operation feeling and in the moving direction of the movable body during presentation of the operation position of the operation part or during prompting of the operation of the operation part,
the elastic supporting part is a leaf spring,
the movable body includes:
a disk-shaped magnet,
a pair of disk-shaped yokes fixed respectively to a front surface and a back surface of the magnet,
a pair of spring retaining parts, which are respectively connected at one ends to the pair of disk-shaped yokes and are respectively connected at another ends to a central portion of the leaf spring having a circular shape, and
a protruding part that protrudes from anther end of one spring retaining part of the pair of spring retaining parts in an axial direction of the magnet and that is connected to the operation part, and
the fixed body includes:
a coil disposed on an outer circumference of the movable body, and
a case that accommodates the movable body together with the coil such that a protruding end side of the protruding part protrudes outward, the fixed supporting the movable body such that the movable body is movable in the axial direction of the magnet via the leaf spring.

6. The operation input apparatus according to claim 3, wherein:
the front surface portion is disposed to be projectable and retractable from a front surface of the case,
a deformable elastic surface-shaped portion is disposed on the front surface of the case to cover the operation part, and
the operation part is capable of pushing up the deformable elastic surface-shaped portion from a back surface or pushing down the deformable elastic surface-shaped portion from a front surface side by the actuation of the movable body.

7. The operation input apparatus according to claim 3, wherein:
the front surface portion is disposed to be projectable and retractable from a front surface of the case, and
in the actuator, the movable body is disposed to be movable in a direction orthogonal to the front surface of the case such that the front surface portion moves perpendicularly to the front surface of the case.

8. The operation input apparatus according to claim 1, wherein
the actuator includes an operation amount detection part that detects a moving amount of the movable body in a moving direction, the movable body being moved by a user operation via the operation part.

9. The operation input apparatus according to claim 8, wherein
the operation amount detection part is a magnetic sensor that detects a position of a magnet of the movable body.

10. The operation input apparatus according to claim 1, wherein
the actuator applies the operation feeling to the user by actuating the movable body in a multi-stage manner in a moving direction depending on an operation amount of the movable body in accordance with the operation by the user.

11. The operation input apparatus according to claim 1, wherein
the actuator performs the actuation of the movable body by supplying a current variable in accordance with an operation amount by the user, so as to apply hardness or softness of a haptic sensation to the user as the operation feeling while changing the hardness or softness.

12. The operation input apparatus according to claim 1, wherein
the actuator performs the actuation of the movable body by supplying a current variable in accordance with an operation amount by the user, so as to apply a reaction force to the movable body and express a buckling haptic sensation to the user as the operation feeling by means of a current that decreases at a stage where the current exceeds a threshold value or a current that flows in an opposite direction at the stage where the current exceeds the threshold value.

13. The operation input apparatus according to claim 1, further comprising:
an action detection part that detects an action of the user, wherein
the actuator performs the actuation of the movable body for presenting the operation position of the operation part to the user or for prompting the user to operate the operation part in accordance with the action of the user detected by the action detection part.

14. An operation input apparatus, comprising:
a movable body to which an operation part that receives a pressing operation by a user is connected via a protruding part;
a fixed body on which the operation part is disposed externally and that accommodates the movable body internally;
an actuator that moves the movable body inside the fixed body through electromagnetic drive in response to the pressing operation, so as to apply an operation feeling to the user; and
a damping member that is disposed between the movable body and the fixed body.

15. The operation input apparatus according to claim 14, wherein
the damping member is provided on a facing portion of the fixed body facing the operation part at a forward position with respect to the operation part in a pressing direction.

16. The operation input apparatus according to claim 14, wherein
the damping member is provided on a facing portion of the operation part facing the fixed body at a rearward position with respect to the fixed body in a pressing direction.

17. The operation input apparatus according to claim 14, wherein
the damping member is provided on a facing portion of the fixed body facing the movable body at a forward position with respect to the movable body in a pressing direction.

18. The operation input apparatus according to claim 14, wherein
the damping member is provided on a facing portion of the movable body facing the fixed body at a rearward position with respect to the fixed body in a pressing direction.

19. The operation input apparatus according to claim 14, wherein
the damping member is provided on a facing portion of the fixed body facing the movable body at a rearward position with respect to the movable body in a pressing direction.

20. The operation input apparatus according to claim 14, wherein
the damping member is provided on a facing portion of the movable body facing the fixed body at a forward position with respect to the fixed body in a pressing direction.

21. The operation input apparatus according to claim 14, wherein:
the fixed body includes a tubular member including an inner circumferential surface that surrounds an outer circumference of the movable body, and
the damping member is provided on the tubular member to protrude inward from the inner circumferential surface at a forward or rearward position with respect to the movable body in a pressing direction to face the movable body.
